(19) United States
(12) Patent Application Publication
(10) Pub. No.: US 2006/0060781 A1
(43) Pub. Date: Mar. 23, 2006

(54) Charged-particle beam apparatus and method for automatically correcting astigmatism and for height detection

(76) Inventors: Masahiro Watanabe, Yokohama (JP); Masayoshi Takeda, Mito (JP); Koichi Hayakawa, Hitachinaka (JP); Yasuhiro Gunji, Hitachiota (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/114,203

(22) Filed: Apr. 26, 2005

Related U.S. Application Data
(63) Continuation-in-part of application No. 10/114,938, filed on Apr. 4, 2002, now abandoned.
(63) Continuation-in-part of application No. 10/851,322, filed on May 24, 2004, now Pat. No. 6,885,012.
(63) Continuation-in-part of application No. 10/853,225, filed on May 26, 2004, now Pat. No. 6,919,577.

(30) Foreign Application Priority Data
Jul. 4, 2001 (JP) 2001-202904
Feb. 27, 1998 (JP) 10-046725
Aug. 11, 1997 (JP) 9-216604

(51) Int. Cl. G21K 7/00

(52) U.S. Cl. 250/310

(57) ABSTRACT

Charged-particle beam arrangements (e.g., apparatus and methods) for automatically correcting astigmatism and for height detection.

### CROSS REFERENCE TO RELATED APPLICATIONS

The present application is a continuation-in-part (CIP) of at least three prior applications, i.e., a first application being Ser. No. 10/114,938 filed 4 Apr. 2002, pending; a second application being Ser. No. 10/851,322 filed 24 May 2004 and issued as U.S. Pat. No. 6,885,012; and a third application being Ser. No. 10/853,225 filed 26 May 2004, pending.

The above-noted second application is a continuation application of U.S. application Ser. No. 10/426,702, filed May 1, 2003, which is a continuation of U.S. application Ser. No. 10/012,400, filed Dec. 12, 2001, now U.S. Pat. No. 6,559,459, which is a continuation of U.S. application Ser. No. 09/258,461, filed Feb. 26, 1999, now U.S. Pat. No. 6,335,532, which is a continuation-in-part application of U.S. application Ser. No. 09/132,220, filed Aug. 11, 1998, by some of the inventors herein, now U.S. Pat. No. 6,107,637.

The above-noted third application is a continuation of U.S. application Ser. No. 10/012,454, filed Dec. 12, 2001, which is a continuation of U.S. application Ser. No. 09/642,014, filed Aug. 21, 2000, now U.S. Pat. No. 6,333,510, which is a continuation of U.S. application Ser. No. 09/132,220, filed Aug. 11, 1998, now U.S. Pat. No. 6,107,637.

The teachings and subject matter of every one of the above-mentioned disclosures is incorporated by reference in its entirety into the present application.

### BACKGROUND

Disclosure gleaned from the first application is as follows. More particularly, the present invention relates to a charged-particle beam apparatus for automatically adjusting astigmatism or the like in a charged-particle optical system for carrying out inspection, measurement, fabrication and the like with a high degree of precision by using a charged-particle beam, and the invention also relates to a method of automatically adjusting the astigmatism in such a charged-particle beam apparatus.

For example, an electron-beam microscope is used as an automatic inspection system for inspecting and/or measuring a microcircuit pattern created on a semiconductor wafer or the like. In the case of defect inspection, a detected image, which is an electronic beam image detected by a scanning electron-beam microscope, is compared with a reference picture used as a reference. In addition, in the case of measurement of a line width, a hole diameter and other quantities of a microcircuit pattern, the measurement is carried out in image processing by using an electron-beam image detected by a scanning electron-beam microscope. The measurement of such quantities of a microcircuit pattern is carried out in setting and monitoring conditions of a process used in the manufacture of a semiconductor device.

In comparative inspection for detecting a defect in a pattern by comparing electronic images of patterns and in measurement of line width or another quantity of a pattern by processing an electronic image, as described above, the quality of the electronic image has a big effect on reliability of a result of the inspection. The quality of an electronic image deteriorates due to deterioration in resolution or the like caused by aberration and defocus of an electron-beam optical system. The deterioration in image quality deteriorates the inspection sensitivity and the measurement performance. In addition, the width of an image on a picture changes and a stable result of detection of an edge cannot be obtained. Thus, the sensitivity of detection of a defect and a result of measurement of the line width of a pattern, as well as a result of measurement of a hole diameter, also become unstable.

Traditionally, the focus and astigmatism of an electron-beam optical system are adjusted by adjusting the control current of an objective lens and control currents of two sets of astigmatism correction coils while visually observing an electronic image. To be more specific, the focus is adjusted by changing the current flowing to the objective lens in order to change the convergence height of a beam.

It takes time to adjust the focus and astigmatism of an electron-beam optical system by adjusting the control current of an objective lens and control currents of two sets of astigmatism correction coils, while visually observing an electronic image, as described above. In addition, if the surface of a sample is scanned by using an electron beam a number of times, it is quite within the bounds of possibility that a problem of damage inflicted on the sample is raised. Furthermore, by carrying out the adjustment manually, the result of adjustment may inevitably vary from operator to operator. Moreover, the astigmatism and the focal position normally vary with the lapse of time. Thus, in automatic inspection and measurement, it is necessary to adjust the astigmatism and the focal position periodically, presenting a hindrance to automation.

In order to solve the problems described above, a variety of conventional automatic astigmatism correction methods have been proposed. In Japanese Patent Laid-open No. Hei 7-153407, for example, there has been disclosed an apparatus (referred to as Example 1) wherein a 2-dimensional scanning operation is carried out on a sample by using a charged-particle beam to produce a secondary-electron signal from the sample; the secondary-electron signal is then differentiated and digital data with a large change is extracted; then, a position on the sample, at which the large change of the extracted data occurs, is found; subsequently, a charged-particle beam is used for scanning in the X direction only and in the Y direction only while excitement flowing to an objective lens is being changed with the found position taken as a center; a maximum value of digital data of a secondary-electron signal generated by these scanning operations is then used for detecting focal information in the X direction and focal information in the Y direction; from the focal information in the X direction and the focal information in the Y direction, a current to flow to the objective lens is then determined and output to the objective lens; afterward, a current flowing to an astigmatism correction coil is changed and a charged-particle beam is then used for carrying out a scanning operation in the X or Y direction to produce a secondary-electron signal; and a maximum value of digital data of the secondary-electron signal is used for determining the magnitude of a current to flow to the astigmatism correction coil in order to adjust the astigmatism and the focus of the charged-particle beam.

In addition, in Japanese Patent Laid-open No. Hei 9-161706, there has been disclosed a method (referred to as Example 2) whereby the focus is changed back and forth by carrying out a scanning operation using an electron beam in a variety of directions in order to recognize the direction of astigmatism; then, two different astigmatism correction quantities are changed, while the relation between these astigmatism correction quantities is being maintained, so that the astigmatism changes only in this direction; and finally, a condition for the image to become bright is searched for. Thus, the adjustment can be carried out by limiting conditions of an astigmatism correction quantity with two degrees of freedom compared to a condition of an astigmatism correction quantity with one degree of freedom.

Furthermore, in Japanese Patent Laid-open No. Hei 10-106469, there has been disclosed a method (referred to as Example 3) whereby, first of all, the focus is adjusted automatically to a position slightly shifted from an in-focus state; then, the direction of astigmatism is found by adoption of FFT of a 2-dimensional picture; subsequently, two different astigmatism correction quantities are changed while the relation between these astigmatism correction quantities is being maintained, so that the astigmatism changes only in this direction; and finally, a condition for the image to become bright is searched for.

Moreover, in Japanese Patent Laid-open No. Hei 9-82257, there has been disclosed a method (referred to as Example 4) whereby, by adopting Fourier transformation of a 2-dimensional SEM image, a point at which a change of the magnitude of the Fourier transformation is inverted is first of all found, while the focus is being changed in order to determine an in-focus position; then, a 2-dimensional particle image at a focal point before the in-focus position and a 2-dimensional particle image at a focal point after the in-focus position are found; subsequently, the direction of astigmatism is found from a distribution of magnitudes of the Fourier transform; and finally, the astigmatism is corrected so that the astigmatism changes in this direction.

In addition, in U.S. Pat. No. 6,025,600, there has been disclosed a method (referred to as Example 5) whereby, 4-direction sharpness values of an acquired SEM picture are found by increasing the focal position; then, the focal position is increased until maximums of these values are obtained; and, finally, a correction quantity of astigmatism is found from the maximums of the sharpness values in the 4-direction.

Furthermore, in Japanese Patent Laid-open No. Sho 59-18555 and U.S. Pat. No. 4,554,452, which is a U.S. patent corresponding to Japanese Patent Laid-open No. Sho 59-18555, there has been disclosed a method (referred to as Example 6) whereby, an SEM picture is scanned in a variety of directions by increasing a focal position in order to find the sharpness in each of the directions; and the correction quantity of astigmatism is found from a maximum value of the sharpness found in each of the directions.

Example 1 adopts a method whereby, while three kinds of control quantity, namely, two kinds of astigmatism correction quantity and a focal correction quantity, are each being changed one by one, a point providing a maximum sharpness value of a secondary particle image is found by a trial-and-error technique. Thus, it takes too long a time to complete the correction of astigmatism. As a result, since the sample is exposed to a charged-particle beam for a long time, the sample may also be damaged by charge-up, contamination and the like. In addition, if an astigmatism is adjusted automatically or visually by taking sharpness as a reference, a state in which the astigmatism is not correctly eliminated easily results in dependence on the sample pattern.

Also in the case of Example 2, after examining the direction of astigmatism by changing the focal point back and forth, it is necessary to carry out a 1-dimensional scanning operation by changing the focal point back and forth while changing the astigmatism adjustment quantity in order to repeatedly carry out an operation to search for a condition in which in-focus positions in two directions coincide with each other, so that Example 2 has a problem in that it takes too much time. In addition, there is also a problem in that a post-radiation mark is left on the sample due to the fact that the scanning operation using an electron beam is a one-dimensional operation. Moreover, there is also a problem in that stable astigmatism correction cannot be carried out since a sufficient signal cannot be obtained in dependence on the location of the one-dimensional scanning operation, if the sample does not have a uniform texture thereon.

Also in the case of Example 3, since the adjustment comprises two steps, namely, the step of changing the focus back and forth and the step of changing the astigmatism correction quantity up and down, there are problems in that it takes time to carry out the adjustment, and, in addition, the damage inflicted on the sample is great. Furthermore, in order to find the direction of the astigmatism by adoption of the FFT, the method requires a precondition that the spectrum of an image in which no astigmatism is generated is uniform. Thus, there is a problem in that the number of usable samples is inevitably limited.

As described above, Examples 1, 2 and 3 include neither a method of finding the direction and the magnitude of astigmatism in a stable manner from a particle image, nor the computation of a correction quantity to be supplied to an astigmatism adjustment means from the direction and the magnitude of the astigmatism. Thus, the astigmatism correction quantity must be changed and the result must be checked repeatedly on a trial-and-error basis, so that it takes time to carry out the adjustment; and, at the same time, the sample is contaminated, whereas damage caused by charge-up is inflicted upon the sample. In addition, in the case of a one-dimensional beam scanning operation, there is a problem of precision deterioration for scanning of a location with a coarse pattern on the sample.

Moreover, in the case of Example 4, the direction and the strength of an astigmatism are found from Fourier transformation of a 2-dimensional image with the focus being changed back and forth. However, Example 4 does not include a specific method of computing a correction quantity to be supplied to an astigmatism adjustment means from the direction and the strength of the astigmatism. Furthermore, the meaning of the strength seen from the physics point of view is not defined clearly. Thus, there is a problem in that the correction quantity to be supplied to the astigmatism adjustment means cannot be found with a sufficient degree of accuracy.

In addition, in the case of Example 5, an astigmatism correction quantity can be found from an SEM image with the sequence of focal points being shifted, and the amount of damage inflicted on the sample can be reduced. However, this method does not consider the case of a sharpness curve becoming unsymmetrical or having two peaks for a large astigmatism. Furthermore, when degrees of directional sharpness are to be found from a picture, the sharpness in the vertical direction and the sharpness in the horizontal direction include many noises in comparison with the sharpness in the slanting direction, due to the beam noises and response characteristics of the detector. As a result, there is a problem of unstable operation for a dark sample.

In the case of Example 6, the scanning axis is rotated in more than three directions to obtain a signal, and the sharpness in each of the directions is found from this cross-sectional signal, so that it takes time to carry out the scanning operation. More specifically, there is a problem in that the determined sharpness is susceptible to an error, because of an effect of the edges in other directions, due to the fact that the processing is a one-dimensional differentiation process.

As a problem common to Examples 5 and 6, the astigmatism correction quantity cannot be found with a high degree of accuracy, or it takes time to converge the astigmatism correction if the edge of a sample pattern is one-sided in a certain direction, so that the sharpness in this certain direction is affected by an edge in another direction and inevitably increases, This phenomenon is caused by the fact that the astigmatism correction quantity is found by adopting a linear junction of maximum values of the sharpness.

Background disclosure gleaned from the second application is as follows. More particularly, The present invention relates to a convergent charged particle beam apparatus using a charged particle beam such as an electron beam or ion beam for microstructure fabrication or observation and an inspection method using the same, and more particularly to an automatic focusing system and arrangement in the convergent charged particle beam apparatus.

As an example of an apparatus using a charged particle beam, there is an automatic inspection system intended for inspecting and measuring a microcircuit pattern formed on a substrate such as a semiconductor wafer. In defect inspection of a microcircuit pattern formed on a semiconductor wafer or the like, the microcircuit pattern under test is compared with a verified non-defective pattern or any corresponding pattern on the wafer under inspection. A variety of optical micrograph imaging instruments have been put to practical use for this purpose, and also electron micrograph imaging has found progressive applications to defect inspection by pattern image comparison. In a scanning electron microscope instrument which is specifically designed for critical-dimension measurement of line widths and hole diameters on microcircuit patterns used for setting and monitoring process conditions of semiconductor device fabrication equipment, automatic critical-dimension measurement is implemented through use of image processing.

In comparison inspection where electron beam images of corresponding microcircuit patterns are compared for detecting a possible defect or in critical-dimension measurement where electron beam images are processed for measuring such dimensions as pattern line widths, reliability of results of inspection or measurement largely depends on the quality of electron beam images.

Deterioration in electron beam image quality occurs due to image distortion caused by deflection or aberration in electron optics, decreased resolution caused by defocusing, etc., resulting in degradation of performance in comparison inspection or critical-dimension measurement.

In a situation where a specimen surface is not uniform in height, if inspection is conducted on the entire surface area under the same condition, an electron beam image varies with each region inspected as exemplified in FIGS. 21(a)-21(d), wherein FIG. 21(a) shows a wafer with different regions A-C, FIG. 21(b) shows an in-focus image of region A and FIGS. 21(c) and 21(d) show defocused images of regions B and C, respectively. In inspection by comparison between the in-focus image of FIG. 21(b) and the defocused image FIG. 21(c) or FIG. 21(d), it is impossible to attain correct results. Further, since these images provide variation in pattern dimensions and results of edge detection on them are unstable, pattern line widths and hole diameters cannot be measured accurately. Conventionally, image focusing on an electron microscope is performed by adjusting a control current to an objective lens thereof while observing an electron beam image. This procedure requires a substantial amount of time and involves repetitive scanning on a surface of a specimen, which may cause a possible problem of specimen damage.

In Japanese Non-examined Patent Publication No. 258703/1993, there is disclosed a method intended for circumventing the abovementioned disadvantages, wherein an optimum control current to an objective lens for each surface height of a specimen is pre-measured at some points on the specimen and then, at the time of inspection, focus adjustment at each point is made by interpolation of pre-measured data. However, this method is also disadvantageous in that a considerable amount of time is required for measuring an optimum objective lens control current before inspection and each specimen surface height may vary during inspection depending on wafer holding conditions.

A focus adjustment method for a scanning electron microscope using an optical height detecting arrangement is found in Japanese Non-examined Patent Publication No. 254649/1988. However, since an optical element for height detection is disposed in a vacuum system, it is rather difficult to perform optical axis alignment.

In microstructure fabricating equipment using a convergent charged particle beam, focus adjustment of the charged particle beam has a significant effect on fabrication accuracy, i.e., focus adjustment is of extreme importance as in instruments designed for observation. Examples of microstructure fabricating equipment include an electron beam exposure system for forming semiconductor circuit patterns, a focused ion beam (FIB) system for repairing circuit patterns, etc.

In a scanning electron microscope, a method of measuring an optimum control current to an objective lens thereof through electron beam imaging necessitates attaining a plurality of electron beam images for detecting a focal point, thus requiring a considerable amount of time for focus adjustment. That is, such a method is not suitable for focusing in a short time. Further, in an application of automatic inspection or critical-dimension measurement over a wide range, focus adjustment at every point using the abovementioned method is not practicable, and it is therefore required to perform pre-measurement at some points before inspection and then estimate a height at each point through interpolation, for instance.

FIG. 22 shows an overview of an electron-beam automatic semiconductor device inspection system to which the present invention is directed. In such an automatic inspection system, a specimen wafer under inspection is moved by means of stages with respect to an electron optical system thereof for carrying out wide-range inspection.

A semiconductor wafer to be inspected in a fabrication process may deform due to heat treatment or other processing, and a degree of deformation will be on the order of some hundreds of micrometers in the worst case. However, it is extremely difficult to hold the specimen wafer stably without causing interference with electron optics in a vacuum specimen chamber, and also it is impossible to adjust specimen leveling as in an optical inspection system using vacuum chucking.

Further, since a substantial amount of time is required for inspection, a specimen holding state may vary due to acceleration/deceleration in reciprocating stage movement, thereby resulting in a specimen surface height being different from a pre-measured level.

For the reasons mentioned above, there is a rather high degree of possibility that a surface height of a specimen under inspection will vary unstably exceeding a focal depth of the electron optical system (a depth of focus is generally on the order of micrometers at a magnification of 100×, but that necessary for semiconductor device inspection depends on inspection performance requirements concerned). For focus adjustment using electron beam images, a plurality of electron images must be attained at each point of interest with each stage being stopped. It is impossible to conduct focus adjustment continuously while detecting a height at each point simultaneously with stage movement for the specimen under inspection.

In an approach that focus adjustment using electron beam images is performed at some points on a specimen surface before the start of inspection, an amount of time is required for calibration before inspection. This causes a significant decrease in throughput as a size of wafer becomes larger. Since there is a technological trend toward larger-diameter wafers, a degree of wafer deformation such as bowing or warping will tend to be larger, resulting in more stringent requirements being imposed on automatic focusing functionality. Depending on the material of a specimen, exposure with an electron beam may alter an electric charge state on specimen surface to cause an adverse effect on electron beam images used for inspection.

In consideration of the above, it is difficult to ensure satisfactory performance in long-period inspection on a scanning electron microscope instrument using the conventional methods. Where stable holding of a specimen is rather difficult, it is desirable to carry out specimen surface height detection in a range of electron optical observation immediately before images are attained during inspection. Further, where inspection is conducted while each stage is moved continuously, specimen surface height detection must also be carried out continuously at high speed without interrupting a flow of inspection operation. For realizing continuous surface height detection simultaneously with inspection, it is required to detect a height of each inspection position or its vicinity at high speed.

However, if any element which affects an electric or magnetic field, e.g., an insulating or magnetic element, is disposed in the vicinity of an observation region, electron beam scanning is affected adversely. It is therefore impracticable to mount a sensor in the vicinity of electron optics. Further, since the observation region is located in the vacuum specimen chamber, measurement must be enabled in a vacuum. For use in the vacuum specimen chamber, it is also desirable to make easy adjustment and maintenance available. While there have been described conditions as to an Example of an electron-beam inspection system, these conditions are also the same in a microstructure observation/fabrication system using an ion beam or any other convergent charged particle beam. Further, since there are the same conditions in such systems that images of an aperture, mask, etc. are formed or projected as well as in a system where a charged particle beam is converged into a single point, it is apparent that the present invention is applicable to charged particle beam systems comprising any charged particle beam optics for image formation/projection.

### BACKGROUND OF THE INVENTION

The present invention relates to an electron beam exposure or system inspection or measurement or processing apparatus having an observation function using charged particle beams such as electron beams or ion beams and its method and an optical height detection apparatus.

Heretofore, a focus of an electron microscope has been adjusted by adjusting a control current of an objective lens while an electron beam image is observed. This process requires a lot of time, and also, a sample surface is scanned by electron beams many times. Accordingly, there is the possibility that a sample will be damaged.

In order to solve the above-mentioned problem, in a prior-art technique (Japanese laid-open patent application No. 5-258703), there is known a method in which a control current of an optimum objective lens relative to a height of a sample surface in several samples are measured in advance before the inspection is started and focuses of respective points are adjusted by interpolating these data when samples are inspected.

In this method, SEM images obtained by changing an objective lens control current at every measurement point are processed, and an objective lens control current by which an image of a highest sharpness is recorded. It takes a lot of time to measure an optimum control current before inspection. Moreover, there is the risk that a sample will be damaged due to the irradiation of electron beams for a long time. Further, there is the problem that a height of a sample surface will be changed depending upon a method of holding a wafer during the inspection.

Moreover, as the prior-art technique of the apparatus for inspecting a height of a sample, there are known Japanese laid-open patent application No. 58-168906 and Japanese laid-open patent application No. 61-74338.

According to the above-mentioned prior art, in the electron beam apparatus, the point in which a clear SEM image without image distortion is detected and a defect of a very small pattern formed on the inspected object like a semiconductor wafer such as ULSI or VLSI is inspected and a dimension of a very small pattern is measured with high accuracy and with high reliability has not been considered sufficiently.

### BRIEF DESCRIPTION OF THE DRAWINGS

FIG. 1 is a block diagram showing the configuration of an inspection/measurement apparatus, which is an embodiment implementing a charged-particle beam apparatus provided by the present invention, in a simple and plain manner;

FIG. 2 is a diagrammatic top view of astigmatism correction coils;

FIG. 3 is a diagram showing a relation between astigmatism and beam-spot shapes;

FIGS. 4(a) and 4(b) are diagrams of patterns for focus and astigmatism correction according to the invention;

FIG. 5 is a flowchart representing image processing carried out by an image-processing circuit employed in the charged-particle beam apparatus shown in FIG. 1 to compute astigmatism and focus correction quantities;

FIG. 6 is a diagram showing curves representing relations among a computed directional sharpness value dθ(f), the astigmatic difference's magnitude δ and direction α and a focal offset z;

FIGS. 7(a) and 7(b) are diagrams each showing typical picture processing to find directional sharpness;

FIGS. 8(a) and 8(b) are diagrams each showing an Example of the shape of a sample serving as a calibration target for fast focus and astigmatism correction;

FIG. 9 is a flowchart representing processing carried out by the image-processing circuit employed in the charged-particle beam apparatus shown in FIG. 1 to compute astigmatism and focus correction quantities in the case of a calibration target shown in FIGS. 8(a) and 8(b);

FIG. 10 is a diagrammatic top view of a wafer and a visual-field moving sequence in the periodic calibration for focus and astigmatism drifts;

FIG. 11 is a graph representing a relation between the focus value and the sharpness and serving as a means for explaining a method of interpolating the position of a peak of a directional-sharpness curve;

FIG. 12(a) is a diagram showing the shapes of a beam at a variety of locations in the z direction;

FIGS. 12(b) and 12(c) are graphs each representing a relation between the focus value and the sharpness and serving as a means for explaining a case of a double-peak curve of directional sharpness;

FIG. 13 is a graph representing a relation between the focus value and the sharpness and serving as a means for explaining a method of using the center of gravity of a directional-sharp curve as a central position of the curve;

FIG. 14 is a graph representing a relation between the focus value and the sharpness and serving as a means for explaining a method of finding a central position of a directional-sharp curve by computing a weighted average of maximum-value positions;

FIGS. 15(a) and 15(b) are graphs representing a relation between the focus value and the sharpness and serving as a means for explaining a method of finding a central position of a directional-sharp curve by adopting a symmetry-matching technique;

FIG. 16 is a graph representing a relation between the focus value and the sharpness and serving as a means for explaining differences in characteristic, which are caused by the direction of a directional-sharpness curve;

FIG. 17 is a diagram which shows top views of a wafer and a graph representing a relation between the focus value and the sharpness, for explaining a method of finding degrees of directional sharpness in four directions with a higher degree of accuracy from two pictures obtained as a result of scanning operations in two directions;

FIG. 18 is a flowchart representing processing to correct astigmatism for a case in which the directional sharpness is computed by adopting the method shown in FIG. 17;

FIG. 19 is a diagram which shows top views of a wafer and graphs representing a relation between the focus value and the sharpness, for explaining a case in which the directional sharpness is shifted by an effect of a pattern existing in another direction;

FIG. 20 is a graph representing a relation between the focus value and the sharpness and serving as a means for explaining a principle underlying more precise correction of astigmatism by correcting the phenomenon shown in FIG. 19;

FIGS. 21(a)-21(d) show inspection of a wafer at different regions and electron beam images of the different regions;

FIG. 22 is a schematic sectional view showing an exemplary structure of an automatic inspection system according to the present invention;

FIG. 23 is a schematic sectional view of a height detection optical system for illustrating a principle of height detection;

FIG. 24 is a graph showing variation in reflectance with respect to incidence angle on each material;

FIG. 25 is a schematic sectional view of a specimen chamber, showing an example of altered disposition of height detection optical system parts;

FIG. 26 is a schematic sectional view of a specimen chamber, showing an arrangement in which the height detection optical system parts are disposed outside the specimen chamber;

FIG. 27 is a schematic sectional view of a specimen chamber, showing an arrangement in which the height detection optical system parts are disposed inside the specimen chamber;

FIG. 28 is a schematic sectional view of a specimen chamber, showing an arrangement in which optical path windows are formed along a plane of an external top wall of the specimen chamber;

FIG. 29 is a graph showing variation in reflectance with respect to incidence angle on glass BK7;

FIG. 30 is a schematic sectional view of a specimen chamber, showing an arrangement in which optical path windows are formed perpendicularly to an optical path on an external top wall of the specimen chamber;

FIG. 31 is a schematic sectional view illustrating chromatic aberration due to a glass window;

FIG. 32 is a schematic sectional view illustrating an arrangement in which a glass plate is inserted for correction of chromatic aberration due to a glass window;

FIG. 33 is a schematic sectional view illustrating another arrangement in which a glass plate is inserted in a different manner for correction of chromatic aberration due to a glass window;

FIGS. 34(a) and (b) are schematic sectional views showing a change in optical path size on a flat-plate electrode according to incidence angle;

FIG. 35 is a schematic sectional view showing a shape of an entrance opening on the flat-plate electrode in case of a circular optical aperture;

FIG. 36 is a schematic sectional view showing a shape of an entrance opening on the flat-plate electrode in case of an elliptical optical aperture;

FIG. 37 is a schematic sectional view showing an example of an window formed perpendicularly to an optical path on the flat-plate electrode;

FIG. 38 is a schematic top view showing an example of disposition in which a window is provided in a circumferential form symmetrically with respect to an optical axis of an electron beam optical system;

FIG. 39 is a schematic top view showing an example of disposition in which windows are provided symmetrically with respect to an axis of deflection direction;

FIG. 40 is a schematic top view showing another example of disposition in which windows are provided in a parallel form symmetrically with respect to an axis of deflection direction;

FIG. 41 is a perspective view of a standard calibration pattern having a slope part;

FIG. 42 is a schematic section view showing an automatic inspection system in which the standard calibration pattern is secured to an X-Y stage;

FIG. 43 is a graph for explaining a relationship between objective lens control current and specimen surface height;

FIG. 44 is a perspective view of a standard calibration pattern having two step parts;

FIG. 45 is a schematic sectional view showing an automatic inspection in which the standard calibration pattern is mounted on a Z stage;

FIG. 46 shows a relationship between deviation in measurement position and error in height detection;

FIGS. 47(a) and (b) show views of a specimen surface for explaining a method of presuming an observation region height using height data detected continuously;

FIGS. 48(a)-(c) show views of a specimen surface for explaining a method of presuming an observation region height using height data detected continuously;

FIGS. 49(a) and (b) show views of a specimen surface for explaining a method of presuming an observation region height using height data detected continuously in a different manner;

FIG. 50 is a schematic sectional view of a specimen chamber in which a height detection optical system can be moved in parallel to an electron optical system;

FIG. 51 is a schematic section view of a specimen for explaining a height detection error due to non-uniform reflectance on a specimen surface;

FIG. 52 is a schematic sectional view of an optical system in which two slit light beams are projected symmetrically for detection;

FIGS. 53(a)-(c) show diagrams for explaining height detection using a plurality of fine slit light beams;

FIGS. 54(a)-54(d) (similar to FIGS. 21(a)-21(d)) show a semiconductor wafer and image obtained at different areas thereof so as to explain that electron beams need be focused on an inspected object such as a semiconductor wafer in an electron beam inspection according to the present invention;

FIG. 55 is a schematic diagram of an electron beam apparatus (SEM apparatus) according to an embodiment of the present invention;

FIG. 56 is a schematic diagram showing an electron beam inspection apparatus (SEM inspection apparatus) according to an embodiment of the present invention;

FIG. 57 shows an electron beam inspection apparatus (SEM inspection apparatus) according to an embodiment of the present invention;

FIGS. 58(a)-(c) show a semiconductor wafer in which a semiconductor memory is formed according to the present invention and enlarged portions thereof;

FIGS. 59(a) and (b) show a detection image f1(x, y) and a comparison image g1(x, y) which are compared and inspected in the electron beam inspection apparatus (SEM inspection apparatus) according to the present invention;

FIG. 60 shows an electron beam inspection apparatus (SEM inspection apparatus) according to another embodiment of the present invention;

FIG. 61 shows a pre-processing circuit forming a part of FIGS. 57 and 60;

FIG. 62 shows curves for explaining the contents that are corrected by the pre-processing circuit shown in FIG. 61;

FIG. 63 shows a height detection optical apparatus according to an embodiment of the present invention;

FIGS. 64(a) and (b) are used to explain a principle in which a detection error is reduced by a multi-slit;

FIG. 65 is a diagram used to explain a detection error caused by a multiple reflection on a transparent film such as an insulating film existing on a semiconductor wafer or the like;

FIG. 66 shows a graph graphing the change of a reflectance versus an incident angle in silicon and resist (a transparent film such as an insulating film) existing on a semiconductor wafer or the like;

FIG. 67 shows waveforms used to explain a height detection algorithm processed by a height calculating unit of a height detection apparatus according to an embodiment of the present invention;

FIG. 68 shows an arrangement in which a measured position displacement is canceled out by both-side projections of a height detection optical apparatus in a height detection apparatus according to a second embodiment of the present invention;

FIG. 69 shows an arrangement in which a detection error is reduced by a polarizing plate of a height detection optical apparatus in a height detection apparatus according to a third embodiment of the present invention;

FIG. 70 is a diagram used to explain the manner in which a detection error caused by a detection position displacement when a sample is inclined in the height detection optical apparatus according to the present invention;

FIG. 71 is a diagram used to explain the manner in which a detection error caused by the inclination of a sample is eliminated in the height detection optical apparatus according to the present invention;

FIGS. 72(a) and (b) are diagrams used to explain the manner in which a height is detected by the selection of the slit under the condition that a detection position is not displaced by a height of a sample surface in the height detection apparatus according to the present invention;

FIG. 73 is a diagram used to explain a height detection which can correct a detection position displacement caused by a detection time delay and a sample scanning on the basis of the selection of the slit in the height detection apparatus according to the present invention;

FIG. 74 is a diagram used to explain the manner in which a height of an arbitrary point can be detected by using detected surface-shape data in the height detection apparatus according to the present invention;

FIG. 75 is a diagram used to explain a detection time delay correction method that can be used regardless of a scanning direction of a stage and a projection-detection direction of a multi-slit in the height detection apparatus according to the present invention;

FIG. 76 is a diagram used to explain a detection time delay correction method that can be used regardless of a scanning direction of a stage and a projection-detection direction of a multi-slit in the height detection apparatus according to the present invention;

FIG. 77 is a diagram used to explain the manner in which a dynamic focus adjustment of electron beam is executed by using surface shape data detected from the height detection apparatus according to the present invention;

FIG. 78 shows an arrangement in which a measured position displacement is canceled out by both-side projections in a height detection optical apparatus according to another embodiment of the present invention;

FIG. 79 shows an arrangement in which a measured position displacement is canceled out by both-side projections in a height detection optical apparatus according to another embodiment of the present invention;

FIG. 80 shows an embodiment in which the same position is constantly detected by elevating and lowering a detector in a height detection optical apparatus according to the present invention;

FIG. 81 is a diagram showing a direction of a projection slit and a pattern on a sample in a height detection optical apparatus according to the present invention;

FIGS. 82(a) and (b) are diagrams showing a detection position displacement and the manner in which a detection position displacement is decreased in a height detection optical apparatus according to the present invention;

FIG. 83 shows an example of an arrangement in which a height distribution on a surface is measured in a height detection optical apparatus according to the present invention;

FIG. 84 shows waveforms used to explain the embodiment in which a position of a multi-slit pattern is detected by a Gabor filter which is a height detection algorithm processed by a height calculating means in a height detection apparatus according to the present invention;

FIG. 85 is a graph in which a slit edge position which is a height detection algorithm processed by a height calculating means is measured in a height detection apparatus according to the present invention;

FIGS. 86(a) and (b) show an embodiment in which a position of a multi-slit image is measured by a vibrating mask in a height detection apparatus according to the present invention;

FIG. 87 shows an electron beam apparatus in which a standard pattern for correction is disposed on an X-Y stage;

FIG. 88 shows in a perspective view a standard pattern for correction with an inclined portion;

FIGS. 89(a)-(c) are graphs used to explain a correction curve obtained by a standard pattern for correction in an electron beam apparatus according to the present invention;

FIGS. 90(a) and (b) show in perspective view standard patterns for correction according to other embodiments of the present invention;

FIG. 91 is a flowchart showing a processing for calculating a parameter for correction;

FIG. 92 is a flowchart in which a stage is driven at a constant speed and an appearance is inspected while an error is corrected by using a correction parameter in an electron beam inspection apparatus according to the present invention;

FIG. 93 is a schematic diagram showing an optical appearance inspection apparatus according to another embodiment of the present invention; and

FIGS. 94(a) and (b) show multi-slit patterns in which the center spacing between the multi-slit patterns is increased and in which the center slit is made wider, respectively.

### DETAILED DESCRIPTION

More particularly, a description will be made of a charged-particle beam apparatus, an automatic astigmatism correction method and a sample used in adjustment of astigmatism of a charged-particle beam according to preferred embodiments of the present invention with reference to the drawings. Mathematical formula within the disclosure gleaned from the first application will be referenced as “equations” (Eq.).

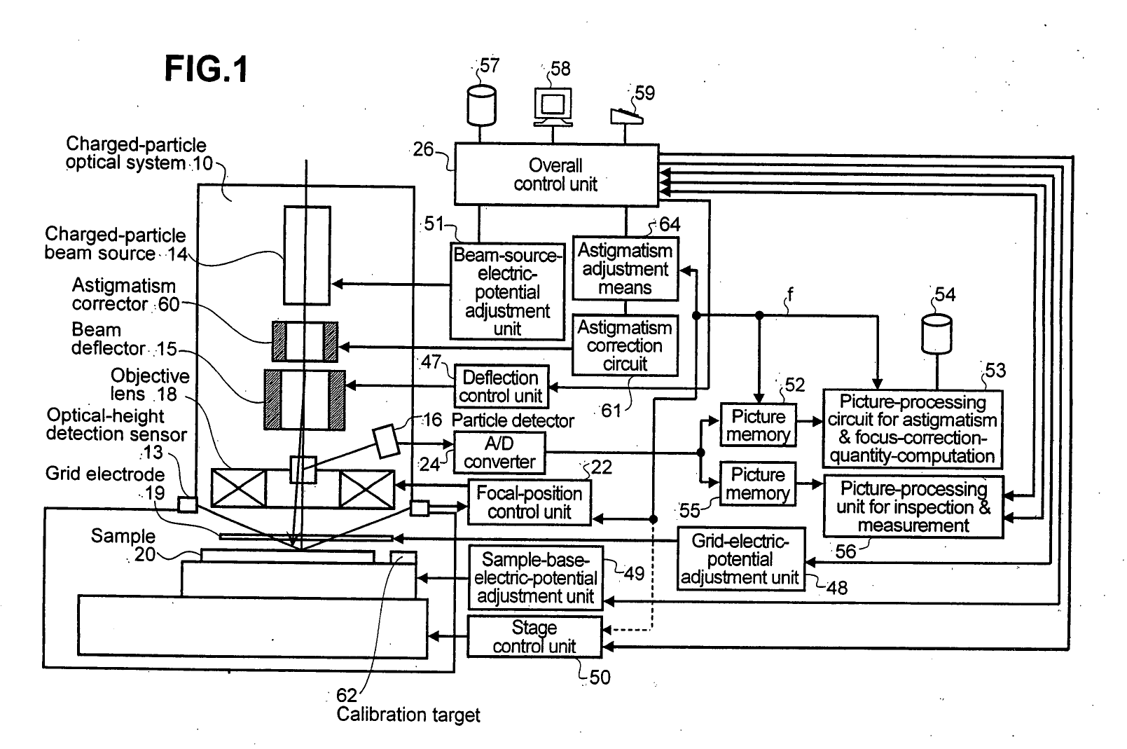

As shown in FIG. 1, the inspection/measurement apparatus, which is an embodiment implementing a charged-particle beam apparatus provided by the present invention, comprises a charged-particle optical system 10, a control system and an image-processing system. The control system controls a variety of components which make up the charged-particle optical system 10. On the other hand, the image-processing system carries out processing on an image based on secondary particles or reflected particles. The secondary particles or the reflected particles are detected by a particle detector 16 employed in the charged-particle optical system 10.

The charged-particle optical system 10 comprises a charged-particle beam source 14, an astigmatism corrector 60, a beam deflector 15, an objective lens 18, a sample base 21, an XY stage 46, a grid electrode 19, a retarding electrode (not shown in the figure), an optical-height detection sensor 13 and the particle detector 16. The charged-particle beam source 14 emits a charged-particle beam, such as an electron beam or an ion beam. By application of an electric field, the astigmatism corrector 60 corrects astigmatism of the charged-particle beam emitted by the charged-particle beam source 14. The beam deflector 15 carries out a scanning operation by deflecting the charged-particle beam emitted by the charged-particle beam source 14. By using a magnetic field, the objective lens 18 converges the charged-particle beam deflected by the beam deflector 15. On the sample base 21, a sample 20 is mounted. A target 62 for calibration use is fixed at a location on the sample base 21 beside the sample 20. The n stage 46 moves the sample base 21. The grid electrode 19 has an electric potential close to ground potential. Provided on the sample base 21, the retarding electrode has a negative electric potential if the charged-particle beam radiated to the sample 20 and the calibration target 62, which are provided on the sample base 21, is an electron beam, but has a positive electric potential if the charged-particle beam is an ion beam. The optical height detection sensor 13 measures the height of the sample 20 or the like by adopting a typical optical technique. The particle detector 16 detects secondary particles emitted from the surface of the sample 20 as a result of radiation of the charged-particle beam to the sample 20. The particle detector 16 may also detect particles reflected by a typical reflecting plate. It should be noted that the astigmatism corrector 60 can be an astigmatism correction coil based on use of a magnetic field or an astigmatism correction electrode based on use of an electric field. In addition, the objective lens 18 can be an objective coil based on use of a magnetic field or an electrostatic objective lens based on use of an electric field. Furthermore, the objective lens 18 may be provided with a coil 18a for focus correction. In this way, the astigmatism corrector 60, an astigmatism correction circuit 61 and other components constitute an astigmatism adjustment means.

A stage control unit 50 controllably drives the movement (the travel) of the XY stage 46 while detecting the position (or the displacement) of the XY stage 46 in accordance with a control command issued by an overall control unit 26. It should be noted that the XY stage 46 has a position-monitoring meter for monitoring the position (or the displacement) of the XY stage 46. The monitored position (or the displacement) of the XY stage 46 can be supplied to the overall control unit 26 by way of the stage control unit 50.

A focal-position control unit 22 controllably drives the objective lens 18 in accordance with a command issued by the overall control unit 26 and on the basis of the sample surface's height measured by the optical height detection sensor 13, so as to adjust the focus of the charged-particle beam to a position on the sample 20. It should be noted that by adding a Z-axis component to the XY stage 46, the focus can be adjusted by controllably driving the Z-axis component instead of the objective lens 18. In this way, a focus control means can be configured to include the objective lens 18 or the Z-axis component and the focal-position control unit 22.

A deflection control unit 47 supplies a deflection signal to the beam deflector 15 in accordance with a control command issued by the overall control unit 26. In this case, the deflection signal may be properly corrected so as to compensate for variations in magnification, which accompany variations in surface height of the sample 20, and a picture rotation accompanying control of the objective lens 18.

In accordance with an electric-potential adjustment command issued by the overall control unit 26, a grid-electric-potential adjustment unit 48 adjusts an electric potential given to the grid electrode 19 provided at a position above and close to the sample 20. On the other hand, in accordance with an electric-potential adjustment command issued by the overall control unit 26, a sample-base-electric-potential adjustment unit 49 adjusts an electric potential given to the retarding electrode provided at a position above the sample base 21. In this way, the grid electrode 19 and the retarding electrode can be used for giving a negative or positive electric potential to the sample 20 in order to reduce the velocity of an electron beam or an ion beam traveling between the objective lens 18 and the sample 20. Thus, the resolution in a low-acceleration-voltage area can be improved.

In accordance with a command issued by the overall control unit 26, a beam-source-electric-potential adjustment unit 51 adjusts the electric potential applied to the charged-particle beam source 14 in order to adjust the acceleration voltage of the charged-particle beam emitted by the charged-particle beam source 14 and/or adjust the beam current.

The beam-source-electric-potential adjustment unit 51, the grid-electric-potential adjustment unit 48 and the sample-base-electric-potential adjustment unit 49 are controlled by the overall control unit 26 so that a particle image with a desired quality can be detected by the particle detector 16.

In the correction of astigmatism and focus, an astigmatism adjustment unit 64 provided in accordance with the present invention issues a control command for changing the focal position (a focus f) to the focal-position control unit 22 so that the focal-position control unit 22 controllably drives the objective lens 18. As a result, while the charged-particle beam is being radiated to an area on the sample 20 or the calibration target 62, the focus is changed. In the area, a pattern including edge elements of the same degree in all directions, like one shown in FIG. 4(a) or 4(b), is created. By doing so, the particle detector 16 detects a plurality of particle-image signals with varied focuses f, and the particle-image signals are each converted by an A/D converter 24 into a particle digital image signal (or digital image data), which is stored in a digital memory 52, being associated with a focus command value f output by the astigmatism adjustment unit 64. Then, an astigmatism & focus-correction-quantity-computation image-processing circuit 53 reads out the plurality of particle image picture signals having varied focuses. The astigmatism & focus-correction-quantity-computation image-processing unit 53 then finds degrees of directional sharpness d0(f), d45(f), d90(f) and d135(f) for the particle digital image signals each associated with a focus command value f. Then, the astigmatism & focus-correction-quantity-computation image-processing unit 53 finds focus values f0, f45, f90 and f135 at which the degrees of directional sharpness d0(f), d45(f), d90(f) and d135(f) respectively each reach a peak. From the focus values f0, f45, f90 and f135, the astigmatism & focus-correction-quantity-computation image-processing unit 53 then finds an astigmatic difference and a focal offset z. The astigmatic difference can be an astigmatic-difference vector (dx, dy) or the astigmatic difference's direction α and magnitude δ. The astigmatic difference and the focal offset z are supplied to the overall control unit 26 to be stored in a storage unit 57.

The overall control unit 26 computes astigmatism correction quantities (Δstx, Δsty) for the astigmatic differences found as described above and stored in the storage unit 57 from a relation between the astigmatic difference and the astigmatism correction quantity. The relation between the astigmatic difference and the astigmatism correction quantity is found in advance as a characteristic of the astigmatism corrector 60. The overall control unit 26 also computes a focus correction quantity for the focal offset z found as described above and stored in the storage unit 57 from a relation between the focal offset z and the focus correction quantity. The relation between the focal offset z and the focus correction quantity is found in advance as a characteristic of the objective lens 18. The astigmatism correction quantities (Δstx, Δsty) and the focus correction quantity, which are found by the overall control unit 26, are supplied to the astigmatism adjustment unit 64.

The astigmatism adjustment unit 64 provides the astigmatism correction quantities (Δstx, Δsty) received from the overall control unit 26 to an astigmatism correction circuit 61 so that the astigmatism corrector 60 is capable of correcting the astigmatism of the charged-particle beam. The astigmatism corrector 60 comprises an astigmatism correction coil based on a magnetic field or an astigmatism correction electrode based on an electric field. The astigmatism adjustment unit 64 supplies the focus correction quantity to the focal-position control unit 22 so as to control a coil current flowing to the objective lens 18 or a coil current flowing to a focus correction coil 18a (not shown in the figure). As a result, the focus is corrected.

As another method, a Z-axis component is provided as a portion of the XY stage 46. In this case, the astigmatism adjustment unit 64 issues a control command for moving the focus back and forth or changing the height of the sample 20 to a stage control unit 50 by way of the overall control unit 26 or directly. In accordance with this control command, the stage control unit 50 drives the Z-axis component in the direction of the Z axis in order to move the focus back and forth, so that a particle picture with a varying focus is obtained from the particle detector 16. Then, the astigmatism & focus-correction-quantity-computation image-processing unit 53 determines the astigmatism correction quantities and a focus correction quantity. The focus correction quantity is fed back to the Z-axis component of the XY stage 46, while the astigmatism correction quantities are fed back to the astigmatism corrector 60. The fed-back quantities are used for correction. Of course, the component for acquiring an image by moving the focus back and forth is different from the component for carrying out final focus correction. That is to say, one of the components may be the focal-position control unit 22, while the other component may be the Z-axis component of the XY stage 46. As an alternative, it is nice to control both components at the same time as a combination so as to adjust the position of the sample 20 or the calibration target 62 relative to the focal position to a desired distance. It should be noted that, by controlling the objective lens 18 rather than the Z-axis component, excellent responsiveness can be obtained.

As described above, the correction of the astigmatism and the focus is based on control executed by the astigmatism adjustment unit 64 in accordance with a command issued by the overall control unit 26. The overall control unit 26 receives a particle image with corrected astigmatism and a corrected focus, which are values stored in the image memory 52, directly or by way of the astigmatism & focus-correction-quantity-computation image-processing unit 53, and displays the image on a display means 58. As a result, the overall control unit 26 is capable of allowing the operator to visually examine corrected data, such as the astigmatism, and indicate acceptance or denial of the corrected data.

In addition, during an inspection and/or a measurement, for example, the XY stage 46 is controlled to bring a predetermined position on the sample 20 to the visual field of the charged-particle optical system. Then, the particle detector 16 acquires a particle-image signal, which is converted by the A/D converter 24 into a particle digital image signal to be stored in an image memory 55.

Subsequently, on the basis of the detection particle digital image signal stored in the image memory 55, an inspection & measurement image-processing circuit 56 measures the dimensions of a fine pattern created on the sample 20 and/or inspects a fine pattern generated on the sample 20 for a defect inherent in the pattern and/or for a defect caused by a foreign material. Results of the measurement and the inspection are supplied to the overall control unit 26. By correcting the astigmatism and the focus in accordance with the present invention at least periodically in this way, it is possible to implement inspection or measurement based on a particle image in which the aberration thereof is always corrected.

It should be noted that, in the case of particle-image-based inspection of a defect or the like, the inspection & measurement image-processing unit 56 repeatedly delays a detected detection particle digital image signal by a period of time corresponding to a pattern in order to create a reference particle digital image signal. The inspection & measurement image-processing unit 56 then compares the detection particle digital image signal with the reference particle digital image signal by making the position of the former coincide with the position of the latter in order to detect a discrepancy or a difference image as a defect candidate. Then, the inspection & measurement image-processing unit 56 carries out processing wherein a characteristic quantity of the defect candidate is extracted and false information to be eliminated from the characteristic quantity is identified. As a result, the sample 20 can be inspected for a true defect.

Since the effects of charge-up, dirt, damage and the like on the sample 20 are small, the optical height detection sensor 13 is capable of detecting variations in surface height of the sample 20 at the time of inspection or measurement of positions. The detected variations are fed back to the focal-position control unit 22 so that an in-focus state can always be maintained. If the optical height detection sensor 13 is used in this way, by carrying out automatic adjustment of astigmatism and focus at another position on the sample 20, or at the calibration target 62 placed on the sample base 21, either in advance or periodically during an inspection or a measurement, the radiation of a converged charged-particle beam used for the automatic adjustment of astigmatism and focus can be removed from the actual sample 20, or reduced substantially. As a result, the effects of charge-up, dirt, damage and the like on the sample 20 can be eliminated.

The following description is directed to the automatic adjustment of astigmatism and focus in the converged charged-particle optical system provided by the present invention. In accordance with the present invention, astigmatism values and focal offsets are collected from a small number of 2-dimensional particle images, and are converted into astigmatism and focus correction quantities, which are used in one correction.

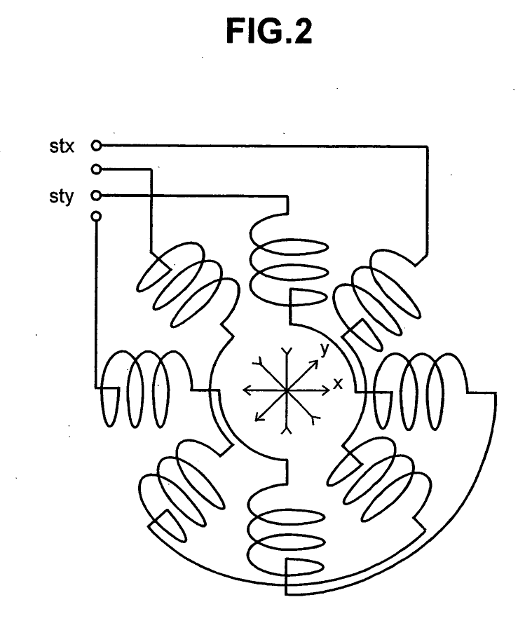

FIG. 2 is a diagram showing a configuration comprising two sets of astigmatism correction coils based on the use of a magnetic field to provide the astigmatism corrector 60. In a configuration comprising two sets of astigmatism correction coils, a current flowing through the coils composing one of the sets stx and sty shown in FIG. 2 has an effect to stretch the beam in one direction, but to shrink the beam in a direction perpendicular to the one direction. If the sets are controlled as a combination, with one of the sets being shifted 45-degrees relative to the other, the astigmatism can be adjusted by a required amount in any arbitrary direction. Of course, the astigmatism corrector 60 can also be configured to comprise electrodes based on the use of an electric field.

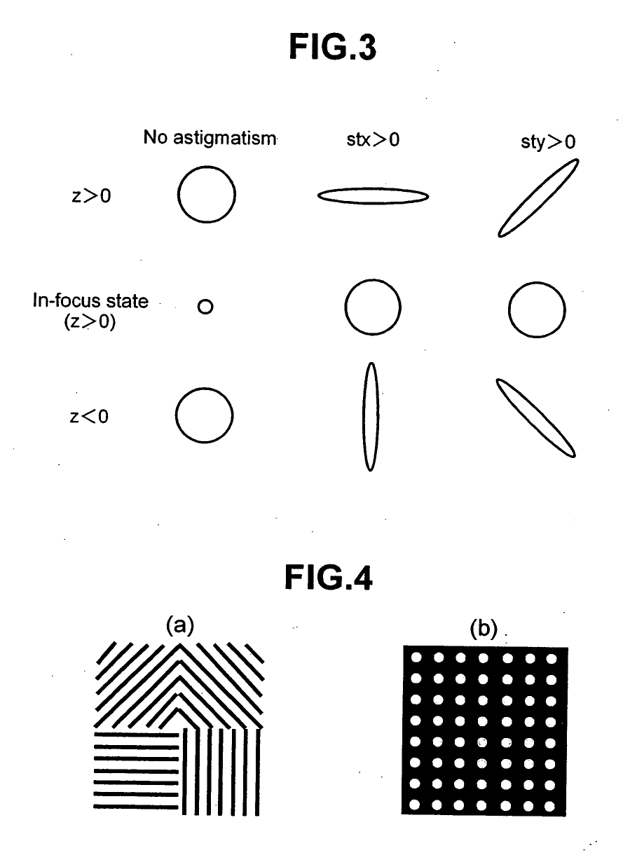

Next, the state of astigmatism will be explained with reference to FIG. 3. On the left side in FIG. 3, there is a column of shapes of a converged charged-particle beam in which the astigmatism has been corrected. The top circle represents the shape of a converged charged-particle beam with a high focal position (Z>0). The middle circle represents the shape of a converged charged-particle beam in an in-focus state (Z=0). The bottom circle represents the shape of a converged charged-particle beam with a low focal position (Z<0). As shown by the shapes on the left side in FIG. 3, a converged charged-particle beam in an in-focus state is converged to a small point, and the top and bottom circles have diameters that are enlarged symmetrically with respect to the middle circle.

In the middle of FIG. 3, there is a column of shapes of a converged charged-particle beam which result when a current flows through the coils of the set stx to generate an astigmatism. For Z>0, the beam is stretched in the horizontal direction. For Z<0, the beam is stretched in the vertical direction. In an in-focus state, the cross section of the beam becomes circular, but the diameter of the cross section is not reduced sufficiently.

On the right side of FIG. 3, there is a column of shapes of a converged charged-particle beam which result when a current flows through the coils of the set sty to generate a shift from an in-focus position. The cross section of the beam becomes elliptical and is oriented in 45-degree directions. The direction of the long axis of the elliptical cross section for Z>0 is perpendicular to the direction for z<0.

Thus, by causing currents to flow to both of the sets stx and sty, astigmatism of any arbitrary orientation can be deliberately generated in any arbitrary direction. As a result, pre-adjustment astigmatism of the charged-particle optical system can be canceled by the deliberately generated astigmatism to result in a corrected astigmatism.

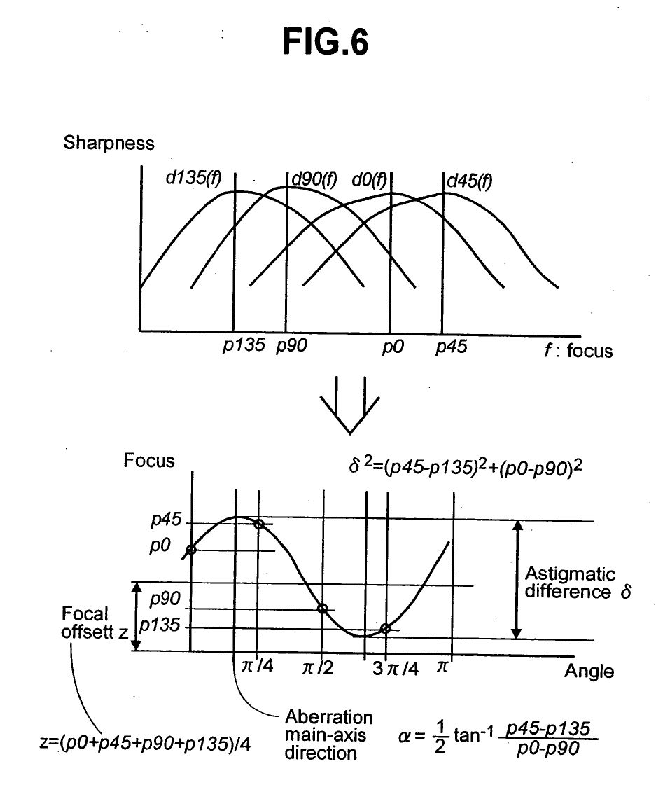

That is to say, in a state in which an astigmatism is being generated, the charged-particle beam blurs into an elliptical shape for a shift from an in-focus condition, as shown in FIG. 3. At positions ±Z on either side of the focus position, the elliptical shape of the beam becomes thinnest, and the orientation of the ellipse at the position +Z is perpendicular to the orientation thereof at the position −Z. The magnitude of the astigmatic difference is expressed by the focal distance 2Z between these two positions, while the direction of the astigmatic difference is represented by the orientation of the ellipse. The focal distance 2Z between these two positions is referred to as an astigmatic difference, which is denoted by notation δ in FIG. 6. The direction of the astigmatic difference is denoted by an astigmatic difference's direction a in FIG. 6. In addition, a vector representing the astigmatic difference can also be expressed by the notation (dx, dy).

Next, correction of the astigmatism and the focus will be explained with reference to FIGS. 4(a) to 7(b). FIGS. 4(a) and 4(b) are diagrams each showing an example of a pattern created on the sample 20 or the calibration target 62 to be used for correction of focus and astigmatism. As a pattern for correcting astigmatism and focus, it is nice to use a pattern including edge elements generated by the astigmatism in three or more directions to the same degree. FIG. 4(a) is a diagram showing a stripe pattern created over four different areas having stripe directions that are different from each other. FIG. 4(b) is a diagram showing a circle pattern having edge elements in four directions with circles being distributed two dimensionally at predetermined pitches. In the case of a pattern on a sample, in particular, it is possible to use a pattern that has been created to include edge elements in three or more directions to the same degree. In this case, however, information on a position at which this pattern is created is supplied to the overall control unit 26 in advance by use of an input means 59 and stored in the storage unit 57. As an alternative, it is necessary for the operator to specify a position on a proper sample used for correcting astigmatism and focus. In addition, of course, information on a position at which the calibration target 62 is placed on the sample base 21 is supplied to the overall control unit 26 in advance by use of the input means 59 and is stored in the storage unit 57.

For the reasons described above, first of all, the XY stage 46 is controllably driven on the basis of positional information of a pattern for correction of astigmatism and focus to position the pattern at a location in close proximity to the optical axis of the charged-particle optical system. The positional information is supplied by the overall control unit 26 to the stage control unit 50. Then, while the charged-particle beam is being radiated to the pattern for correction of astigmatism and focus in a scanning operation in response to a command issued by the overall control unit 26 to the deflection control unit 47, the astigmatism adjustment unit 64 issues commands to the focal-position control unit 22 to have the following operations take place:

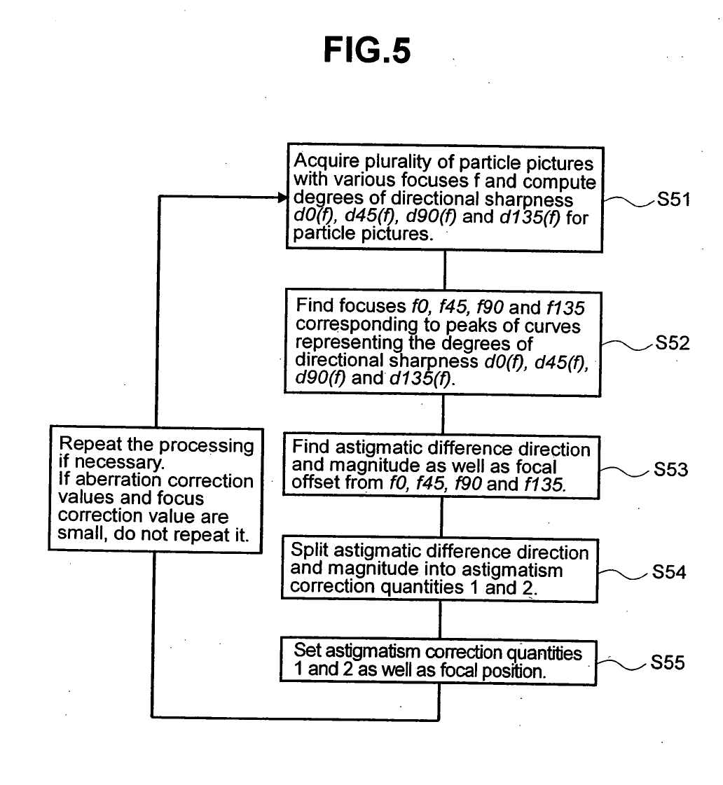

(1) At a step S51 in the flowchart shown in FIG. 5, the particle detector 16 is driven to acquire a plurality of images, while the focus f is being changed, and store the images in the image memory 52; and, the astigmatism & focus-correction-quantity-computation image-processing unit 53 is driven to compute the degrees of directional sharpness at angles of 0, 45, 90 and 135 degrees for the images, producing d0(f), d45(f), d90(f) and d135(f), which are shown in the upper part of FIG. 6. Incidentally, the focus value f is acquired as a command value issued from the astigmatism adjustment unit 64 and supplied to the focal-position control unit 22. It should be noted that, as will be described later, the focus f is changed in two or more scanning directions in image processing so as to improve the precision.

(2) Subsequently, at the next step S52, the astigmatism & focus-correction-quantity-computation image-processing unit 53 is driven to find center positions p0, p45. p90 and p135 of curves representing the degrees of directional sharpness at the angles of 0, 45, 90 and 135 degrees, namely, d0(f), d45(f), d90(f) and d135(f), respectively, each as a function of the focus f as shown in the upper part of FIG. 6.

(3) Then, at the following step S53, the astigmatism & focus-correction-quantity image-processing unit 53 is driven to find a focal-position shift (astigmatic difference) direction α and magnitude δ, as well as a focal offset z, in a direction caused by the astigmatic difference from a sinusoidal relation shown in the lower part of FIG. 6 for each of the center positions p0, p45, p90 and p135, and supply these quantities to the overall control unit 26 so as to be stored in the storage unit 57. It should be noted that, at the step S53, it is not absolutely necessary to find the astigmatic difference direction α and magnitude δ6. Instead, only a vector (dx, dy) representing the astigmatic difference needs to be found. The magnitude 5 of the astigmatic difference is represented by Eq. (1) below. The direction α of the astigmatic difference (or the direction of the focal-position shift) is expressed by Eq. (2) below. The focal offset z is represented by Eq. (3) below.

$$\begin{matrix}\begin{matrix}δ 2 = {( p 0 - p 90 )}^{2} + {( p 45 - p 135 )}^{2} \\ = {( dx )}^{2} + {dy}^{2}\end{matrix} & ( 1 ) \\ \begin{matrix}α = ( 1 / 2 ) {tan}^{- 1} ( ( p 45 - p 135 ) / ( p 0 - p 90 ) ) \\ = ( 1 / 2 ) {tan}^{- 1} ( ( dy / dx ) )\end{matrix} & ( 2 ) \\ z = ( p 0 + p 45 + p 90 + p 135 ) / 4 & ( 3 )\end{matrix}$$

It should be noted that a storage unit 54 is used for storing, among others, a program for finding the degrees of directional sharpness d0(f), d45(f), d90(f) and d135(f), a program for finding the center positions p0, p45, p90 and p135 from the degrees of directional sharpness d0(f), d45(f), d90(f) and d135(f) and a program for finding the astigmatic difference and the offset value. The astigmatism & focus-correction-quantity-computation image-processing unit 53 is capable of executing these programs. The storage unit 54 can be a ROM or the like.

(4) There has been found in advance a relation between variations in astigmatism control values (stx, sty), which are characteristics of the astigmatism corrector 60, and variations in astigmatic difference direction α and magnitude δ or variations in the astigmatic-difference vector (dx, dy). The variations in the astigmatic difference direction α and magnitude δ or variations in astigmatic-difference vector (dx, dy) are known as sensitivity. Thus, at the next step S54, the overall control unit 26 is capable of converting and splitting the astigmatic difference direction α and magnitude δ or the vector (dx, dy) into required astigmatism correction quantities (1, 2) (Δstx, Δsty) on the basis of this relation. Then, at the next step S55, the overall control unit 26 is capable of setting the astigmatism correction quantities (1, 2) (Δstir, Δsty) as well as a focal offset z and supplying them to the astigmatism adjustment unit 64. It should be noted that the astigmatism correction quantities (1, 2) (Δstx, Δsty) and the focal offset z can also be computed by the astigmatism & focus-correction-quantity-computation image-processing unit 53, instead of the overall control unit 26. In this case, the astigmatism & focus-correction-quantity-computation image-processing unit 53 receives characteristics of the astigmatism corrector 60 and the objective lens 18 from the overall control unit 26.

(5) The astigmatism adjustment unit 64 transmits the focal offset z received from the overall control unit 26 to the focal-position control unit 22, which uses the focal offset z to correct an objective-coil current flowing through the objective lens 18, or a focus correction coil current flowing through the focus correction coil 18a. The astigmatism adjustment unit 64 transmits the astigmatism correction quantities (Δstx, Δsty) received from the overall control unit 26 to an astigmatism correction circuit 61, which uses the astigmatism correction quantities (Δstx, Δsty) to correct an astigmatism correction coil current or an astigmatism correction static voltage. In this way, the correction and the adjustment of the astigmatism can be carried out at the same time.

(6) For a small astigmatism, an auto-stigma operation is completed in one processing as described above. For a large astigmatism, however the correction cannot be completed in one processing due to causes of the aberration other than astigmatism. Examples of such causes are high-order astigmatism and picture distortion. In this case, the processing goes back to step (1) to apply an auto stigma and repeat the loop until the astigmatism correction quantities (Δstx, Δsty) and the focal offset z are reduced to small values.

In accordance with the method described above, it is possible to implement simultaneous adjustment of astigmatism and focus in a short period of time with little damage inflicted upon the sample 20 and the calibration target 62. In addition, by comparing the directional sharpness of images of the same sample 20 or the same calibration target 62, while varying the focal distance, an astigmatic difference can be found. Thus, the simultaneous adjustment of astigmatism and focus can be implemented independently of a pattern on the sample 20 or the calibration target 62, that is, a pattern for astigmatism and focus correction. The only condition imposed on the pattern on the sample 20 or the calibration target 62 is that the pattern shall include edge elements to the same degree in all directions.

In the embodiment described above, four types of directional sharpness at θ=0, 45, 90 and 135 degrees are used. It should be noted, however, that if the astigmatic difference direction α and magnitude δ are known, not all the four directions at θ=0, 45, 90 and 135 degrees need be used. That is to say, only degrees of directional sharpness dθ(f) for at least 3 angles θ corresponding to three directions are required. In this case, for each value of θ, a center position pθ of the curve dθ(f) is found. Then, a sinusoidal waveform or a waveform close to the sinusoidal waveform is applied to pθ. The astigmatic difference direction α and magnitude δ can be found as the phase and the amplitude of the sinusoidal waveform, respectively.

The following description is directed to a specific embodiment implementing processing carried out by the astigmatism & focus-correction-quantity-computation image-processing unit 53 to find the directional sharpness of a particle image.

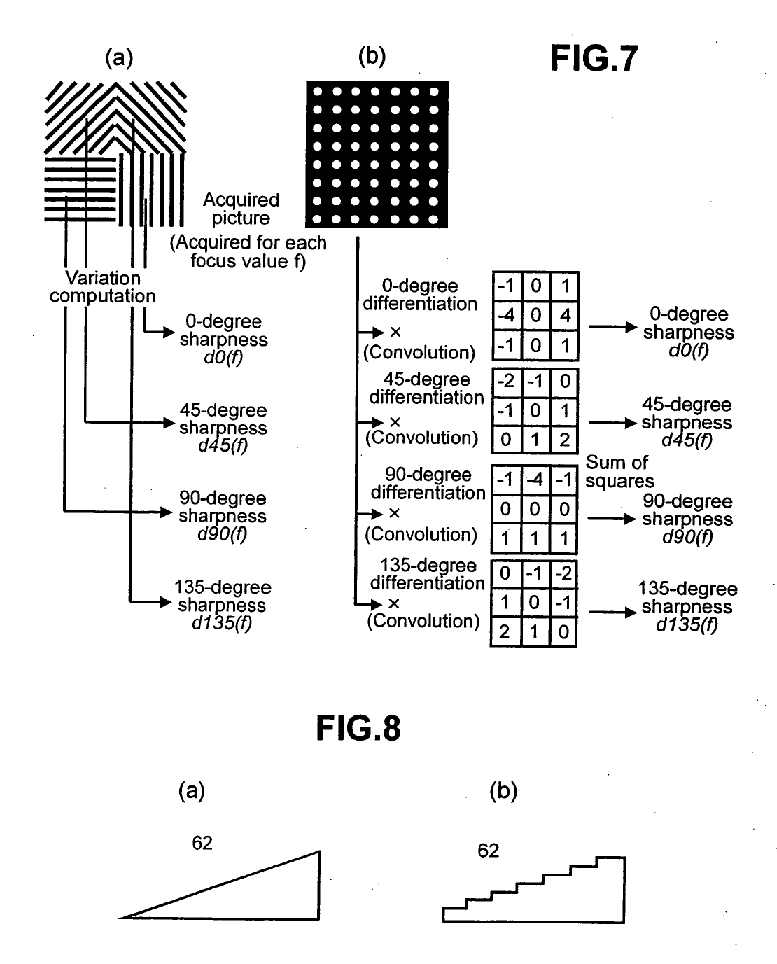

As a first embodiment, a particle image is detected and observed by the particle detector 16. The particle image is detected by radiating a charged-particle beam to a sample (target) 62 in a scanning operation. The target 62 is used specially for automatic correction of astigmatism. The sample 62 has a striped pattern with a stripe direction varying from area, to area as shown in FIG. 7(a). The directional sharpness dθ is found by measuring the amplitude of a particle image in each area. The amplitude can be found by directly measuring an amplitude {=a maximum value of s (x, y)−a minimum value of s (x, y)} in each area or by measuring a variance of a concentration quantity (gradation quantity) of a particle image in each area. The variation V is expressed by the following equation:
V=Σxy(s(x,y)−s mean)2/N.
As an alternative, the amplitude can also be found by computing a sum of absolute values Σxy|t(x, y)| or a sum of squares Σxy(t(x, y))², where notation t (x, y) denotes a differential obtained as a result of 2-dimensional differentiation, such as Laplacian differentiation, of s(x,y), notation |t(x,y)| denotes the absolute value of the differential t(xy) and notation (t(x,y))² denotes the square of the differential t(x,y). In this case, the result defines the directional sharpness dθ. The angular direction θ can be defined in any way. In the figure, an angular direction of 0 degrees is defined for a normal direction of the pattern coinciding with the horizontal direction. The angular direction θ is then defined in a clockwise manner with the angular direction of 0 degrees taken as a reference. Directions of the pattern are not limited to the four directions shown in the figure. That is to say, the directions of the pattern may be a combination of arbitrary angles that divide a 180-degree-area into about n equal parts, where n is any arbitrary integer equal to or greater than 3.

A second embodiment is provided for a pattern created on the sample 20 or the target 62, as shown in FIG. 7(b). In this case, the directional sharpness dθ is found by carrying out a directional-differentiation process on a particle image detected by the particle detector 16. The directional-differentiation process is carried out by convolution of a mask, similar to the one shown in the figure, on the image. Then, a sum of squares of values at all points on the image of a differentiation is computed so as to be used as the directional sharpness dθ. The differentiation mask shown in the figure is a typical mask. Any mask other than the typical mask can be used as long as the other mask satisfies a condition for the differentiation. The condition requires that two pieces of data at any two positions symmetrical with each other with respect to a certain axis shall have signs opposite to each other and equal absolute values. For suppression of noise and improvement of direction selectability, there are a variety of differentiation masks. In addition, it is necessary to select a type of filtering prior to computation of image differentials and to select an image-shrinking technique appropriate for the image. Furthermore, by carrying out the directional-differentiation process after rotating the image, it is possible to perform the directional-differentiation process in any direction θ by using the simple 0-degree or 90-degree differentiation.

Moreover, in order to find the directional sharpness with a high degree of accuracy, the following technique can be adopted. As shown in FIG. 16, curves representing sharpness at angles 0, 90, 45 and 135 degrees have different properties due to the direction of the scanning line, the frequency response of the detector and characteristics of the noise. Thus, in a technique for finding degrees of sharpness in four directions by a directional differentiation process carried out on an image, there is a problem related to errors of astigmatism. To be more specific, for degrees of sharpness at 0 and 90 degrees, the bottom's height relative to the height of the peak is comparatively large. In the case of the 0-degree angle, in particular, the magnitude of the noise is large, increasing then error generated during processing to find the center of a curve representing the sharpness. This is because, for the 90-degree direction, the differentiation process is carried out in a direction stretching over a plurality of scanning lines. Thus, the magnitude of the noise will increase due to an effect of variations in brightness, which are caused by differences in current, magnitude among primary beams for scanning lines. As for the 0-degree direction, the differentiation process is carried out in the direction of the scanning line. Thus, the peak of the sharpness curve decreases by as large an amount as the signal corruption caused by the frequency response of the detector. In the case of the 45 and 135 degree directions, on the other hand, if a differentiation filter with a low response is employed in both the horizontal and vertical directions, either effect is almost meaningless. As a result, a sharpness curve with a high peak and a low bottom is selected.

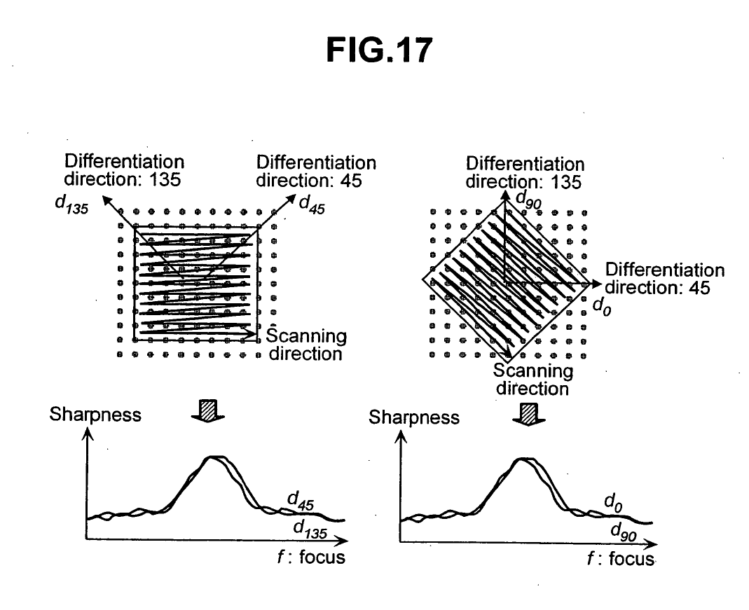

For the reasons described above, the scanning direction is changed from the first focus sweep to the second focus sweep by about −45 degrees, as shown in FIG. 17. Only degrees of sharpness at 45 and 135 degrees, at which an excellent property is exhibited, are computed by using their respective image sets. In the second sweep, the picture has been rotated by 45 degrees. Thus, degrees of sharpness in the 0 and 90 degree directions, that is, d0 and d90, are computed. The scanning direction may also be rotated by 135 degrees, instead of −45 degrees. As a matter of fact, the scanning direction may also be rotated by −135 degrees or 45 degrees. In this case, however, the differentiation direction of 45 degrees corresponds to the sharpness d90, whereas the differentiation direction of 135 degrees corresponds to the sharpness d0. It should be noted that, if the differentiation direction is shifted from 0 and 90 degrees, the differentiation process is not necessarily carried out in the ±45 and ±135-degree directions. For example, the differentiation process can be carried out in the 60 and 150 degree directions or the −150 and −60 degree directions on an image, which is not rotated to produce directional sharpness that is proof against four types of noise. In this case, however, four degrees of sharpness {d15(f), d60(f), d105(f), d150(f)} are obtained, in accordance with the same equations described above, by replacing all numbers representing angles in the equation with correct numbers for the angles of 15, 60, 105 and 150 degrees.

Thus, astigmatism can be measured with a high degree of accuracy and without being affected by noise even for a dim pattern. In addition, astigmatism can be measured and corrected even for a pattern that is darkened due to contamination of the sample or the like.

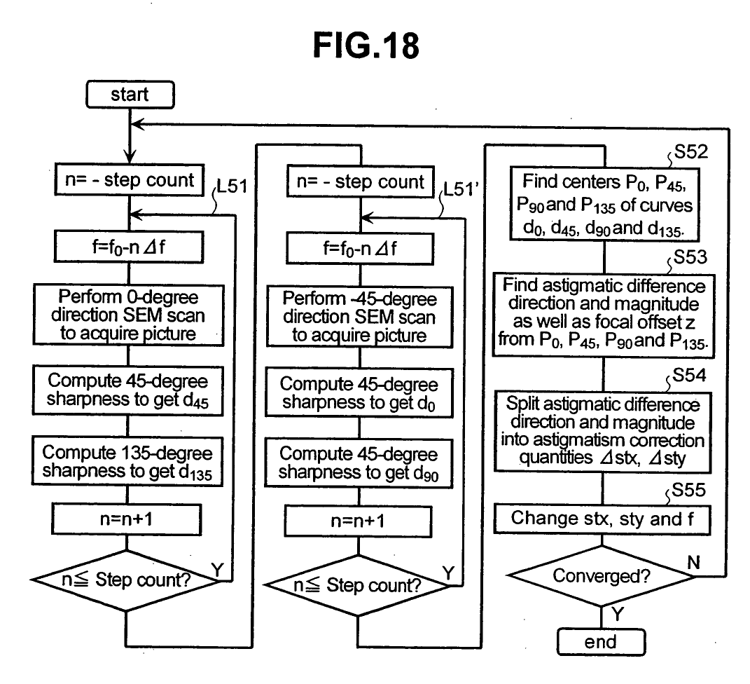

FIG. 18 is a flowchart representing processing to correct astigmatism for a case in which the directional sharpness is computed by adopting the method shown in FIG. 17.

(1) In a loop L51, while a charged-particle beam is being radiated to a pattern for correction of astigmatism and focus in a scanning operation according to a command issued by the overall control unit 26 to the deflection control unit 47, the astigmatism adjustment unit 64 issues a command to the focal-position control unit 22 to make the following happen. While the focus f is being changed, the particle detector 16 acquires a plurality of images and stores them in the image memory 52. The astigmatism & focus-correction-quantity-computation image-processing unit 53 computes degrees of directional sharpness at angles of 45 and 135 degrees for the images, that is, the degrees of directional sharpness d45(f) and d135(f), which are shown in FIG. 17.

(2) Then, in the next loop L51′, while the charged-particle beam is being radiated to the pattern for correction of astigmatism and focus in a scanning operation, with the angle rotated from that of the loop 51 by −45 degrees in accordance with a command issued by the overall control unit 26 to the deflection control unit 47, the astigmatism adjustment unit 64 issues a command to the focal-position control unit 22 to make the following happen. While the focus f is being changed, the particle detector 16 acquires a plurality of images and stores them in the image memory 52. The astigmatism & focus-correction-quantity-computation image-processing unit 53 computes degrees of directional sharpness at angles of 45 and 135 degrees for the images, that is, the degrees of directional sharpness d0(f) and d90(f), which are shown in FIG. 17.

(3) Subsequently, at the next step S52, the astigmatism & focus-correction-quantity-computation image-processing unit 53 is driven to find center positions p0, p45, p90 and p135 of curves representing the degrees of directional sharpness at the angles of 0, 45, 90 and 135 degrees, namely, d0(f), d45(f), d90(f) and d135(f) respectively, each as a function of focus f, as shown in the upper portion of FIG. 6.

(4) Then, at the following step S53, the astigmatism & focus-correction-quantity-computation image-processing unit 53 is driven to find a focal-position shift (astigmatic difference) direction α and magnitude δ, as well as an focal offset z, in a direction caused by the astigmatic difference from a sinusoidal relation, as shown in the lower portion of FIG. 6, for each of the center positions p0, p45, p90 and p135, and to supply these quantities to the overall control unit 26 so as to be stored in the storage unit 57. It should be noted that, at the step S53, it is not absolutely necessary to find the astigmatic difference direction α and magnitude δ. Instead, only a vector (dx, dy) representing the astigmatic difference needs to be found.

(5) There has been found in advance a relation between variations in astigmatism control values (stx, sty), which are characteristics of the astigmatism corrector 60, and variations in astigmatic difference direction α and magnitude δ, or variations in astigmatic-difference vector (dx, dy). The variations in astigmatic difference direction α and magnitude δ, or variations in the astigmatic-difference vector (dx, dy), are known as sensitivity. Thus, at step S54, the overall control unit 26 is capable of converting and splitting the astigmatic difference direction α and magnitude δ or vector (dx, dy), into required astigmatism correction quantities (1, 2) (Δstx, Δdty) on the basis of this relation. At step S55, the overall control unit 26 is capable of setting the astigmatism correction quantities (1, 2) (Δstx, Δsty) and a focal offset z and supplying them to the astigmatism adjustment unit 64.

(6) The astigmatism adjustment unit 64 transmits the focal offset z received from the overall control unit 26 to the focal-position control unit 22, which uses the focal offset z to correct an objective coil current flowing through the objective lens 18, or a focus correction coil current flowing through the focus correction coil 18a. The astigmatism adjustment unit 64 transmits the astigmatism correction quantities (Δstx, Δsty) received from the overall control unit 26 to the astigmatism correction circuit 61, which uses the astigmatism correction quantities (Δstx, Δsty) to correct an astigmatism correction coil current or an astigmatism correction static voltage. In this way, the correction and the adjustment of the astigmatism can be carried out at the same time.

(7) For a small astigmatism, an auto-stigma operation is completed in one processing, as described above. For a large astigmatism, however, the correction cannot be completed in one processing due to causes of aberration other than astigmatism. Examples of such causes are high-order astigmatism and picture distortion. In this case, the processing goes back to step (1) to apply an auto stigma and repeat the loop until the astigmatism correction quantities (Δstx, Δsty) and the focal offset z are reduced to small values.

The following description is directed to a method based on another principle. The method is adopted to solve a phenomenon of differences in property among sharpness curves at 0, 90, 45 and 135 degrees, as shown in FIG. 16. The differences are caused by effects of the direction of the scanning line, the frequency response of the detector and the characteristics of noise. Brightness noise of the scanning line is generated at random. That is to say, brightness noise of the scanning line in an operation to scan a particle image have no correlation with brightness noise generated in another operation to scan the particle image under the same conditions. In order to solve this problem, directional differentials are computed for each of two images. Then, by finding covariance values of the pixels of the two differential images or their square roots, noise components can be eliminated. Thus, a square average of each of the differential images or its square root can be found. It should be noted that a covariance value can be computed as a value of the following expression: Σf (x, y) g (x, y)/N, where notations f (x, y) and g (x, y) denote the two differential images respectively, and notation N denotes the number of pixels in the area of the covariance computation. By adopting this method, it is possible to suppress a phenomenon in which the bottom of a sharpness curve for 90 degrees is elevated by noise, as shown in FIG. 16. It is also possible to improve the stability and precision of the automatic aberration correction using a sample with a problem of a pattern sensitive to noise. A covariance value is computed for a pair of images, which are selected by two focus-scanning operations and have a common focal position f, as follows. Covariance values after the directional differentiation are found for differentiations in the 0, 45. 90 and 135 directions and are used as the degrees of directional sharpness d0(f), d45(f), d90(f) and d135(f).

The following description is directed to an embodiment of a method adopted by the astigmatism & focus-correction-quantity-computation image-processing unit 53 to find the center position pθ of a directional-sharpness curve dθ(f), which is a function of focal position f. In accordance with a method to find the center position pθ of a directional-sharpness curve dθ(f), a quadratic function, a Gaussian function or the like is applied to values in close proximity to a focal position f corresponding to the peak of the directional-sharpness curve dθ(f). Thus, the center position pθ is found as the center position of the function. In accordance with a method used to find the center position pθ of a directional-sharpness curve dθ(f), the center position pθ is found as the center of gravity of points representing values greater than a predetermined threshold. A proper method can be selected.

FIG. 11 is a diagram showing a graph representing a relation between the focus and the sharpness and serving as a means for explaining a method of finding the center position pθ of a directional-sharpness curve dθ(f), wherein a Gaussian function or the like is applied to values in close proximity to a focal position f corresponding to the peak of the directional-sharpness curve dθ(f). To be more specific, a focal position f corresponding to the peak of the directional-sharpness curve 40(f) is found, and, then, a beetle-brow function, such, as a quadratic function or a Gaussian function, is applied to N values in close proximity to the focal position f. For N=3, parameters can be determined so that the quadratic function or the Gaussian function passes all pieces of data. Thus, a center position of the directional-sharpness curve dθ(f) can be found by interpolation.

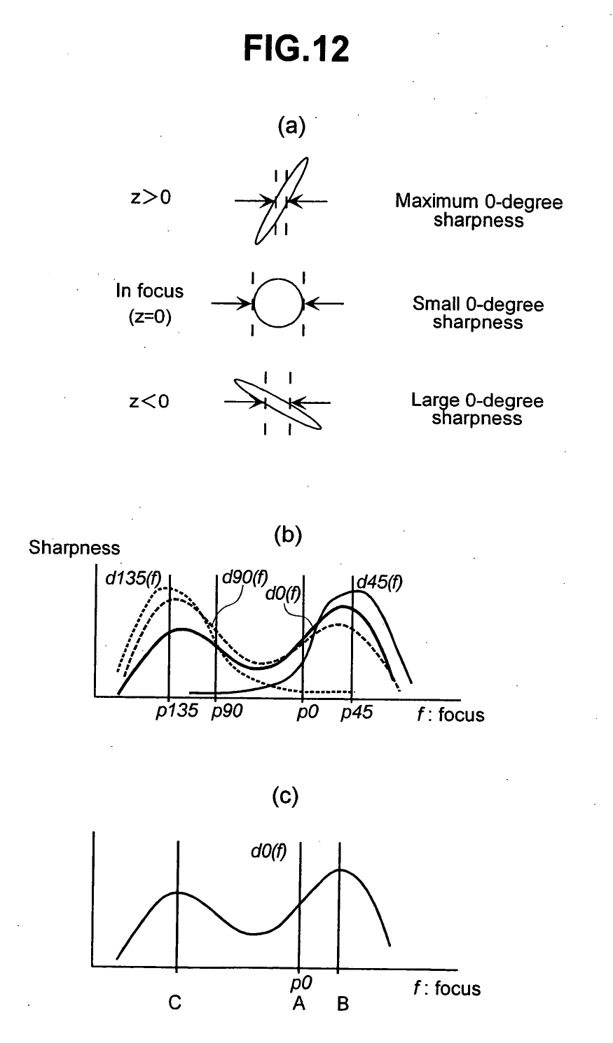

With this simple technique to find a position corresponding to a peak or the interpolation technique to find such a position, however, an error is generated, particularly in the case of a large astigmatism. This problem will be explained with reference to FIGS. 12(a) to 12(c). Consider sharpness in the 0-degree direction for a case in which an astigmatism is generated in about ±45 degree directions, as shown in FIG. 12(a). In this case, when the spot cross section of the charged-particle line is in an in-focus state in the ±45 degree directions, the cross section of the spot for sharpness in the 0-degree direction is narrow. When the spot cross section of the charged-particle line is in an in-focus state in the 0-degree direction, on the other hand, the cross section of the spot for sharpness in the 0-degree direction is wide. The narrower the spot cross section, the higher the degree of sharpness. Thus, for a large astigmatism, the sharpness curves in a direction in which no astigmatism is generated reveal a trend of a double-peak property, as is the case with the d0(f) and d90(f) curves shown in FIG. 12(b). If the simple maximum-value method is adopted in this case, a one-sided position, such as point B shown in FIG. 12(c), is incorrectly determined to be the center point of the d0(f) curve. In actuality, point B, which has been incorrectly determined to be the center point of the d0(f) curve, is close to p45, which is a point corresponding to the peak of the d45(f) curve in this example.

In the example shown in FIGS. 12(a) to 12(c), if the simple maximum-value method is adopted, point p0 corresponding to the peak of the d0(f) curve will be close to point p45 corresponding to the peak of the d45(f) curve, while point p90 corresponding to the peak of the d90(f) curve will be close to point p135 corresponding to the peak of the d135(f) curve. In this case, components p45-p135 of the astigmatic difference in the ±45 degree directions have magnitudes at least twice the magnitudes which are supposed to occur. Thus, if those components are used for correction, the astigmatism in these directions will be inevitably over corrected, causing an instability.

On the other hand, the method used to search for a peak may determine a point C, as shown in FIG. 12(c), to be the center of the d0(f) curve. In this case, the components of the astigmatism difference in the ±45 degree directions are not corrected. For this reason, it is necessary to find a middle point, such as point A between points B and C, as shown in FIG. 12(c), as the center of the sharpness curve d0(f) in order to correctly find the magnitude of the astigmatic difference and the axial direction of the aberration, as shown in FIG. 6.

In order to find such a middle point, in accordance with the present invention, the sizes of peaks B and C are taken into consideration, so that the middle point between points B and C truly represents the center of the directional sharpness. There are a variety of conceivable methods implemented by embodiments described below to find such a middle point. However, the methods to find such a middle point are not limited to the embodiments described below. In the case of a double-peak sharpness curve, any method provided by the present invention can be adopted to find such a middle point by taking the sizes of the peaks into consideration.

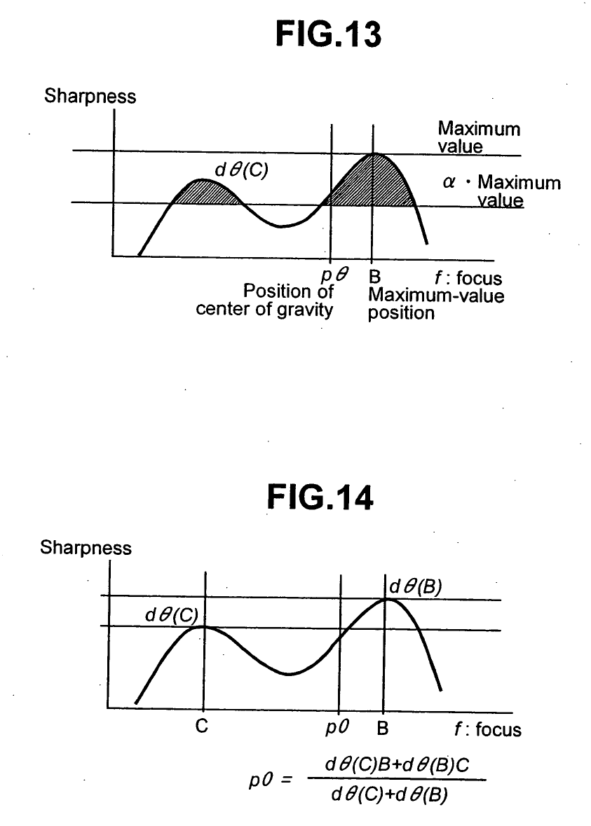

FIG. 13 is a graph representing a relation between the focus value and the sharpness and serving as a means for explaining a method of using the center of gravity of a directional-sharp curve as a central position of the curve. As described above, first of all, a maximum value is found. Then, a threshold value is found as a product of the maximum value and a coefficient α not greater than 1. The middle point of the directional sharpness is finally found as a center of gravity of hatched areas enclosed by the portions of the graph representing sharpness greater than the threshold value and a horizontal line representing the threshold value. As described above, the graph represents variations in directional sharpness with variations in focal position. The middle point p0 of the directional sharpness is found as follows:
pθ=Σf*(dθ(f)−αMax Value)/pθ=Σd(dθ(f)−αMax Value)

FIG. 14 is a graph representing a relation between the focus value and the sharpness and serving as a means for explaining a method of finding a central position of a directional-sharp curve by computing a weighted average of maximum-value positions. If a plurality of peaks exist on a directional-sharpness curve, the positions of the peaks are first of all found. Then, a weight proportional to the height of a peak is found for each position and is used for computing a weighted average representing the central point of the directional sharpness. Assume that notations B and C each denote the position of a maximum value. In this case, the middle point pθ of the directional sharpness is finally found as follows:
pθ=(dθ(C)*B+dθ(B)*C)/(dθ(C)dθ(B))

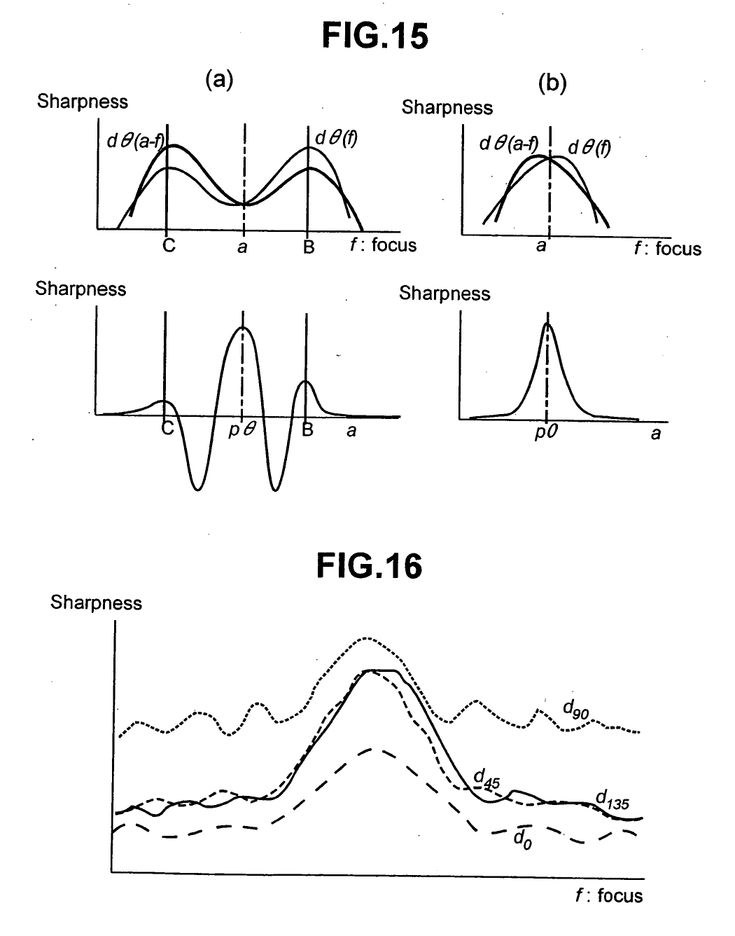

FIGS. 15(a) and 15(b) are graphs representing a relation between the focus value and the sharpness and serving as a means for explaining a method of finding a central position of a directional-sharp curve by adopting a symmetry-matching technique. In the figures, a curve dθ(f) represents variations in directional sharpness with variations in focal position. Consider a vertical line f=a passing through a position a as a symmetrical axis. The position a is selected so that the portion of a curve dθ(a−f) on the left side of the symmetrical axis becomes the most matching image of the portion of the curve dθ(f) on the right side of the symmetrical axis serving as an error. On the other hand, the portion of the curve dθ(a−f) on the right side of the symmetrical axis becomes the most matching image of the portion of the curve dθ(f) on the left side of the symmetrical axis. The curves on the lower side each represent variations in degree of matching with variations in position a. The position a at which the degree of matching reaches a maximum is taken as the in-focus position pθ. The degree of matching can be computed as a correlation quantity between the curves. In this case, at the in-focus position pθ, the correlation quantity reaches a maximum. The degree of matching can also be computed as a sum of squared differences between the curves. In this case, at the in-focus position pθ, the correlation quantity reaches a minimum. It is needless to say that the degree of matching can also be computed as any quantity that is generally used as an indicator of matching.

The following description is directed to an embodiment implementing a technique adopted by the overall control unit 26 to compute an astigmatism correction quantity from an astigmatic difference received from the astigmatism & focus-correction-quantity-computation image-processing unit 53. When the four directions of the in-focus positions p0, p45, p90 and p135 at 0, 45, 90 and 135 degrees are used, first of all, the astigmatism & focus-correction-quantity-computation image-processing unit 53 computes an astigmatic-difference vector (dx, dy)=(p0−p90, p45−p135) and supplies the vector to the overall control unit 26. Then, the overall control unit 26 splits astigmatism correction quantities (Δstx, Δsty) on the basis of Eq. (4) given as follows:
Δstx=mxx*dx+mxy*dy
Δsty=myx*dx+myy*dy (4)
where notations mxx, mxy, myx and myy each denote a parameter of astigmatism correction quantity splitting, which are computed on the basis of characteristics of the astigmatism corrector 60. Typically, the parameters are stored in the storage unit 57. Thus, the astigmatism adjustment unit 64 supplies the astigmatism correction quantities obtained from the overall control unit 26 to the astigmatism correction circuit 61 so that the astigmatism correction circuit 61 changes the quantities by (βΔstx, βΔsty) where notation β denotes a correction quantity reduction coefficient. In turn, the astigmatism correction circuit 61 drives the astigmatism corrector 60 to change the astigmatism correction quantities by (βΔstx, βΔsty).

In addition, since the focal offset z obtained from the image-processing circuit 53 is an average value of focal positions in different directions, the overall control unit 26 sets the focus correction quantity at (p0+p45+p90+p135)/4. Thus, the astigmatism adjustment unit 64 supplies the focus correction quantity obtained from the overall control unit 26 typically to the focal-position control unit 22, which then corrects the objective lens 18 by the focus correction quantity.

It should be noted that, as another embodiment, the astigmatism & focus-correction-quantity-computation image-processing unit 53 first computes the astigmatic difference magnitude δ−|dx,dy)| and direction α=½ arctan (dy/dx), supplying the magnitude and the direction to the overall control unit 26. The overall control unit 26 may then convert the astigmatic difference magnitude δ and direction α into the astigmatism correction quantities (Δstx, Δsty).

In addition, when directional sharpness pθ in n directions is used, where n is an integer of at least 3, the astigmatism & focus-correction-quantity-computation image-processing unit 53 needs to apply a sinusoidal waveform to these pieces of data and then find the astigmatic difference magnitude δ and direction α, as well as the focal offset z, from the phase, the amplitude and the offset of the waveform.

Furthermore, if the astigmatism correction quantity is changed, the focal position may be affected by the change, being slightly shifted in some cases. Thus, in this case, the overall control unit 26 typically multiplies each of the astigmatism correction quantities (Δstx, Δsty) by a proper coefficient and adds the products to variations of the astigmatism correction quantities (Δstx, Δsty) to produce new astigmatism correction quantities.

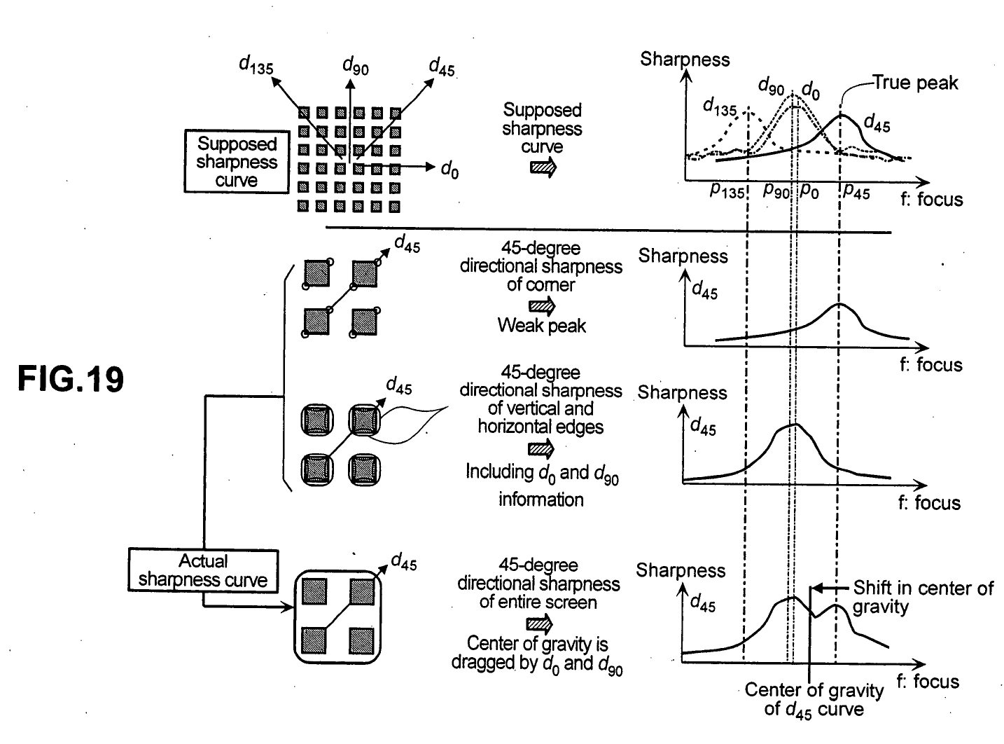

The following description is directed to a method to compute the astigmatism correction quantities more accurately, in a shorter period of time and with a higher degree of precision, in comparison with the embodiment described above. With the method described above, there occurs a phenomenon wherein the position of the gravitational center of the sharpness is dragged by the sharpness in the adjacent direction. Consider a sharpness curve d45 in a 45-degree direction relative to, for example, a pattern like the one shown in FIG. 19. As shown in the figure, the pattern includes more vertical and horizontal edges than inclined edges. Since edges oriented in an inclined direction exist only at the corners of the pattern, the effects of the vertical and horizontal edges on the sharpness curve d45 are relatively strong, generating a peak not only at the supposed peak position, but also at peak positions of the sharpness curves d0 and d90. This phenomenon also holds true of the sharpness curve d135. For this reason, the component dx of an astigmatic-difference vector, computed by adopting the technique of the center of gravity, has a value smaller than the actual value to a certain degree. When a semiconductor is used as the sample 20, in general, the semiconductor pattern is a vertical and horizontal pattern. Thus, the phenomenon described above does not occur.

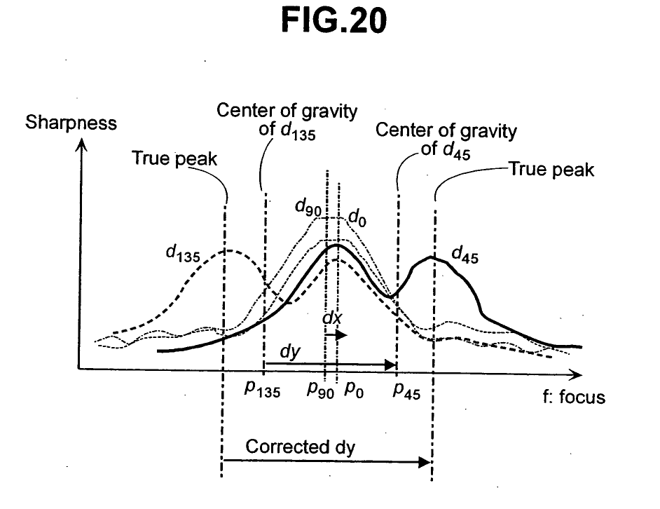

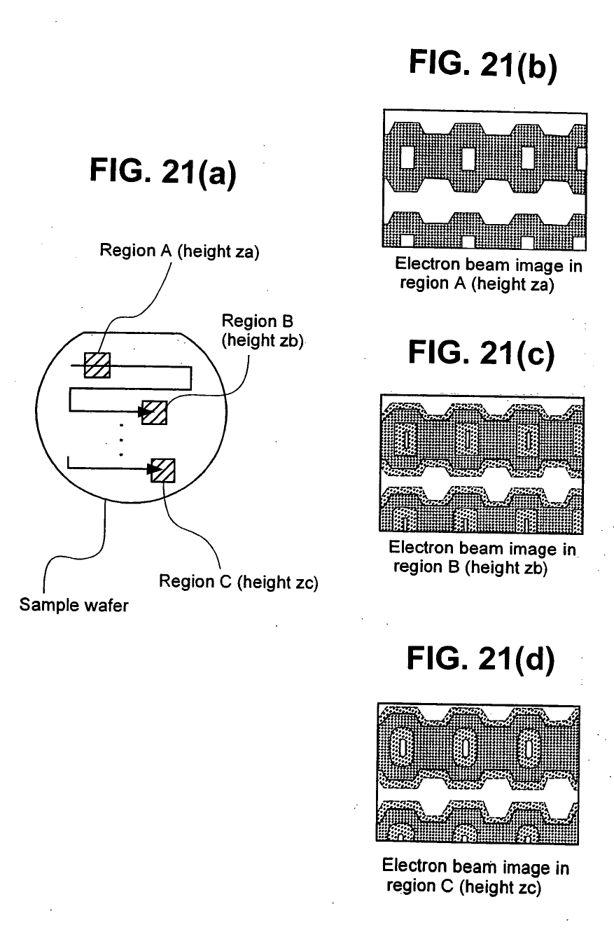

Thus, a corrected astigmatic-difference vector is used to find the astigmatism correction quantities (Δstx, Δsty). As shown in FIG. 20, the component dx of an astigmatic-difference vector is small in comparison with the component dy and the peaks d0 and d90 are high. In this case, the component dy of the astigmatic-difference vector is shifted in a direction toward a value smaller than the actual one. Thus, an equation usable for correcting it must be utilized. The following three kinds of correction equations are given as an example. In order to obtain the same effects, however, it is also possible to use other equations having similar functions to carry out the correction. With the first correction equation, the astigmatic-difference vector (dx, dy) is corrected in accordance with a relation between the magnitudes of the components dx and dy of the astigmatic-difference vector. To be more specific, the astigmatic-difference vector (dx, dy)=(p0 p90, p45−p135) by using (dx/dy)ˆp, where the notation denotes exponentiation.

$$\begin{matrix}Δ stx = {m}_{xx} \frac{{d}_{x}^{p + 1}}{{d}_{y}^{p}} + {m}_{xy} \frac{{d}_{y}^{p + 1}}{{d}_{x}^{p}} & Eq . ( 5 ) \\ Δ sty = {m}_{yx} \frac{{d}_{x}^{p + 1}}{{d}_{y}^{p}} + {m}_{yy} \frac{{d}_{y}^{p + 1}}{{d}_{x}^{p}} & Eq . ( 6 )\end{matrix}$$

Eqs. (5) and (6) are used for splitting the astigmatism correction quantities. Notations mxx, mxy, myx and myy each denote a parameter for splitting the astigmatism correction quantities. In the above equations, notation p denotes a parameter for correcting a phenomenon in which the position of the sharpness center of gravity is dragged by sharpness in the adjacent direction. The parameter p has a value in the range 0<p<1.

With the second correction equation, on the other hand, the astigmatic-difference vector (dx, dy) is corrected in accordance with the heights of the peaks of the directional-sharpness curves in addition to the relation between the magnitudes of the components dx and dy of the astigmatic-difference vector. Assume that the values pd0, pd45, pd90 and pd135 are used as the heights of the peaks of the sharpness curves d0, d45, d90 and d135, respectively, and assume that px=pd0+pd90, whereas py=pd45+pd135. In this case, the following equations hold true:

$$\begin{matrix}Δ stx = {m}_{xx} \frac{a + exp {b}_{p} ( \frac{{P}_{y}}{{P}_{x}} - {c}_{p} ) + exp {b}_{d} ( \frac{{d}_{x}}{{d}_{y}} - {c}_{d} )}{1 + exp {b}_{p} ( \frac{{P}_{y}}{{P}_{x}} - {c}_{p} ) + exp {b}_{d} ( \frac{{d}_{x}}{{d}_{y}} - {c}_{d} )} \\ {d}_{x} + {m}_{xy} \frac{a + exp {b}_{p} ( \frac{{P}_{x}}{{P}_{y}} - {c}_{p} ) + exp {b}_{d} ( \frac{{d}_{y}}{{d}_{x}} - {c}_{d} )}{1 + exp {b}_{p} ( \frac{{P}_{x}}{{P}_{y}} - {c}_{p} ) + exp {b}_{d} ( \frac{{d}_{y}}{{d}_{x}} - {c}_{d} )} & Eq . ( 7 ) \\ Δ sty = {m}_{yx} \frac{a + exp {b}_{p} ( \frac{{P}_{y}}{{P}_{x}} - {c}_{p} ) + exp {b}_{d} ( \frac{{d}_{x}}{{d}_{y}} - {c}_{d} )}{1 + exp {b}_{p} ( \frac{{P}_{y}}{{P}_{x}} - {c}_{p} ) + exp {b}_{d} ( \frac{{d}_{x}}{{d}_{y}} - {c}_{d} )} \\ {d}_{x} + {m}_{yy} \frac{a + exp {b}_{p} ( \frac{{P}_{x}}{{P}_{y}} - {c}_{p} ) + exp {b}_{d} ( \frac{{d}_{y}}{{d}_{x}} - {c}_{d} )}{1 + exp {b}_{p} ( \frac{{P}_{x}}{{P}_{y}} - {c}_{p} ) + exp {b}_{d} ( \frac{{d}_{y}}{{d}_{x}} - {c}_{d} )} . & Eq . ( 8 )\end{matrix}$$

Eqs. (7) and (8) are used for splitting the astigmatism correction quantities. Notations a, bp, bd, cp and cd each denote a correction parameter. The a parameter has a value in the range of 1 to 2. A typical value of the parameter a is 1.8. The parameters bp and bd each have a value of 5, whereas the parameters cp and cd each have a value of about 0.5. That is to say, for px<py and dx>dy, the component dx is corrected by a factor not exceeding a times. For px>py and dx<dy, on the other hand, the component dy is corrected by a magnification factor not exceeding a times.

$$\begin{matrix}Δ stx = {m}_{xx} \frac{a + {( {b}_{p} ( \frac{{P}_{y}}{{P}_{x}} ) )}^{{C}_{p}} + {( {b}_{d} ( \frac{{d}_{x}}{{d}_{y}} ) )}^{{C}_{d}}}{1 + {( {b}_{p} ( \frac{{P}_{y}}{{P}_{x}} ) )}^{{C}_{p}} + {( {b}_{d} ( \frac{{d}_{x}}{{d}_{y}} ) )}^{{C}_{d}}} \\ {d}_{x} + {m}_{xy} \frac{a + {( {b}_{p} ( \frac{{P}_{x}}{{P}_{y}} ) )}^{{C}_{p}} + {( {b}_{d} ( \frac{{d}_{y}}{{d}_{x}} ) )}^{{C}_{d}}}{1 + {( {b}_{p} ( \frac{{P}_{x}}{{P}_{y}} ) )}^{{C}_{p}} + {( {b}_{d} ( \frac{{d}_{y}}{{d}_{x}} ) )}^{{C}_{d}}} {d}_{y} & Eq . ( 9 ) \\ Δ sty = {m}_{yx} \frac{a + {( {b}_{p} ( \frac{{P}_{y}}{{P}_{x}} ) )}^{{C}_{p}} + {( {b}_{d} ( \frac{{d}_{x}}{{d}_{y}} ) )}^{{C}_{d}}}{1 + {( {b}_{p} ( \frac{{P}_{y}}{{P}_{x}} ) )}^{{C}_{p}} + {( {b}_{d} ( \frac{{d}_{x}}{{d}_{y}} ) )}^{{C}_{d}}} \\ {d}_{x} + {m}_{yy} \frac{a + {( {b}_{p} ( \frac{{P}_{x}}{{P}_{y}} ) )}^{{C}_{p}} + {( {b}_{d} ( \frac{{d}_{y}}{{d}_{x}} ) )}^{{C}_{d}}}{1 + {( {b}_{p} ( \frac{{P}_{x}}{{P}_{y}} ) )}^{{C}_{p}} + {( {b}_{d} ( \frac{{d}_{y}}{{d}_{x}} ) )}^{{C}_{d}}} {d}_{y} & Eq . ( 10 )\end{matrix}$$

Eqs. (9) and (10) are used for splitting the astigmatism correction quantities. Notations a, bp, bd, cp and cd each denote a correction parameter. The a parameter has a value in the range of 1 to 2. A typical value of the parameter a is 1.8. The parameters bp and bd each have a value of about 2, whereas the parameters cp and cd each have a value of about 4. That is to say, for px<py and dx>dy, the component dx is corrected by a factor not exceeding a times. For px>py and dx<dy, on the other hand, the component dy is corrected by a magnification factor not exceeding a times.

By using these equations, even if a sample pattern exhibits a one-sided property in the direction thereof, the one-sided property can be corrected so that the astigmatism correction quantities can be computed with a high degree of precision. As a result, the astigmatism can be corrected in a short period of time and with a high degree of precision.

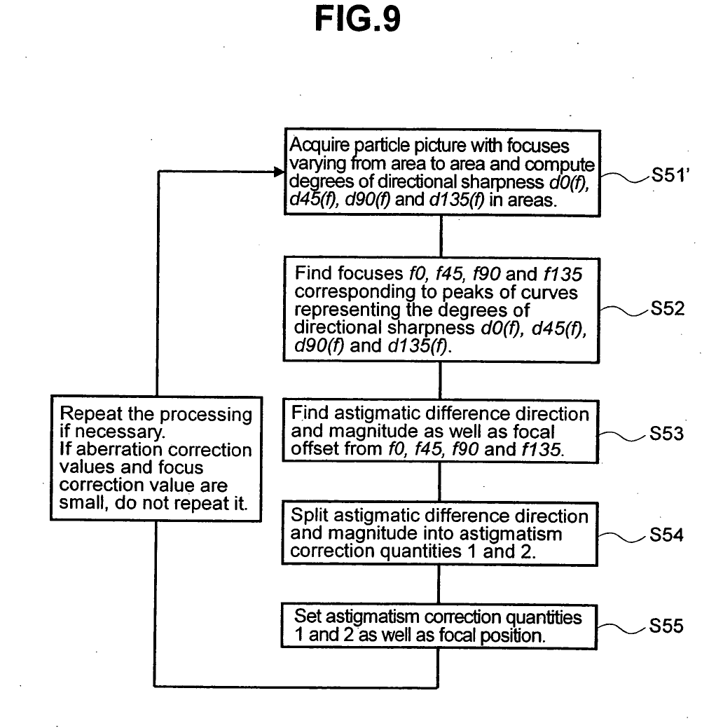

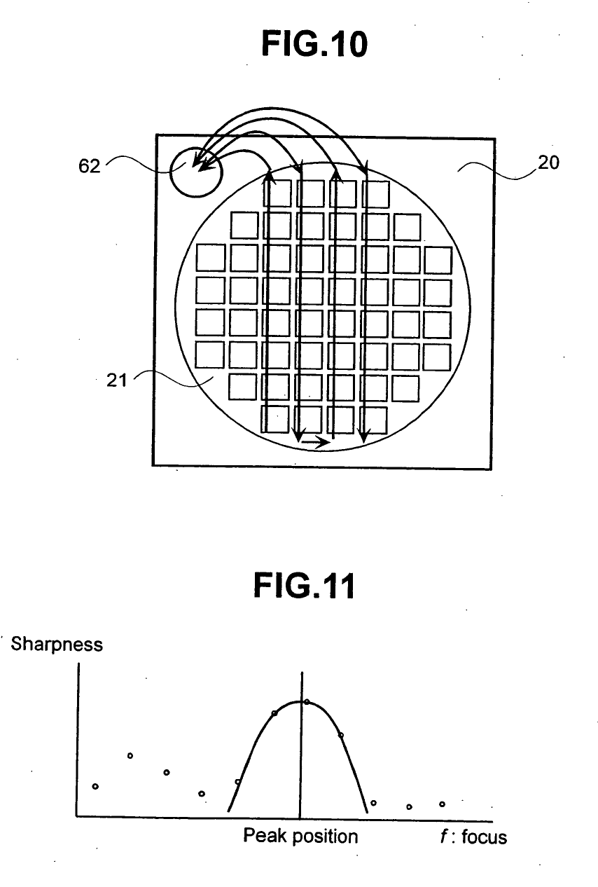

Referring to FIGS. 8 and 9, the following description is directed to another embodiment of the present invention relating to a technique for automatically correcting astigmatism and focus in an even shorter period of time. In this embodiment, the surface of the calibration target 62 is inclined as shown in FIG. 8(a). A proper pattern is created on the inclined surface to form a calibration target 62a. On the other hand, the calibration target 62 shown in FIG. 8(b) has a surface with a staircase shape. By the same token, a proper pattern is created on the staircase-shaped surface to form a calibration target 62b. The calibration target 62a or 62b is placed on the sample base 21 shown in FIGS. 1 and 10. By doing so, only one particle image of the calibration target 62a or 62b created on the sample 20 needs to be taken in order to produce a picture with the focus f varying from area to area on the image. If two images of it are taken by changing the scanning direction, it is possible to compute a directional sharpness having proof against noise, as described earlier. It should be noted that the difference between the height of a reference point on the calibration target 62a and the height of the surface pf the actual sample 20, as well as the difference between the height of a reference surface of the calibration target 62b and the height of the surface of the actual sample 20, have been measured in advance. As a typical method to measure such a difference, it is possible to apply automatic height correction to both the calibration target 62 and the sample 20, or to use an optical height sensor, as will be described later.

That is to say, since the calibration target 62a shown in FIG. 8(a) or the calibration target 62b shown in FIG. 8(b) is used, it is possible to produce an image with the focus f varying from area to area on the picture from different areas of only one particle image. Thus, the flowchart shown in FIG. 9 is different from the flowchart shown in FIG. 5 in that, in place of the step S51 of the flowchart shown in FIG. 5, the flowchart shown in FIG. 9 includes a step S51′ to acquire a particle image, which includes edge elements in at least three directions to the same degree and has a height (focus) f varying from area to area, and to compute the directional sharpness pθ(t) for each area. At the remaining steps S52 to S55, the astigmatism and focus correction quantities need to be found and used for adjusting the astigmatism and the focus in the same way as the corresponding steps of the flowchart shown in FIG. 5. In this way, by using only an image, the astigmatism and the focus can be adjusted in a short period of time.

In addition, even if a calibration target 62 with a horizontal planar shape, or the actual sample 20, is used, the same effects as the embodiment described above can be obtained. That is to say, if a particle image is taken by varying the focal position at a high speed, an image with a focus varying from area to area can be obtained in the same way as in the embodiment described above. As a result, by using only an image, the astigmatism and the focus can be adjusted in a short period of time.

The following description is directed to a relation between inspection or measurement of an object substrate and correction of astigmatism, as well as correction of focus. First of all, the object substrate (or the actual sample) 20 is mounted on the sample base 21. Then, the overall control unit 26 inputs and stores information concerning positions on the object substrate 20 to be scanned or measured. The information is acquired from an input means 59, which typically comprises a recording medium or a network. Thus, in an operation to scan or measure the object substrate 20, the overall control unit 26 issues a command to the XY stage 46 to control the XY stage 46 in order to take a predetermined position on the sample 20 to the visual field of the charged-particle optical system. Subsequently, a charged-particle beam is radiated to the predetermined position in a scanning operation, and a particle image generated as a result of the scanning operation is detected by the particle detector 16. A signal representing the particle image is then subjected to an A/D conversion to generate digital data to be stored in the image memory 55. Then, the inspection & measurement image-processing unit 56 carries out image processing on the digital data stored in the image memory 55 in an inspection or measurement operation. In the inspection or measurement operation, the astigmatism and the focus are corrected at each inspection or measurement position in accordance with the present invention so as to allow implementation of the inspection or the measurement based on a particle image with the aberration always being corrected.

Assume that the height detection sensor 13 employed in the inspection & measurement apparatus is an optical height detection sensor, which has small bad effects, such as charge-up, dirt and damage on the object substrate 20. With such, sensor characteristics, a sample height detected by the optical height detection sensor 13 at each inspection or measurement position is fed back to the focal-position control unit 22 so that only a converged charged-particle beam for inspection or measurement is radiated to the object substrate (sample) 20 in a scanning operation without radiating a converged charged-particle beam for correcting astigmatism and focus to the object substrate (sample) 20 in a scanning operation. As a result, bad effects such as charge-up, dirt and damage on the object substrate can be reduced to a minimum. In this case, automatic adjustment of astigmatism and focus is carried out at another position on the sample 20, or at the calibration target 62 placed on the sample base 21, either in advance or periodically during an inspection or a measurement.

By the way, it is possible to use a sample having an inclined or staircase-shaped surface as shown in FIGS. 8(a) and 8(b), or a sample having a planar top surface as shown n FIG. 1, as the calibration target 62.

By carrying out automatic adjustment of astigmatism and focus in accordance with the present invention, as described above, it is possible to correct shifts in focal position and astigmatism, which normally occur with the lapse of time. In order to carry out the automatic adjustment of astigmatism and focus in accordance with the present invention, however, it is necessary to adjust the detection offset of the optical height detection sensor 13 in advance. Differences (or variations) in height between inspection or measurement positions on the actual sample (object substrate) 20 are detected for use in correction of an in-focus state. Thus, a converged charged-particle beam with no astigmatism is radiated to the actual sample 20 in a scanning operation in an in-focus state only during an inspection or a measurement. Therefore, a particle image can be detected with the effects, such as charge-up, dirt and damage, on the object substrate reduced to a minimum. As a result, the object substrate 20 can be inspected or measured with a high degree of precision.

In addition, when it is desired to calibrate not only an offset between the optical height detection sensor 13 and the focal-position control unit 22, but also the gain, a plurality of calibration targets 62, each having a known height, are provided in advance. Such calibration targets 62 are used for carrying out both automatic correction of focus and detection using the optical height detection sensor 13, so that the gain and, furthermore, the linearity can also be calibrated as well. In addition, by carrying out both automatic correction of focus and detection using the optical height detection sensor 13, while changing the height of the calibration target 62 or the sample 20 by using the Z-axis component of the XY stage 46, the gain and, furthermore, the linearity can also be calibrated.

In addition, an inspection or a measurement can be carried out at a high speed by driving the beam deflector 15 to move a converged charged-particle beam in a scanning operation in a direction crossing (or, particularly, perpendicular to) the movement of the XY stage 46, while continuously moving the XY stage 46 in the horizontal direction, as shown in FIG. 10. In such an inspection or a measurement, the particle detector 16 continuously detects a particle image. In order to carry out such an inspection or a measurement, the following control is executed.

The height detected by the optical height detection sensor 13 is always fed back to the focal-position control unit 22 and the deflection control unit 47. In addition, while the focal shift and deflection rotation are being corrected, a particle image is being detected continuously. As a result, the entire surface of the actual sample 20 can be inspected or measured with a high degree of precision and a high degree of sensitivity. It should be noted that, in order to correct the focus, it is of course also possible to drive the Z-axis component of the XY stage 46 instead of driving the focal-position control unit 22 to provide the same effects as well. In the mean time, the radiation of the charged-particle beam is moved to the calibration target 62 periodically, as shown in FIG. 10, to automatically correct the focus and the astigmatism. It is thus possible to inspect the sample 20 with a high degree of precision and a high degree of sensitivity by using a particle image, which is obtained as a result of high-precision correction of astigmatism and focus, over a long period of time.

The embodiments described above are applied to cases in which the charged-particle beam apparatus is applied to an inspection & measurement apparatus. It should be noted, however, that the present invention can also be applied to fabrication equipment and the like.

The present invention exhibits an effect such that astigmatism and focus can be automatically adjusted at a high speed and with a high degree of precision without inflicting damage upon a sample by using only a small number of particle images obtained by detection of a converged charged-particle beam radiated to the sample in a scanning operation.

In addition, the present invention also exhibits another effect in that inspection or measurement can be carried out automatically with a high degree of stability and a high degree of precision, while the quality of a particle image detected over a long period of time is being maintained in operations to inspect defects, such as impurities in a pattern, or to measure the dimensions of the pattern on the basis of a particle image detected by radiation of a converged charged-particle beam to an object substrate, including the pattern in a scanning operation, wherein the converged charged-particle beam has been subjected to high-speed and high-precision automatic adjustment of astigmatism and focus without inflicting damage on the sample.

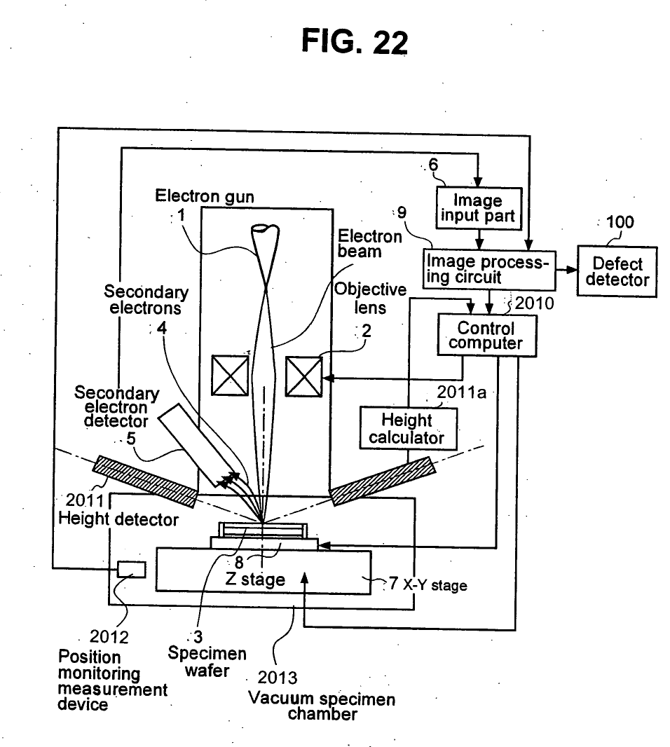

More particularly, shown in FIG. 22 an overview of an automatic semiconductor device inspection system using electron beam images as an exemplary preferred embodiment of the present invention. In an electron optical system shown in FIG. 22, an electron beam emitted from an electron gun 1 is converged through an objective lens 2, and the electron beam thus converged can be scanned over a surface of a specimen in an arbitrary sequence. A signal of secondary electrons 4 produced on a surface of a specimen wafer 3 in irradiation with the electron beam is detected by a secondary electron detector 5, and then the secondary electron signal is fed to an image input part 6 as an image signal.

The specimen wafer under inspection can be moved by an X-Y stage 7 and a Z stage 8. By moving each stage, an arbitrary point on the surface of the specimen wafer is observable through the electron optical system. Electron beam irradiation and image input can be performed in synchronization with stage movement, which is controlled under direction of a control computer 2010. A height detector 2011 is of an optical non-contact type which does not cause interference with the electron optical system, and it can speedily detect a height of the specimen surface at or around an observation position in the electron optical system by a height calculator 2011a. Resultant data of height detection is input to the control computer 2010.

According to the height of the specimen surface, the control computer 2010 adjusts a focal point of the electron optical system, i.e., a position of the Z stage, and it receives input of the image signal. Using the image signal input in a focused state and inspection position data detected by a position monitoring measurement device, defect judgment is carried out through comparison with a pattern pre-stored by an image processing circuit 9, a corresponding pattern at a location on the specimen wafer under inspection, or a corresponding pattern on a different wafer with a defect being detected by defect detector 100. While the automatic semiconductor device inspection system using secondary electron images is exemplified in FIG. 22, back scattered electron images or transmitted electron images may also be used for specimen surface observation instead of secondary electron images.

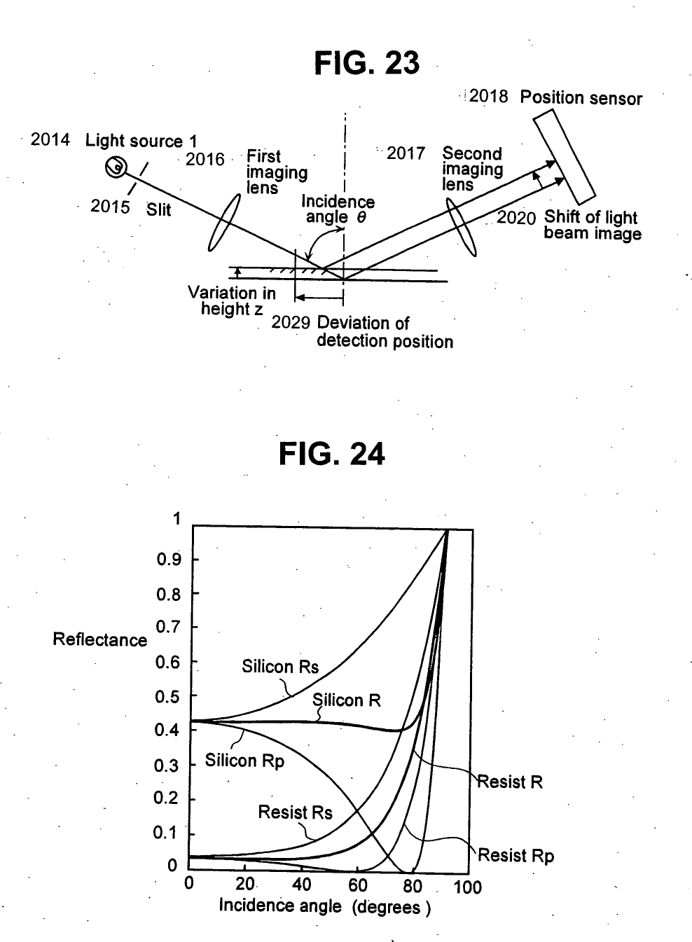

In the example shown in FIG. 22, a spot or slit light beam is projected onto the specimen surface, reflected light therefrom is imaged, and a position of a light beam image thus attained is detected for determining a height of the specimen surface (hereinafter referred to as a light-reflected position detecting method). More specifically, as shown in FIG. 23, the spot or slit light beam is projected onto the specimen surface at a predetermined angle of incidence so that its image is formed on the specimen surface, and reflected light thereof from the specimen surface is detected. Through conversion from specimen surface height variation to light beam image shift, a degree of light beam image shift is detected to determine a height of the specimen surface.

The height detector described above may also be applicable to different types of microstructure observation/fabrication systems using other convergent charged particle beams as in the inspection system exemplified in FIG. 22. The following exemplary preferred embodiments of the height detector are described as related to a microstructure observation system using a charged particle beam, but it is apparent that the height detector may also be applicable to a microstructure fabrication system using a charged particle beam. As will be apparent to those skilled in the art, the degradation in image quality in the microstructure observation system corresponds to the degradation in fabrication accuracy in the microstructure fabrication system. It is also apparent that the present invention is not limited in its application to a charged particle beam system in which a charged particle beam is converged to a single point. The present invention is further applicable to such microstructure fabrication systems that images of an aperture, mask, etc. are formed/projected, and it provides similar advantageous effects in these systems having image-forming charged particle optics. As an example of such microstructure fabrication systems, there is an electron beam lithography system using cell-projection exposure.

In the light-reflected position detecting method mentioned above, since a height detection optical element is not located directly above a detection position, a height in an observation region in a charged particle beam optical system can be detected simultaneously with observation by the charged particle beam optical system in a fashion that virtually no interference takes place. By making a height point detected by the height detector meet an observation region in the charged particle beam optical system, a surface height of an object item can be known at the time of observation. In this arrangement, through feedback of height data thus attained, observation can be conducted using a charged particle beam which is always in focus.

It is not necessarily required to provide such a condition that a desired observation region in the charged particle beam optical system meets a corresponding height point detected by the height detector, but rather it is just required that a surface height of the object is recognizable at the time of observation using vicinal height data attained successively. In use of the light-reflected position detecting method, optical parts may be arranged flexibly to some extent in optical system design, and it is therefore possible to dispose the optical parts to prevent interference with the charged particle beam optical system.

Disposition of the height detector in the light-reflected position detecting method is substantially limited by an angle of incidence on the object surface. In the light-reflected position detecting method, since a degree of incidence angle has an effect on height detection performance, an incidence angle cannot be determined only by part disposition in the system. FIG. 24 shows incidence angle dependency of surface reflectance of silicon and a resist which are representative materials used in formation of semiconductor wafer circuit patterns. A value of reflectance on specimen surface increases with an increase in incidence angle, and a difference in reflectance between materials decreases with an increase in incidence angle. This tendency characteristic also holds for other kinds of materials. Any difference in reflectance between materials causes non-uniform reflectance on the specimen surface, causing irregularity in distribution of the quantity of light detected. If irregular distribution of the quantity of light occurs in a detected slit image due to non-uniform reflectance of specimen surface pattern, an error takes place in slit position detection, resulting in a decrease in accuracy of height detection.

Referring to FIG. 23, a degree of light beam image shift is detected by a position sensor. Instead of the position sensor, a linear image sensor or any sensor capable of detecting a light beam irradiating position may also be used. For ensuring a proper S/N ratio in output of such a sensor, it is required to detect an adequate quantity of light. To provide a sufficient quantity of light for stable detection, it is desirable to increase the incidence angle. In principle, detection sensitivity in the light-reflected position detecting method become higher as the incidence angle with respect to the vertical increases. An adequate quantity of detected light can be ensured by providing an arrangement that the incidence angle is 60 degrees or more. More particularly, it has been determined that 70 degrees provides good results.

Exemplary preferred embodiments of disposition of optical parts in a height detection optical system are described in the following description wherein in general, if an insulator is located in the vicinity of a charged particle beam optical system, a possible charge build-up in the insulator affects an electric field around it to cause an adverse effect on charged particle beam deflection, resulting in degradation in image quality. Since such a charging effect varies with time as a charged condition changes, compensation for it is difficult practically.

For attaining a stable charged particle beam image, disposition of an insulator such as a lens at a position encountered with the charged particle beam must be avoided. If the insulator is coated with a conductive film and disposed at a position sufficiently apart from the charged particle beam optical system, an adverse effect may be reduced. A degree of requirement for preventing an adverse effect of the insulator (lens) on the charged particle beam optical system depends on specifications of the charged particle beam optical system such as visual field condition, accuracy, resolution, etc. According to the specifications of the charged particle beam optical system, a range influential on the charged particle beam optical system may be determined, and an optical path may be designed so that the insulator is not disposed in the influential range, thus preventing an adverse effect on the charged particle beam optical system.

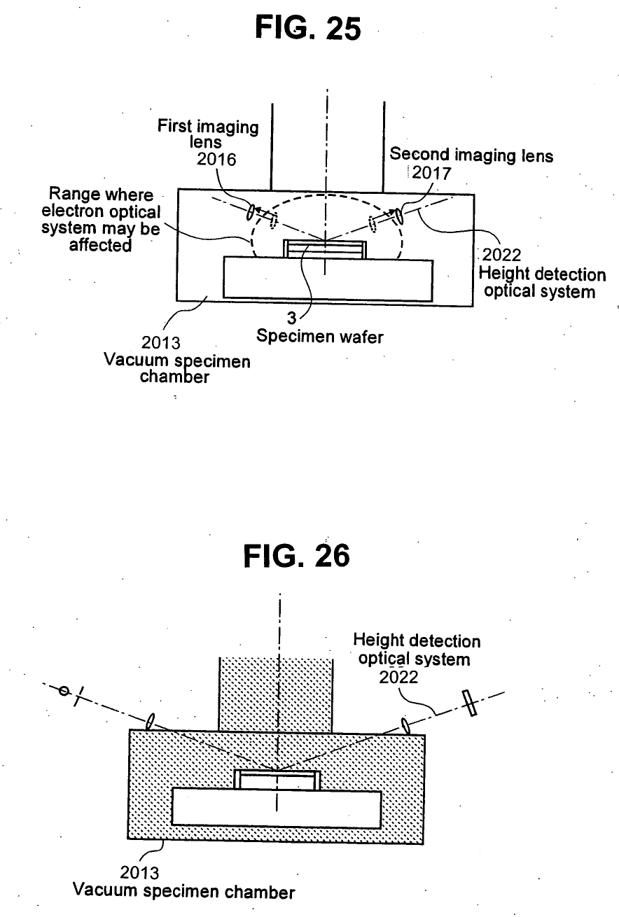

When a lens for the height detector is disposed in the periphery of the charged particle beam optical system, an effect on the charged particle beam can be presumed experimentally through computer simulation. The height detection optical system may be designed after determining a suitable mounting position of each lens as illustrated in FIG. 25. A distance between a surface of a specimen (imaging point) and each of lenses 2016 and 2017 facing the specimen may be adjusted by selecting lenses having a proper focal length.

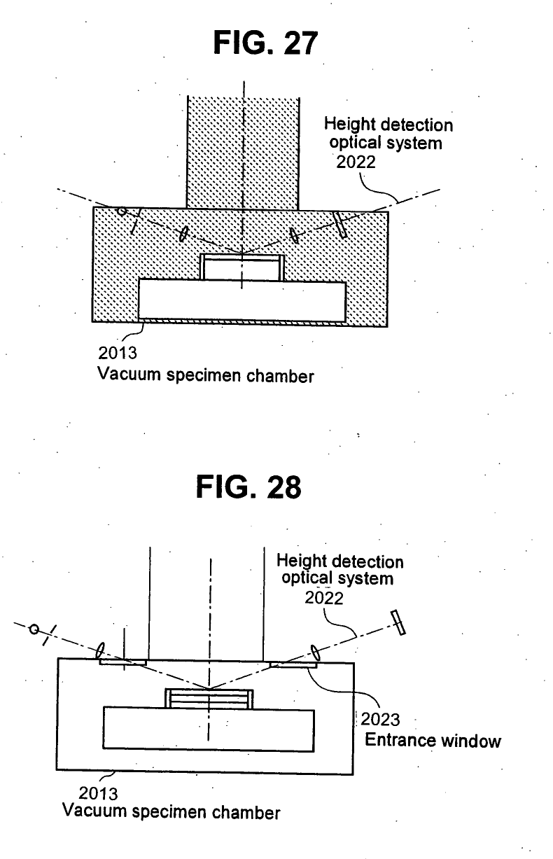

In the preferred embodiment mentioned above, each lens is disposed at a position which does not cause an adverse effect on the charged particle beam optical system. Further, as shown in FIG. 26, there may also be provided such an arrangement that the lenses and other parts of the height detection optical system can be located outside a vacuum specimen chamber 2013 by increasing a distance between the specimen surface and each lens facing the specimen. On a casing between the inside of the vacuum specimen chamber 2013 and the atmosphere, there may be provided a transparent window made of glass or the like. In this arrangement wherein the optical parts of the height detection optical system are disposed outside the vacuum specimen chamber, adjustment at the time of installation and maintenance thereafter will be easier advantageously than when the height detection optical system is disposed in a vacuum as shown in FIG. 27.

As in the preferred embodiment exemplified above, some or all of the optical parts of the height detection optical system may be arranged outside the vacuum specimen chamber. As illustrated in FIG. 28, where some or all of the optical parts are disposed outside the vacuum specimen chamber, an external wall for separation between the inside of the vacuum specimen chamber and the atmosphere is located on an optical path. For allowing passage of light through the external wall, it is necessary to provide an entrance window made of transparent material such as glass. In an arrangement that the entrance window is formed along a plane of the external wall at the top of the vacuum specimen chamber as shown in FIG. 28, if a light beam is projected at a high angle of incidence in the light-reflected position detecting method, an incidence angle of the light beam to the entrance window becomes larger to increase reflectance on a surface of the entrance window significantly.

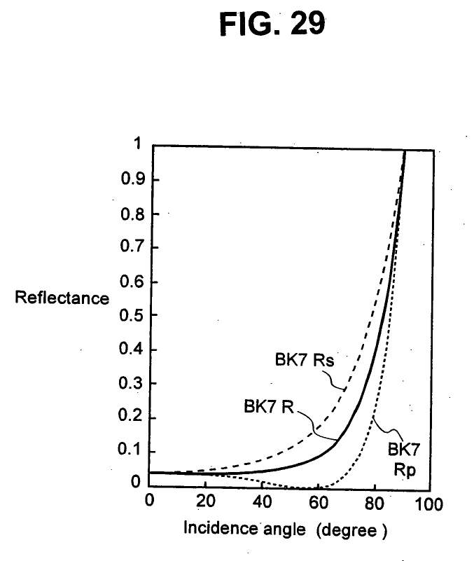

Referring to FIG. 29, there is shown incidence angle dependency of surface reflectance of a representative kind of glass BK7 which is commonly used as an optical material. Since the surface of the entrance window may be coated with a conductive film and different kinds of window materials may be used, the incidence angle dependency will vary to some extent but its tendency characteristic is similar. As the incidence angle to the surface of the entrance window increases, a value of surface reflectance increases to cause larger loss in the quantity of light at passage through the entrance window.

As shown in FIG. 28, light may pass through two windows; an entrance window when it is projected onto a surface of a specimen, and an exit window after it is reflected therefrom. As the number of windows through which light passes is increased, loss in the quantity of light becomes larger. Further, in consideration of incidence angle distribution in the light beam (e.g., incidence angle distribution in a range of ±5.7 deg. in case of NA 0.1), it is required to avoid providing an incidence angle which causes significant variation in reflectance in order to prevent irregular distribution of the quantity of light in the beam.

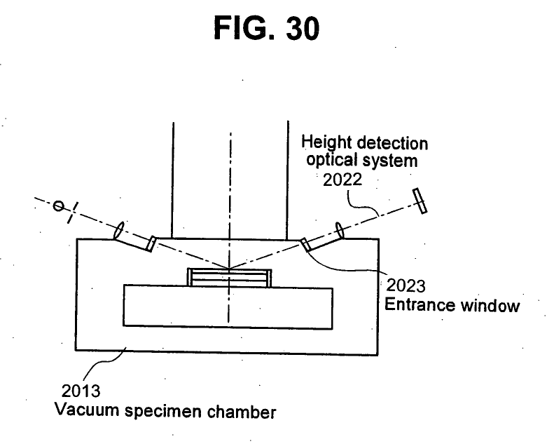

Accordingly, as shown in FIG. 30, there may be provided such an arrangement that an entrance window 2023 is formed perpendicularly to or at an angle which is almost perpendicular to the optical path of the height detection optical system for reducing surface reflectance on the window, thereby decreasing loss in the quantity of light on the optical path. In consideration of possible irregularity in distribution of the quantity of light in the beam, it is preferred to dispose the entrance window at an incidence angle of 30 deg. or less so that there will occur little variation in reflectance with incidence angle as indicated in FIG. 29. In addition to the external wall for separation between the inside of the vacuum specimen chamber and the atmosphere, there may be any member part on the optical path in the height detection optical system. If it is impossible to provide an opening through the member part, it is required to arrange a window thereon in the same manner. In such a case, loss in the quantity of light can be minimized by forming a shape of the window perpendicularly to the optical path as far as possible on condition that the shape of the window does not cause an adverse effect on the charged particle beam optical system.

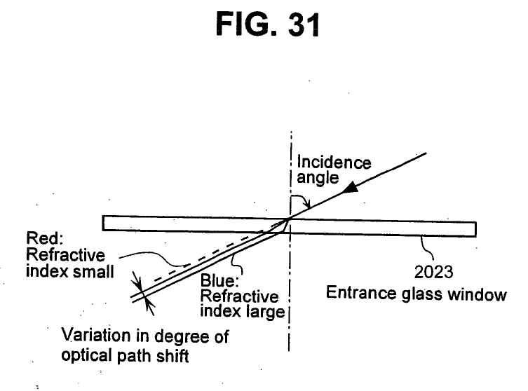

The following description describes exemplary preferred embodiments for reducing an effect of chromatic aberration due to variance in refractive index of glass material used for a window for light passage. When a light beam for height detection passes though the window made of glass, its optical path is made to shift. As shown in FIG. 31, since there is variance in refractive index of glass material, a degree of optical path shift varies depending on wavelength. When white light is used for specimen surface height detection, an error may occur in height detection due to chromatic aberration caused by the white light.

Further, the degree of optical path shift is dependent on an angle of incidence and proportional to a thickness of glass plate. If the incidence angle to the glass plate of the window is decreased as in the foregoing preferred embodiment, the degree of optical path shift can be reduced. However, if the incidence angle is rather large, there arises a particular problem. (For example, in case that the incidence angle is 70 deg., glass BK7 is used and the thickness of glass plate is 2 mm, there occurs a difference of 9 μm in optical path shift between wavelengths of 656.28 nm and 404.66 nm.).

Where white light is used, an effect of chromatic aberration varies with color of an object under inspection and therefore its correction is rather difficult. For reduction in effect of chromatic aberration, there may be provided such arrangements that the window glass plate is made thinner and a glass plate for correcting chromatic aberration is inserted on the optical path. Since the degree of optical path shift is proportional to the thickness of window glass plate, it is preferred to use a glass plate having a thickness which will not cause significant chromatic aberration, in consideration of applicable wavelength coverage and desired accuracy of height detection.

It is not necessarily required to use glass material if a required strength can be satisfied, and therefore an optically transparent part made of pellicle material, for example, may be employed. However, in case of the window on the vacuum specimen chamber, considerable strength is required and it is not permitted to make the glass plate sufficiently thinner. Therefore, in such a case, the glass plate for correcting chromatic aberration may be inserted on the optical path.

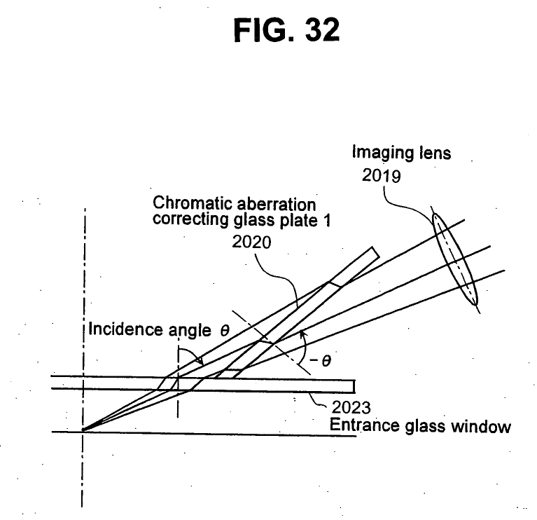

Referring to FIG. 32, there is shown an arrangement that a chromatic aberration correcting glass plate is inserted in the same positional relation as that of an entrance window with respect to an imaging lens. In this arrangement, a difference in degree of optical path shift can be canceled by disposing the chromatic aberration correcting glass plate, which has the same characteristic as the entrance glass window in that it, for example, is made of the same material as that of the entrance window and has the same thickness as that of the entrance window, so that an incidence angle to the chromatic aberration correcting glass plate will be θ with respect to an incidence angle to the entrance glass window θ. A similar arrangement may also be provided on the detector side with respect to the exit glass window.

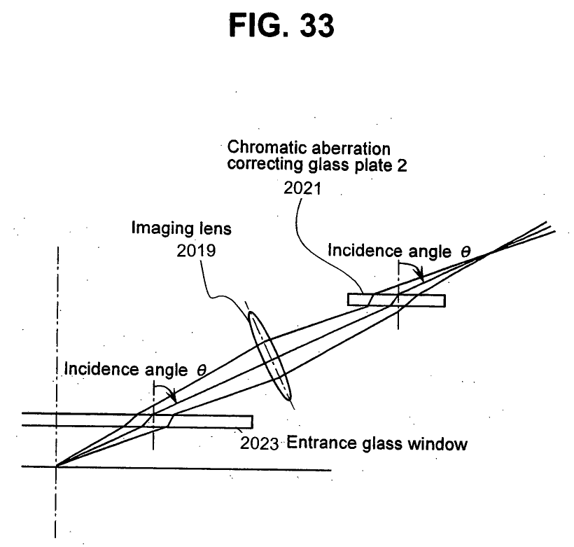

Further, in FIG. 33, there is shown an arrangement that a chromatic aberration glass plate and an imaging lens are located in reverse. In this arrangement, a difference in degree of optical path shift can also be canceled by disposing the chromatic aberration correcting glass plate, which is made of the same material as that of the entrance window and has a thickness proportional to a magnification of the imaging lens, so that the chromatic aberration correcting glass plate will be in parallel to the entrance window.

For the purpose of decreasing an accelerating voltage for the charged particle beam to be applied onto a specimen, a flat-plate electrode may be arranged at a position over a surface of the specimen in parallel thereto. In this arrangement, it is required to provide an opening or window on the flat-plate electrode to allow passage of light on an optical path for the height detector. Since a shape of the flat-plate electrode has an effect on electric field distribution in the vicinity of the specimen, it may affect the quality of charged particle beam images adversely. Exemplary embodiments for reducing an adverse effect on the charged particle beam images are described in the following description. A degree of adverse effect on the charged particle beam optical system varies depending on the size or position of the opening to be provided on the flat-plate electrode. An permissible level of adverse effect by the opening depends on performance required for the charged particle beam optical system. When the size of the opening is considerably small, its adverse effect may be negligible. Therefore, a method for reducing the opening size is explained below.

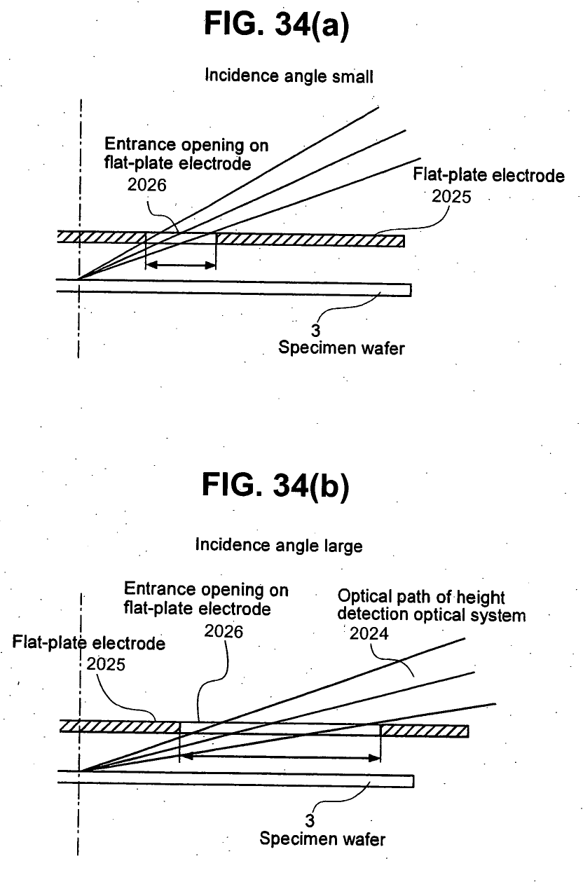

As shown in FIGS. 34(a) and 34(b), when an incidence angle to a surface of an object with respect to the vertical is increased from the small incidence angle of FIG. 34(a) to the relatively large incidence angle of FIG. 34(b), the size of an optical path going through a plane parallel to the object surface becomes larger even if a numerical aperture (NA) of the optical path of the height detection optical system is constant. Where the optical path goes through an opening on the flat-plate electrode 2025 as in this case, the shape of the opening 2026 must be enlarged substantially in the projecting direction of the optical axis to the flat-plate electrode from that shown in FIG. 34(a) to that shown in FIG. 34(b). This gives rise to a problem particularly in a situation where the numerical aperture of the optical system is rather large and a distance between the flat-plate electrode and the object surface is rather long. A suitable position of the flat-plate electrode is determined according to specifications of the charged particle beam optical system, and it cannot be changed in common applications. Further, it is not allowed to extremely decrease the numerical aperture since a sufficient quantity of light must be provided for detection.

Reduction of the size of the opening without decreasing the entire quantity of light for detection is described below. Commonly, an optical lens aperture having a circular shape whose center coincides with the optical axis is employed. According to one aspect of the present invention, there is provided an elliptic or rectangular optical lens aperture having its major axis which is in the axial direction across the optical axis and parallel to the object surface and having its minor axis which is in the axial direction across the major axis and the optical axis. In this arrangement, the entire quantity of light necessary for height detection can be ensured by providing an elliptic or rectangular area which is equal to that of a circular lens aperture.

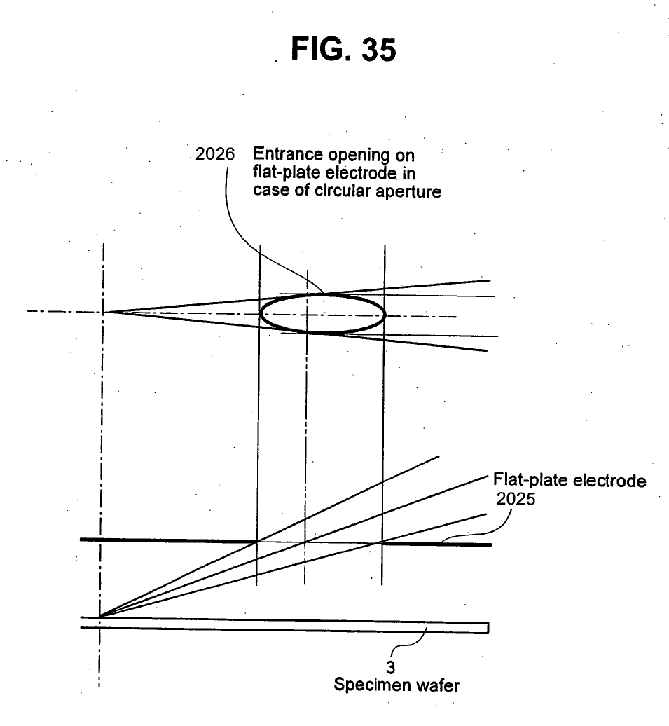

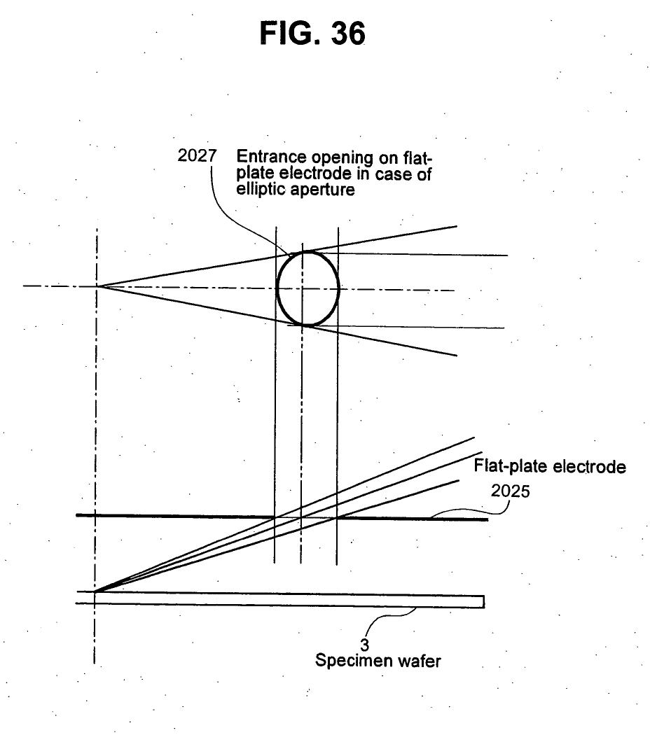

FIG. 35 shows an optical geometry of an optical path going through the opening 2026 of the flat-plate electrode 2025 in case of a circular optical aperture, and FIG. 36 shows an optical geometry of an optical path going through the opening 2026 of the flat-plate electrode 2025 in case of an elliptical optical aperture which has almost the same area as that of the circular optical aperture in FIG. 35. As can be seen from these figures, the size of the opening 2026 in one direction on the flat-plate electrode 2025 can be reduced by using the elliptic aperture. As illustrated here, the size and shape of the opening can be changed by modifying the shape of the aperture as far as performance required for the height detector can be ensured. Thus, a degree of adverse effect on the charged particle beam optical system can be reduced.

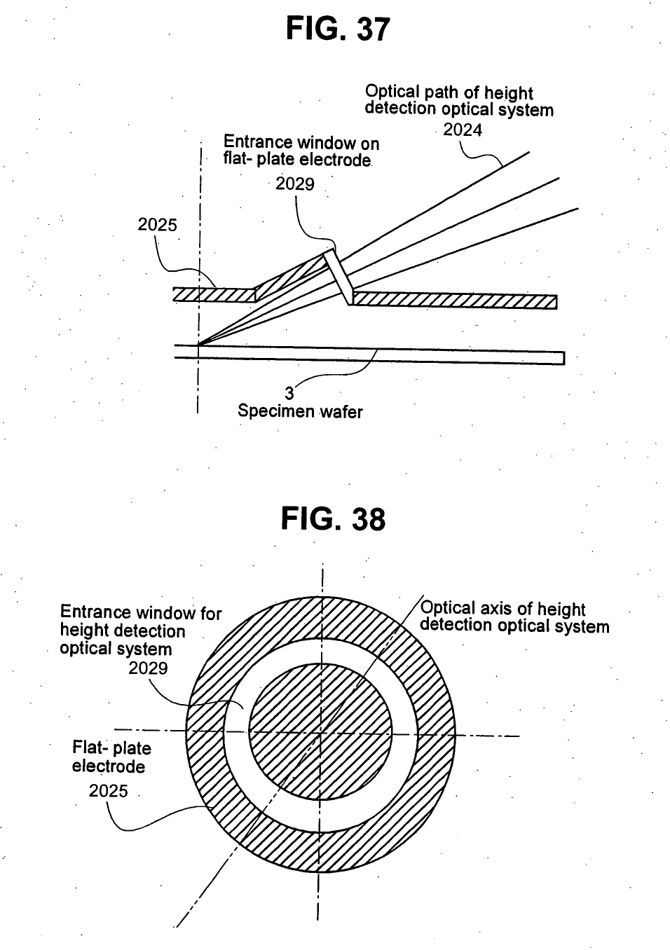

If the charged particle beam optical system is affected by the size of the opening so that performance required for it cannot be attained, it is necessary to provide a further measure. For example, instead of merely a hollow opening formed on the flat-plate electrode, there may be provided such an arrangement that a window made of glass coated with a conductive film or other material is formed on the flat-plate electrode to allow passage of light on an optical path. In this arrangement, an adverse effect due to electric field to be given to an object or its periphery can be reduced. As exemplified in FIG. 28, if the window is formed at the position of the opening along a plane of the flat-plate electrode in FIG. 34, significant loss in the quantity of light occurs due to reflection on a surface of the window, causing irregular distribution in the quantity of light in the beam. Therefore, as exemplified in FIG. 30, there may be provided such an arrangement that the window is formed perpendicularly to or at an angle almost perpendicular to the optical path. Thus, loss in the quantity of light due to reflection on the surface of the window can be decreased. FIG. 37 shows an example of the window formed in this arrangement.

The opening or window formed on the flat-plate electrode in the foregoing examples has a considerable effect on electric potential distribution in the vicinity of the object. The following describes an opening/window disposition method for reducing this effect. Since the window and opening can be disposed in the same manner, the window is taken in the description given below.

In a microstructure observation/fabrication system to which the present invention is directed, two-dimensional observation or fabrication is mostly carried out through two-dimensional scanning by deflecting a convergent charged particle beam or through stage scanning by combination of one-dimensional scanning based on charged particle beam deflection and stage movement in the direction orthogonal to the one-dimensional scanning. According to the present invention, the window is disposed in consideration of charged particle beam deflection and stage movement direction in charged particle beam scanning. Thus, an effect of variation in electric field due to the window can be reduced as proposed below.

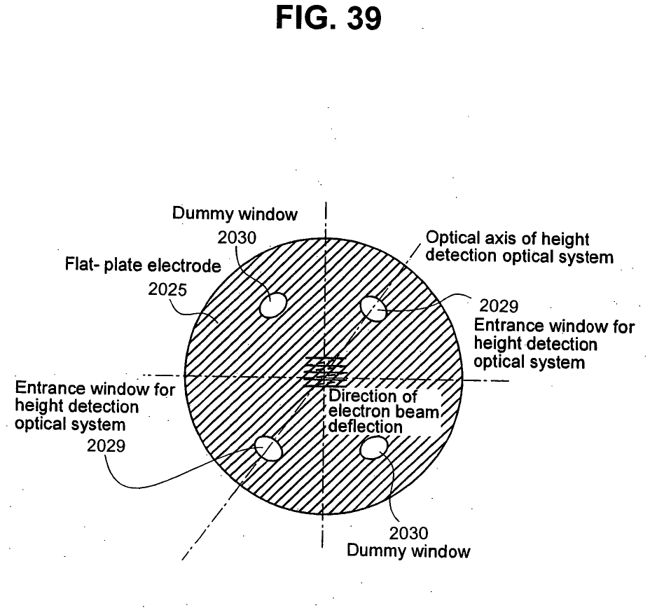

Referring to FIG. 38, there is shown an example of disposition in which the window 2029 is provided in a circumferential form having its center at the optical axis of the charged particle beam optical system. Since the window is located at a position apart from a scanning range of the charged particle beam, an effect of variation in electric field due to the window is isotropic in the disposition shown in FIG. 38. Thus, the effect will be almost uniform in an observation region in the charged particle beam optical system. Further, it is possible to attain almost the same result by disposing dummy windows 2030 at axisymmetric positions with respect to the directions of electron beam deflection and stage movement as shown in FIG. 39.

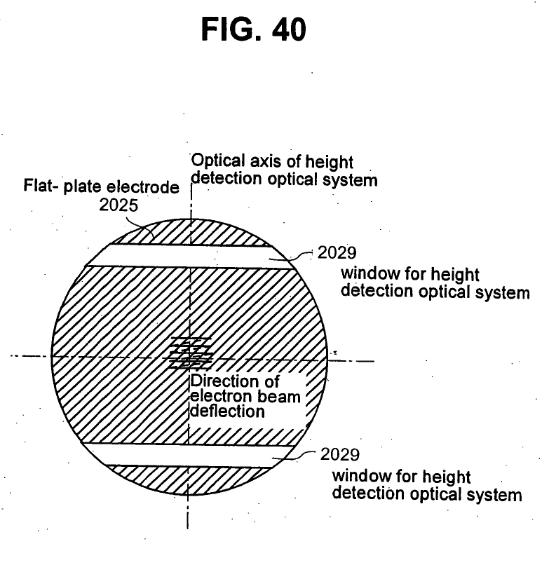

In case of stage scanning, electric field distribution in a deflection range can be made uniform by disposing windows 2029 in parallel to the deflection direction as shown in FIG. 40. If electric field distribution is kept uniform, scanning position correction is allowed to enable improvement in image quality. In carrying out the present invention, an effect to be given by the shape and disposition of these windows or openings is to be examined in consideration of specifications of the charged particle beam optical system and desired inspection performance to select suitable window formation and disposition.

The following describes exemplary embodiments for charged particle beam focus adjustment using height detection result data attained by the height detector. A focal point of the charged particle beam is adjusted by an objective lens control current. Using input data of an object surface height detected by the height detector in an observation region of the charged particle beam optical system, the objective lens control current is regulated to enable observation of a charged particle beam image which is always in focus. For this purpose, in the charged particle beam optical system, a level of objective lens control current is to be calibrated beforehand with respect to variation in object surface height. Further, an offset and gain in relation between the height detector and the charged particle beam optical system are to be calibrated beforehand.

Calibration methods for offset and gain will be described in the following exemplary embodiments. When the charged particle beam optical system is not structured in a telecentric optical arrangement, variation in object surface height will cause a magnification error in addition to a defocused condition. As to the magnification error, correction can be made through feedback control of a deflection circuit using height variation data, thus making it possible to always attain a charged particle beam image at the same magnification. Further, if the microstructure observation/fabrication system using the convergent charged particle beam is provided with a mechanism capable of moving an object in the Z-axis direction with high accuracy and at response speed sufficient for focal point control, resultant data of height detection may be used for object stage height feedback control instead of feedback control of the charged particle beam optical system.

Where stage height feedback control is carried out, a surface of the object can always be maintained at a constant height with respect to the height detector and the charged particle beam optical system. Therefore, no problem will arise even if a guaranteed detection accuracy range of the height detector is narrow. As a drive mechanism for an object stage, there may be provided a piezoelectric mechanism enabling fine movement at high speed under vacuum, for example. When such a piezoelectric mechanism is used, a magnification error does not occur since a height of the object surface is always maintained at a constant level with respect to the charged particle beam optical system.

Calibration of objective lens control current and focal point in the charged particle beam optical system may be carried out in the following manner. In an instance where there is a nonlinear relationship between objective lens control current and focal point, it is required to make correction for nonlinearity. Linearity evaluation and correction value determination may be effected as described below.

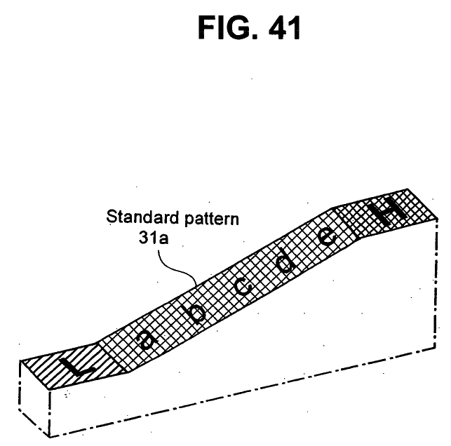

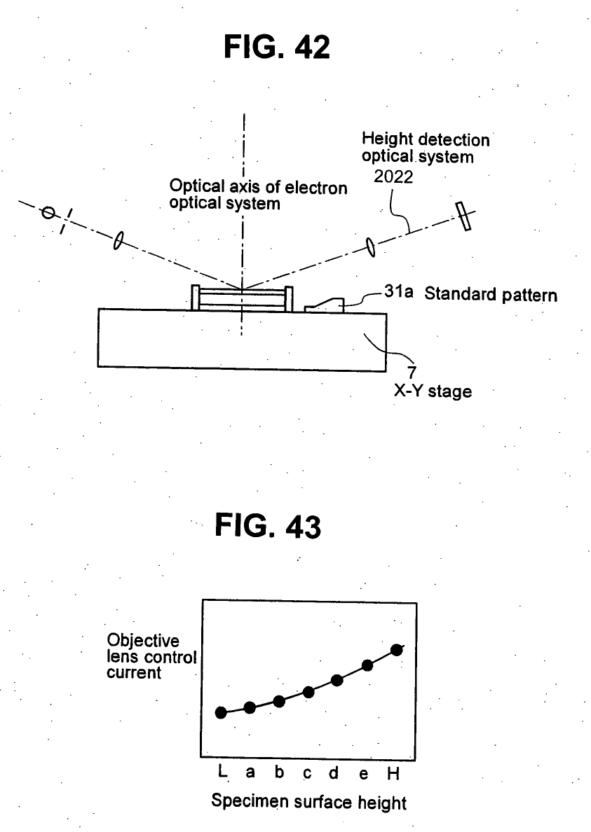

Referring to FIG. 41, there is shown a standard pattern 31a for calibration. As shown in FIG. 42, this standard calibration pattern is secured to a stage for holding an object. The standard calibration pattern is made of conductive material so that it will not be charged by scanning of the charged particle beam. It is also desirable to provide such a surface pattern feature that a height at each position can be identified.

When the object holding stage is movable on a plane as in the inspection system shown in FIG. 22, the standard pattern is moved to an observation region at the time of calibration. Using the standard pattern, objective lens control current measurement is effected to determine a current level where a charged particle beam image becomes sharpest at each point. At this step, visibility of the charged particle beam image is determined through visual observation or image processing. In this measurement, it is possible to determine a relationship between variation in object surface height and optimum level of objective lens control current as shown in FIG. 43. If the relationship between variation in object surface height and optimum level of objective lens control current is determined, a value of objective lens control current which is most suitable for forming the charged particle beam image in focus can be identified using object surface height data attained by the height detector.

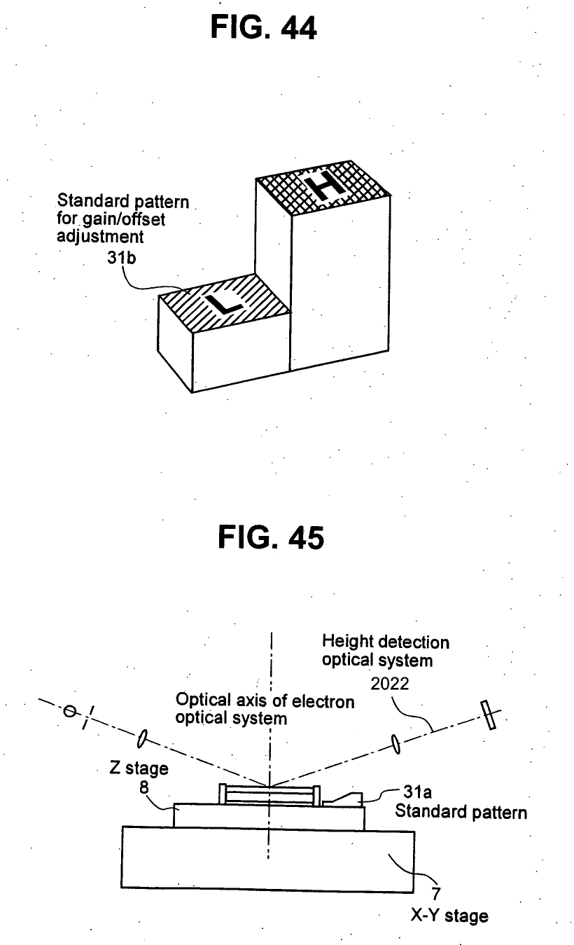

The standard pattern 31a shown in FIG. 41 has a flat part at both ends thereof. At each flat part, if a reference height is determined through measurement with the optical height detector, gain/offset calibration of objective lens control current can be made according to height measurement data. In case that characteristics of objective lens control current and focal point are calibrated for the objective lens by any means, gain/offset calibration of objective lens control current may be made with respect to the optical height detector using a standard pattern 31b which has two step parts as shown in FIG. 44.

Where the object holding stage is not provided with a movement mechanism, the charged particle beam optical system can be calibrated by disposing the standard pattern so that it will always be located in a visual field of the charged particle beam optical system. Further, the standard pattern may be formed so that it can be attached to an object holding jig. Thus, even when the object holding stage is not provided with a movement mechanism, it is possible to perform calibration by setting the standard pattern on the stage and thereafter exchange the standard pattern with the object for observation.

In case that the charged particle beam system is provided with a mechanism for moving an object in the height direction as shown in FIG. 45, an ordinary stepless pattern is utilizable instead of the standard pattern shown in FIG. 41. Through height detection by Z stage movement and image evaluation using the stepless pattern, calibration of objective lens control current can be made with respect to the height detector. Where there is provided a movement mechanism for Z stage, it is possible to conduct focus adjustment using the Z stage. However, if a response speed of the Z stage is not sufficiently high for an observation region change speed, focal adjustment may be made using the objective lens control current with the stage being fixed.

Calibration of the charged particle beam optical system using the standard pattern shown in FIG. 41 is practicable only in a microstructure observation/inspection system which allows observation of a surface feature of the standard pattern using the charged particle beam optical system. As contrasted, in a microstructure fabrication system, calibration is to be made only for the height detector using the standard step-pattern shown in FIG. 44, and for a relationship between focal point and control current of the charged particle beam optical system, calibration is made beforehand therein. Where the microstructure fabrication system is provided with a charged particle beam image observation mode in which such an operational parameter as an accelerating voltage for the convergent charged particle beam can be altered, it is possible to check a point detected by the height detector using a charged particle beam image.

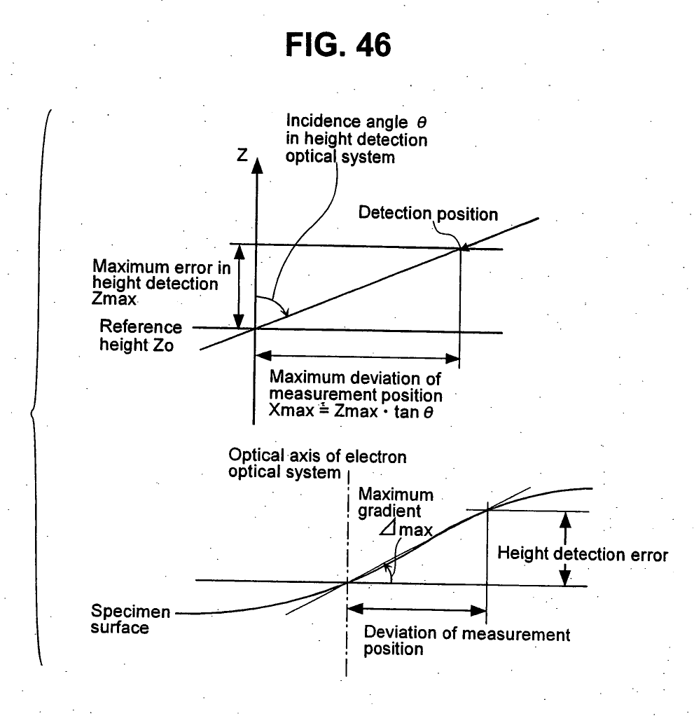

The following describes exemplary embodiments concerning focal point correction and relationship between height measurement position under inspection and observation position in the charged particle beam optical system. If the observation position of the charged particle beam optical system completely meets the height detection position of the height detector, focus adjustment may be made according to height data detected by the height detector. However, in the light-reflected position detecting method, a deviation of detection position occurs due to variation in object surface height as illustrated in FIG. 23. Designating a predictable value of maximum variation in object surface height as Zmax and an incidence angle in the height detection optical system as θ, a value of maximum positional deviation Xmax is equal to Zmax·tan φ. Then, on condition that a value of allowable variation in object surface height in terms of focal depth of the charged particle beam optical system and performance requirement for the system is z0 and a predictable value of maximum gradient of object surface is Δmax, a value of height detection error for maximum positional deviation dz is expressed as Δmax·Xmax=Δmax·Zmax·tan θ as indicated in FIG. 46. If the height detection error dz is smaller than z0, there arises no problem. However, if dz is larger than z0, it is required to attain a height on the optical axis of the charged particle beam optical system.

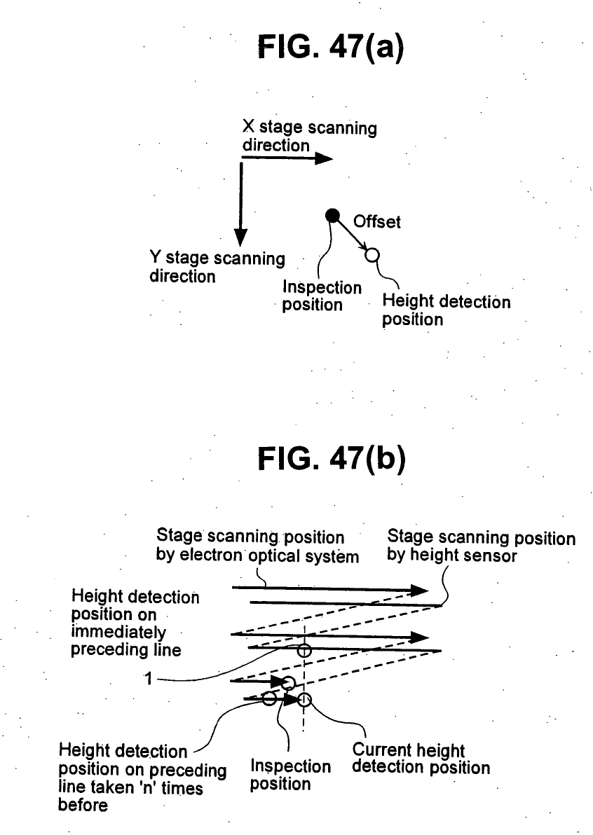

In the inspection system according to the present invention, since continuous inspection is performed by moving the stage, height data at each point can be attained continuously. Using resultant data of height detection, a height of object surface in an observation region in the charged particle beam optical system may be presumed or predicted to enable focus adjustment. Focus adjustment when there is a positional deviation between the height detection position and the observation region in the charged particle beam optical system may be effected in the following manner. In the following description, it is assumed that stage scanning is performed by deflecting the beam of the charged particle beam optical system in the Y-axis direction and moving the stage in the X-axis direction to produce a two-dimensional image.

Where each of X-axis and Y-axis stage scanning movements is always limited to one direction at the time of inspection, if each of the X-axis and Y-axis scanning movements is always made in one direction only as shown in FIG. 47, i.e., reciprocal scanning movement is not performed, the height detector may be disposed with an offset so that the height detection position will always be located before the observation position of the charged particle beam optical system with respect to the direction of stage scanning movement as shown in FIG. 47(a). In this manner, a height at a desired position can be determined using height data in the vicinity of the observation region, which is attainable before each step of inspection.

As shown in FIG. 47(b), three points in the vicinity of the current inspection position are selected and a height of the inspection position is presumed according to a local plane determined by these three points. It is necessary to select three points so that the current inspection position will be located inside a triangle formed with the selected three points. Thus, a height of the inspection position can be presumed reliably through interpolation. In this case, although a height of a stage scanning position at the start of inspection cannot be presumed, it can be determined by performing a sequence of scanning for height detection in advance.

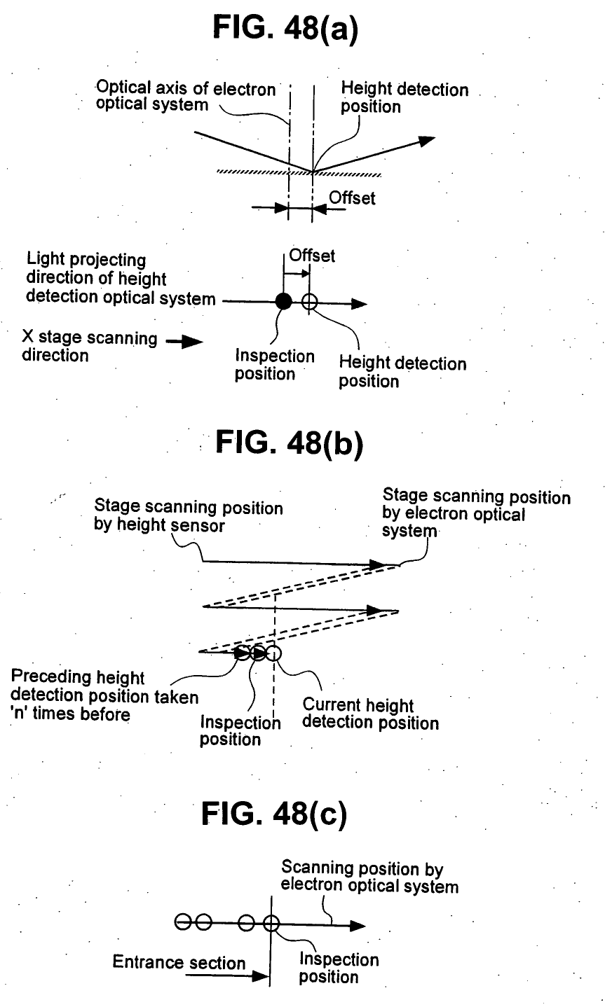

Another exemplary embodiment is considered in that either one of X-axis and Y-axis stage scanning movements is always limited to one direction and also the axis movable only in one direction coincides with the projection direction of the height detection optical system. As shown in FIG. 48, if the X-axis stage scanning movement is always limited to one direction and the X axis coincides with the projection direction of the height detection optical system, positional deviation in height detection due to variation in height takes place only in the X-axis direction. Therefore, by providing an offset in the X-axis direction as shown in FIG. 48(a), a height can be determined through one-dimensional interpolation using height data on one line only. In this case, a height of the inspection position may be determined by means of linear interpolation using two-point data or spline interpolation using three-point data. At the start of inspection, a height detection value in an entrance section until the stage reaches a constant speed may be used.

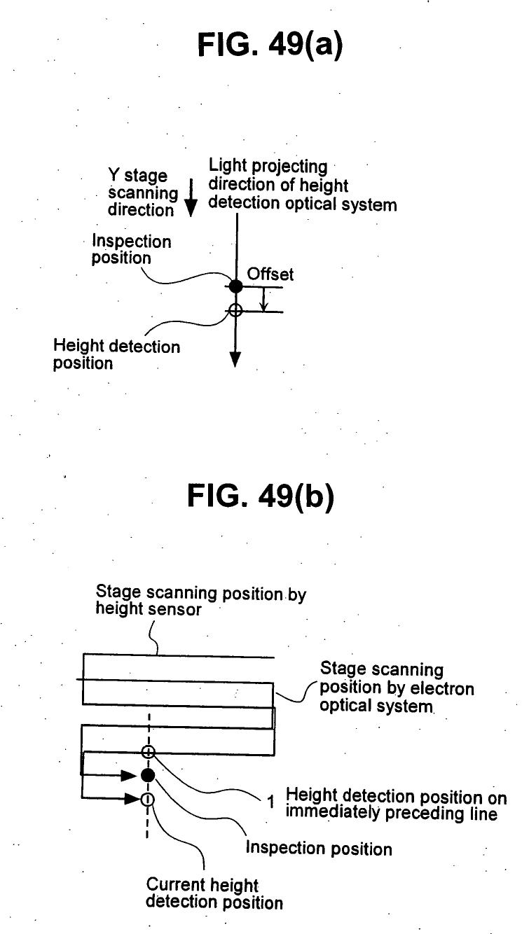

Further, as shown in FIG. 49, if the Y-axis stage scanning movement is always limited to one direction and the Y axis corresponds to the projection direction of the height detection optical system, positional deviation in height detection due to variation in height takes place only in the Y-axis direction. Therefore, by providing an offset in the Y-axis direction as shown in FIG. 49(a), a height of the inspection position can always be determined reliably through interpolation using height detection data on a preceding line. In case that the stage is moved in a reciprocal scanning fashion, such an offset as mentioned above cannot be provided in one direction.

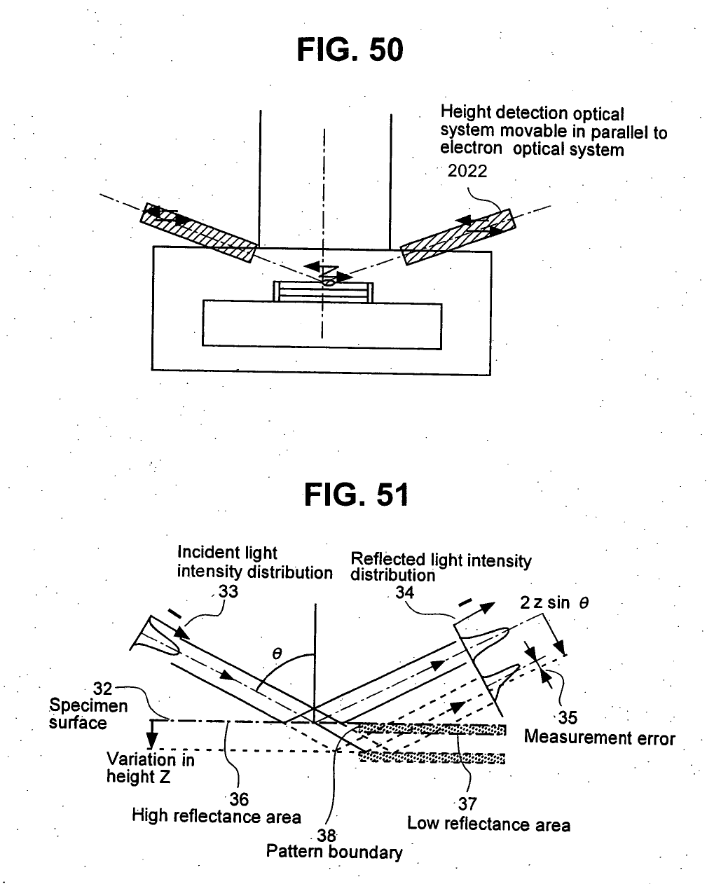

In an arrangement that the optical axis of the charged particle beam optical system is made to coincide with a reference position of height detection, it is possible to presume a height of the inspection position using height detection data attained. However, since a height of the inspection position cannot always be determined through interpolation, its reliability is not ensured. For reliable height detection, there may be provided such an arrangement that the height detection optical system is equipped with a movable mechanism and the entire optical system is shifted in parallel as shown in FIG. 50 so as to give an offset in the stage scanning movement direction. Thus, a height of the inspection position can always be determined reliably through interpolation in the same manner as in the foregoing example. There may also be provided such an arrangement that a plurality of height detectors are disposed to enable height measurement at a plurality of points in the vicinity of the inspection position. In this arrangement, data of only necessary points can be used according to the stage scanning movement direction.

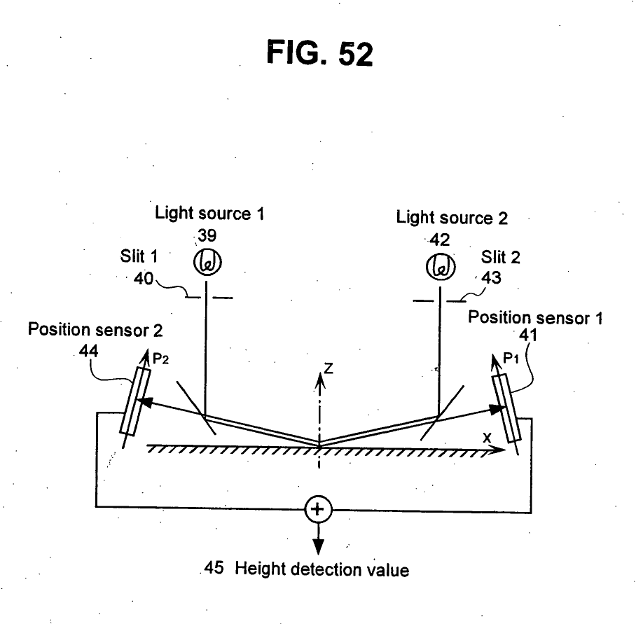

Exemplary embodiments for optical height detection in which a height of a specimen surface can be detected reliably without being affected by a state of the specimen surface are now considered. In case that a specimen surface height is detected by the light-reflected position detecting method as shown in FIG. 23, a deviation of a detection position occurs to cause an error in height detection. As shown in FIG. 51, if a specimen surface 32 is provided with pattern areas having different reflectances (high reflectance area 36, low reflectance area 37) and slit light is projected onto a pattern boundary 38 therebetween, reflected light intensity distribution 34 of slit light to be detected is affected to cause an error in height detection. Such a height detection error may be reduced in the following manner. As shown in FIG. 52, two slit light beams are projected onto the specimen surface in directions symmetrical with respect to a normal line thereon, and respective reflected light beams from the specimen surface are detected. If sensors for detecting these slit light beams are disposed as shown in FIG. 52, a light image shift due to variation in specimen surface height is made in the same direction and a measurement error due to specimen surface features appears in the opposite directions. Therefore, an effect of specimen surface pattern features can be canceled by means of addition. Further, in case that the slit light beams are projected in two directions as shown in FIG. 52, a deviation of the detection position due to variation in height occurs to the same extent in the opposite directions. Therefore, a deviation of the detection position can be eliminated by means of averaging.

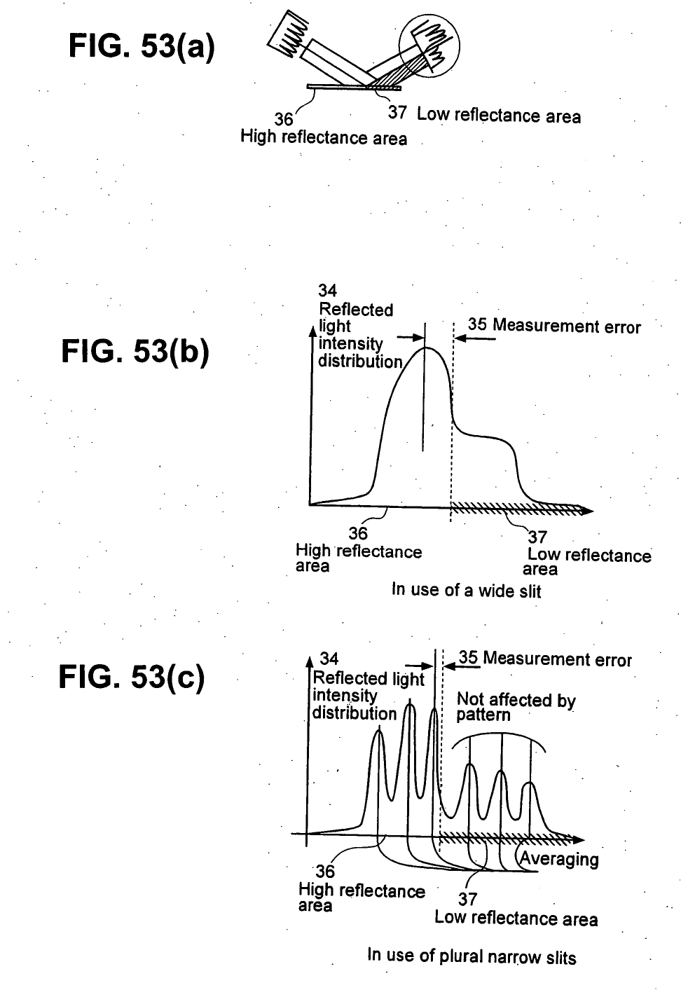

FIG. 53 shows a method for reducing an effect of specimen surface pattern features using a plurality of fine slits. A height detection error due to specimen surface pattern features increases in proportion to a slit width. Therefore, as shown in FIG. 53(a), a plurality of fine slit light beams are projected onto the specimen surface, and reflected light beams are detected by a linear image sensor. Individual center values of plural slit beam images are determined and averaged, thus making it possible to reduce an error in height detection. As shown in FIG. 53(c) in comparison with FIG. 53(b), an error on a pattern boundary can be reduced by decreasing each slit width. Since fine slit beams on other than the pattern boundary are not affected by pattern features, an error on the pattern boundary can be decreased through averaging. Although the quantity of light to be detected decreases as each slit width is decreased, an S/N ratio can be improved by averaging for plural slit positions, thereby ensuring reliability in height detection.

According to the present invention, it is possible to detect a height of an observation position in the electron beam optical system using the optical height detector and attain an in-focus electron beam image while conducting inspection. In an electron beam inspection system, inspection performance and reliability thereof can be improved by carrying out inspection using an electron beam image which is always focused in a consistent state. Furthermore, since height detection can be made simultaneously with inspection, continuous stage movement is applicable to inspection to reduce a required inspection time substantially. This feature is particularly advantageous in inspection of semiconductor wafers which will become still larger in diameter in the future. Similarly, the same advantageous effects can be attained in a microstructure observation/fabrication system using a convergent charged particle beam. Further, by disposing the height detection optical system outside the vacuum specimen chamber, adjustment and maintenance can be carried out with ease.

Mathematical formula within the disclosure gleaned from the first application will be referenced as “expressions.”

An embodiment of an automatic inspection system for inspecting/measuring a micro-circuit pattern formed on a semiconductor wafer which is an inspected object according to the present invention will be described. A defect inspection of the micro-circuit pattern formed on the semiconductor wafer or the like is executed by comparing inspected patterns and good pattern and patterns of the same kind on the inspected wafer. Also in the case of an appearance inspection using an electron microscope image (SEM image), a defect inspection is executed by comparing pattern images. Furthermore, also in the case of the length measurement (SEM length measurement) executed by a scanning-type electron microscope which measures a line width or a hole diameter of a micro-circuit pattern used to set or monitor a manufacturing process condition of semiconductor devices, the length measurement can be automatically executed by the image processing.

In the comparison inspection for detecting a defect by comparing electron beam images of a similar pattern or when a line width of a pattern is measured by processing an electron beam image, a quality of an obtained electron beam image exerts a serious influence upon the reliability of the inspected results. The quality of electron beam image is deteriorated by an image distortion caused by deflection and aberration of an electron optical system and is also deteriorated as resolution is lowered by a de-focusing. The deterioration of the image quality lowers a comparison and inspection efficiency and a length measurement efficiency.

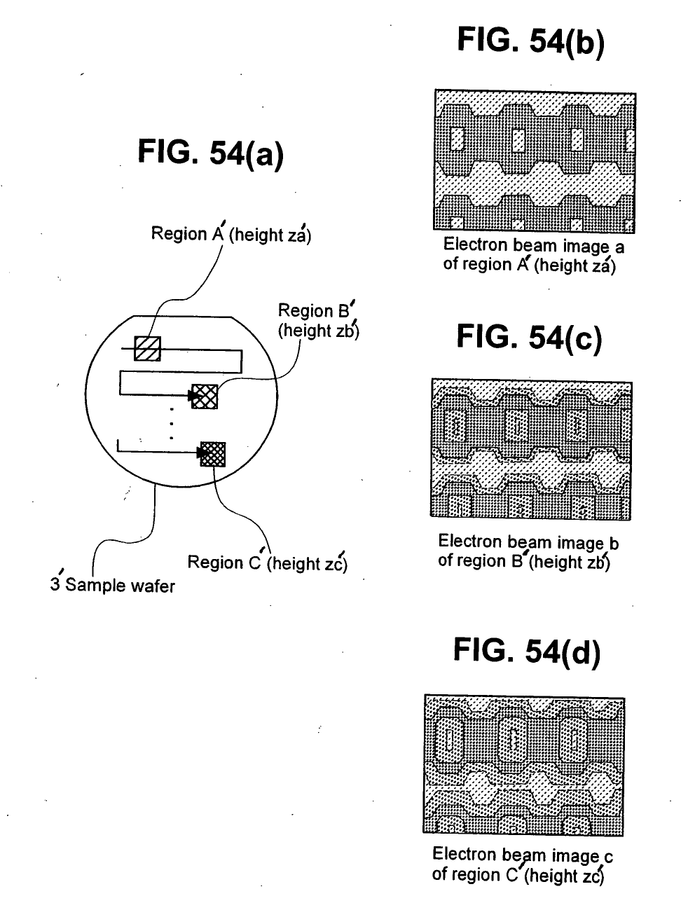

Referring now to the drawings, a height of a surface of an inspected object is not even and an inspection is executed over the whole range of heights under the same condition for a wafer as shown in FIG. 54(a), then as shown in FIGS. 54(b)-(d), electron beam images (SEM images) are changed in accordance with the inspection portions (area A′, area B′, area C′). As a result, if an inspection is carried out by comparing an image (electron beam image of area A′ (height za′) of a properly-focused point shown in FIG. 54(b), a de-focused image (electron beam image of area B′ (height zb′) shown in FIG. 54(c), and a defocused image (electron beam image of area C′ (height zc′) shown in FIG. 54(d), then a correct inspected result cannot be obtained. Moreover, in these images, the width of the pattern is changed, and an edge detected result of an image cannot be obtained stably so that the line width and the hole diameter of the pattern also cannot be measured stably.

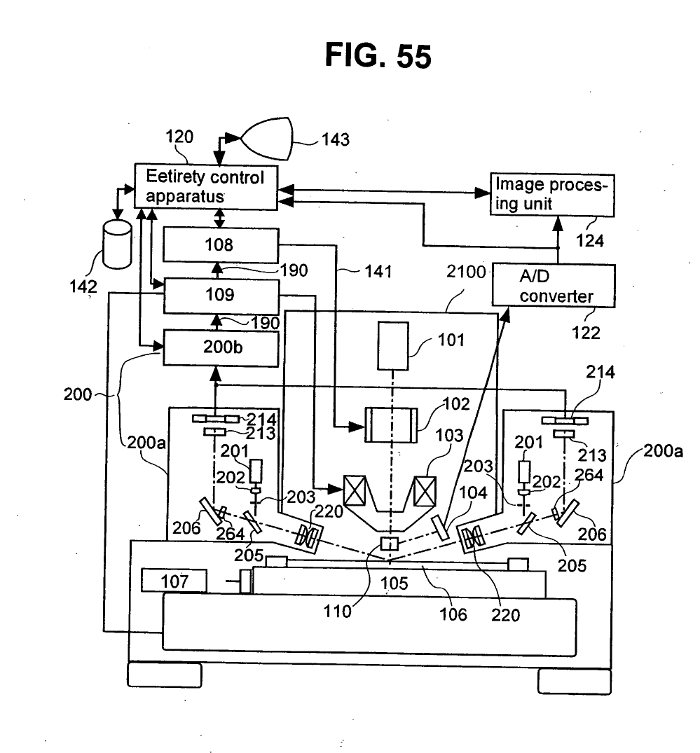

An electron beam apparatus according to an embodiment of the present invention will be described with reference to FIG. 55. An electron beam apparatus 2100 composed of an electron beam column for irradiating electron beams on an inspected object (sample) 106 comprises an electron beam source 101 for emitting electron beams, a deflection element 102 for deflecting electron beams emitted from the electron beam source 101 in a two-dimensional fashion, and an objective lens 103 which is controlled so as to focus the electron beam on the sample 106. Specifically, the electron beam emitted from the electron beam source 101 is passed through the deflection element 102 and the objective lens 103 and focused on the sample 106. The sample 106 rests on an XY stage 105 and the position thereof is measured by a laser length measuring system 107. Further, in the case of an SEM apparatus, a secondary electron emitted from the sample 106 is detected by a secondary electron detector 104, and a detected secondary electron signal is converted by an A/D converter 122 into an SEM image. The SEM image thus converted is processed by an image processing unit 124. In the case of the length measuring SEM, for example, the image processing unit 124 measures a distance between patterns of a designated image. Also, in the case of an observation SEM (appearance inspection based on the SEM image), the image processing unit 124 executes a processing such as emphasis of the image or the like. The secondary electron includes a secondary electron with a higher energy level which is sometimes called a back-scattered electron. From the viewpoint of forming scanning electron images, it is not meaningful to discriminate between the back-scattered electron and the secondary electron.

In accordance with the present invention, an electron beam image is prevented from being deteriorated in the above-mentioned electron beam apparatus (observation SEM apparatus, length measuring SEM apparatus).

The quality of the electron beam image is deteriorated due to image distortion caused by deflection and aberration of the electron optical system, and a resolution is lowered by de-focusing. For preventing the image quality from being deteriorated, the present invention provides, as shown in FIG. 55, a height detection apparatus 200 composed of a height detection optical apparatus 200a and a height calculating unit 200b, a focus control apparatus 109, a deflection signal generating apparatus 108, and an entirety control apparatus 120.

The height detection apparatus 200 composed of the height detection optical apparatus 200a and the height calculating unit 200b is arranged substantially similarly to a second embodiment which will be described later, and is installed about an optical axis 110 of an electron beam symmetrically with respect to the sample 106. An illumination optical system of each height detection optical apparatus 200a comprises a light source 201, a condenser lens 202, a mask 203 with a multi-slit pattern, a half mirror 205, and a projection/detection lens 220. A detection optical system of each height detection optical apparatus 200a comprises a projection/detection lens 220, a magnifying lens 264 for focusing an intermediate multi-slit image focused by the projection/detection lens 220 on a line image sensor 214 in an enlarged scale, a mirror 206, a cylindrical lens (cylindrical lens) 213, and a line image sensor 214.

By the illumination optical system of the respective height detection optical apparatus which is installed symmetrically, a multi-slit shaped pattern is projected at the measurement position on the sample 106 for detecting an SEM image with the above-mentioned irradiation of electron beams. This regularly-reflected image is focused by the detection optical system of each height detection optical apparatus 200a and thereby detected as a multi-slit image. Specifically, since the height detection optical apparatus 200a projects and detects patterns of multi-slit shape from the left and right symmetrical directions and the height calculating unit 200b constantly obtains a height of a constant point 110 by averaging both detected values, it is necessary to locate a pair of height detection optical apparatus 200a in the left and right directions. Initially, a light beam emitted from the light source 201 is converged by the condenser lens 202 in such a manner that a light source image is focused at the pupil of the projection/detection lens. This light beam further illuminates the mask 203 on which the multi-slit shaped pattern is formed. Of the light beams, the light beam that was reflected on the half mirror 205 is projected by the projection/detection lens 220 onto the sample 106. The multi-slit pattern that was projected onto the sample is regularly reflected and passed through the projection/detection lens 220 of the opposite side. Then, the light beam passed through the half mirror 205 is focused in front of the magnifying lens 264. This intermediate image is focused on the line image sensor 214 by the magnifying lens 264. At that time, of the luminous flux, the portion that was passed through the half mirror 205 is focused on the line image sensor 214. In this embodiment, the cylindrical lens 213 is disposed ahead of the line image sensor 214 to compress the longitudinal direction of the slit and thereby the light beam is converged on the line image sensor 214. Assuming that m is a magnification of the detection optical system, then when the height of the sample is changed by z, a multi-slit image is shifted by 2mz·sin θ on the whole. By utilizing this fact, the height calculating unit 200b calculates a shift amount of the multi-slit image from a signal of a multi-slit image detected from the detection optical system of each height detection optical apparatus 200a, calculates a height of a sample from the calculated shift amount of the multi-slit image, and obtains a height on the electron beam optical axis 110 on the sample by averaging these calculated heights of the sample. Specifically, the height calculating means 200b calculates the height of the sample 106 from the shift amounts of the right and left multi-slit images. Here, an average value therebetween is calculated by using the height detected values obtained from the right and left detection system 200a, and is set to a height detection value at the final point 110. The position 110 at which the height is to be detected becomes an optical axis of the upper observation system.

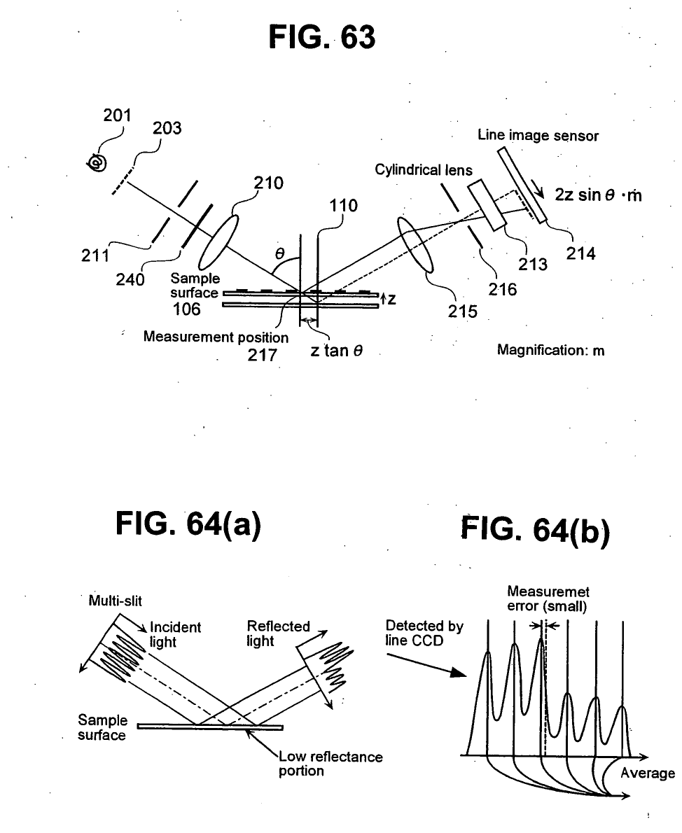

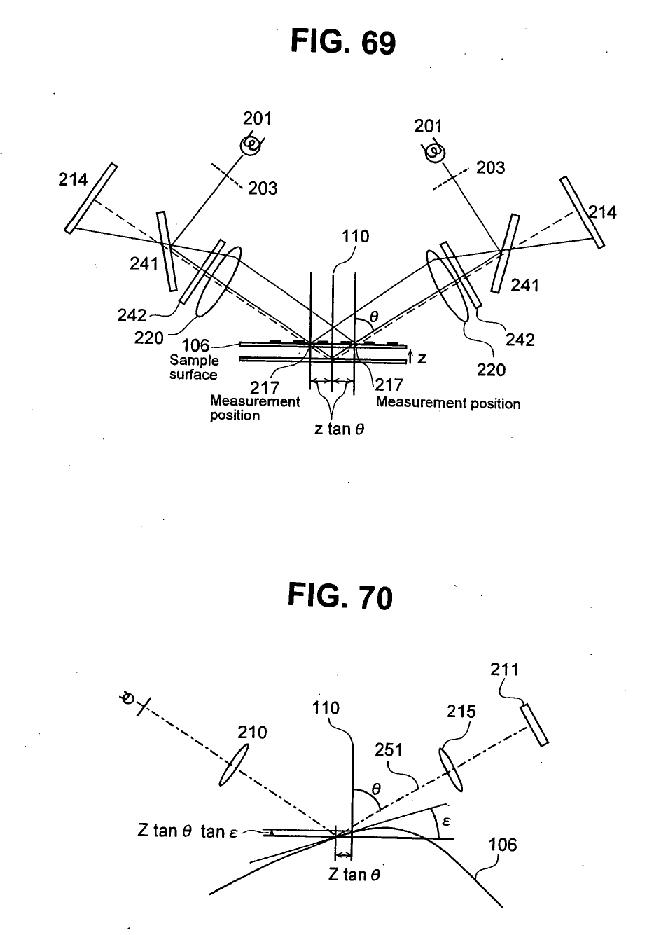

Incidentally, while the height detection optical apparatus 200a is arranged substantially similarly to a second embodiment as shown in FIG. 68 as described above, it is apparent that the optical system according to the first embodiment as shown in FIG. 63 or an optical system according to a third embodiment as shown in FIG. 69 or optical systems according to embodiments as shown in FIGS. 78, 79, 80, 83 may be used.

The focus control apparatus 109 drives and controls an electromagnetic lens or an electrostatic lens on the basis of height data 190 obtained from the height calculating unit 200b to thereby focus an electron beam on the surface of the sample 106.

A deflection signal generating apparatus 108 generates the deflection signal 141 to the deflection element 102. At that time, the deflection signal generating apparatus 108 corrects the deflection signal 141 on the basis of the height data obtained from the height calculating unit 200b in such a manner as to compensate for an image magnification fluctuation caused by the fluctuation of the height of the surface of the sample 106 and an image rotation caused by the control of the electromagnetic lens 103. Incidentally, if an electrostatic lens is used as the objective lens 103 instead of the electromagnetic lens, then the image rotation caused when the focus is controlled does not occur so that the image rotation need not be corrected by the height data 190. Further, if lens 103 is comprised of a combination of an electromagnetic lens and an electrostatic lens, the electromagnetic lens has a main converging action and the electrostatic lens adjusts the focus position, then the image rotation, of course, need not be corrected by the height data 190.

Further, instead of directly controlling the focus position of the electromagnetic lens or the electrostatic lens 103 by the focus control apparatus 109 under the condition that the stage 105 is used as an XYZ stage, the height of the stage 105 may be controlled.

The entirety control apparatus 120 controls the whole of the electron beam apparatus (SEM apparatus), displays a processed result processed by the image processing apparatus 124 on a display 143 or stores the same in a memory 142 together with coordinate data for the sample. Also, the entirety control apparatus 120 controls the height calculating unit 200b, the focus control apparatus 109 and the deflection signal generating apparatus 108 thereby to realize a high-speed auto focus control in the electron beam apparatus and an image magnification correction and an image rotation correction caused by this focus control. Furthermore, the entirety control apparatus 120 executes a correction of a height detected value, which will be described later.

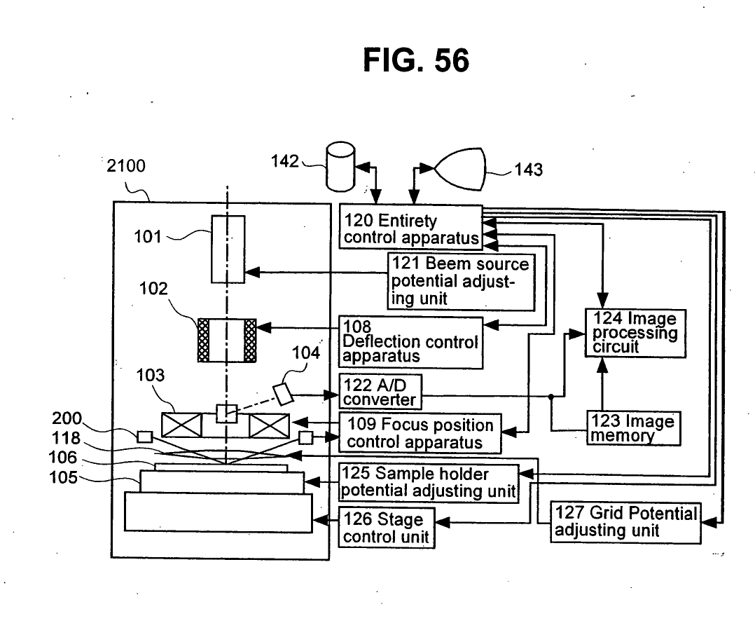

FIG. 56 shows a defect detection apparatus using an SEM image according to an embodiment of the present invention. Specifically, the appearance inspection apparatus using an SEM image comprises an electron beam source 101 for generating electron beams, a beam deflector 102 for forming an image by scanning beams, an objective lens 103 for focusing electron beams on an inspected object 106 formed of a wafer or the like, a grid 118 disposed between the objective lens 103 and an inspected object 106, a stage 105 for holding, scanning or positioning the inspected object 106, a secondary electron detector 104 for detecting secondary electrons generated from the inspected object 106, a height detection optical apparatus 200a, a focus position control apparatus 109 for adjusting a focus position of the objective lens 103, an electron beam source potential adjusting unit 121 for controlling a voltage of the electron beam source, a deflection control apparatus (deflection signal generating apparatus) 108 for realizing a beam scanning by controlling the beam deflector 102, a grid potential adjusting unit 127 for controlling a potential of the grid 118, a sample holder potential adjusting unit 125 for adjusting a potential of a sample holder, an A/D converter 122 for A/D-converting a signal from the secondary electron detector 104, an image processing circuit 124 for processing a digital image thus A/D-converted, an image memory 123 therefor, a stage control unit 126 for controlling the stage, an entirety control unit 120 for controlling the entirety, and a vacuum sample chamber (vacuum reservoir) 2100. A height detection value 190 of the height detection sensor 200 is constantly fed back to the focus position control apparatus 109 and a deflection control apparatus (deflection signal generating apparatus) 108. When the inspected object 106 is inspected, the entirety control unit 120 continuously moves the stage 105 by issuing a command to the stage control apparatus 126. Concurrently therewith, the entirety control unit 120 issues a command to the deflection control apparatus (deflection signal generating apparatus) 108, and the deflection control apparatus 108 drives the beam deflector 102 to scan electron beams in the direction perpendicular thereto. Simultaneously, the deflection control apparatus 108 receives the height detection value 190 obtained from the height calculating unit 200b and corrects a deflection direction and a deflection width. The focus position control apparatus 109 drives the electromagnetic lens or electrostatic lens 103 in accordance with the height detection value 190 obtained from the calculating unit 200b, and corrects a properly-focused height of electron beam. At that time, the secondary electron detector 104 detects secondary electrons generated from the sample 106 and enters the detected secondary electron into the A/D converter 122 to thereby continuously obtain SEM images.

When the appearance of the inspected object is inspected based on the SEM image, a two-dimensional SEM image should be obtained over a certain wide area. As a result, driving the beam deflector 102 to scan electron beams in the direction substantially perpendicular to the movement direction of the stage 105 while the stage 105 is being continuously moved, it is necessary to detect a two-dimensional secondary electron image signal by the secondary electron detector 104. Specifically, while the stage 105 is being continuously moved in the X direction, for example, the beam deflector 102 is moved to scan electron beams in the Y direction substantially perpendicular to the movement direction of the stage 105, and then the stage 105 is moved in a stepwise fashion in the Y direction. Thereafter, while the stage 105 is being continuously moved in the X direction, the beam deflector 102 is driven to scan electron beams in the Y direction substantially perpendicular to the movement direction of the stage 105, and a two-dimensional secondary electron image signal has to be detected by the secondary electron detector 104. The processes of (1) continuous movement of the stage, (2) beam scanning, (3) optical height detection, (4) focus control and/or deflection direction and width correction, and (5) secondary electron image acquisition should be executed simultaneously. In this way, the acquired SEM image is kept focused and distortion-corrected while the image is being acquired continuously and speedily. By this control, fast and high-sensitivity defect detection can be achieved. Then, the image processing circuit 124 compares corresponding images or repetitive patterns by comparing an electron beam image delayed by the image memory and an image directly inputted from the A/D converter 124, thereby resulting in the comparison inspection being realized. The entirety control unit 120 receives the inspected result at the same time it controls the image processing circuit 124, and then displays the inspected result on the display 143 or stores the same in the memory 142. Incidentally, in the embodiment shown in FIG. 56, while a focus is adjusted by controlling a control current flowing to the objective lens 103 having an excellent responsiveness, the present invention is not limited thereto, and the stage 105 may be elevated and lowered. However, if the focus is adjusted by elevating and lowering the stage 105, then responsiveness is deteriorated.

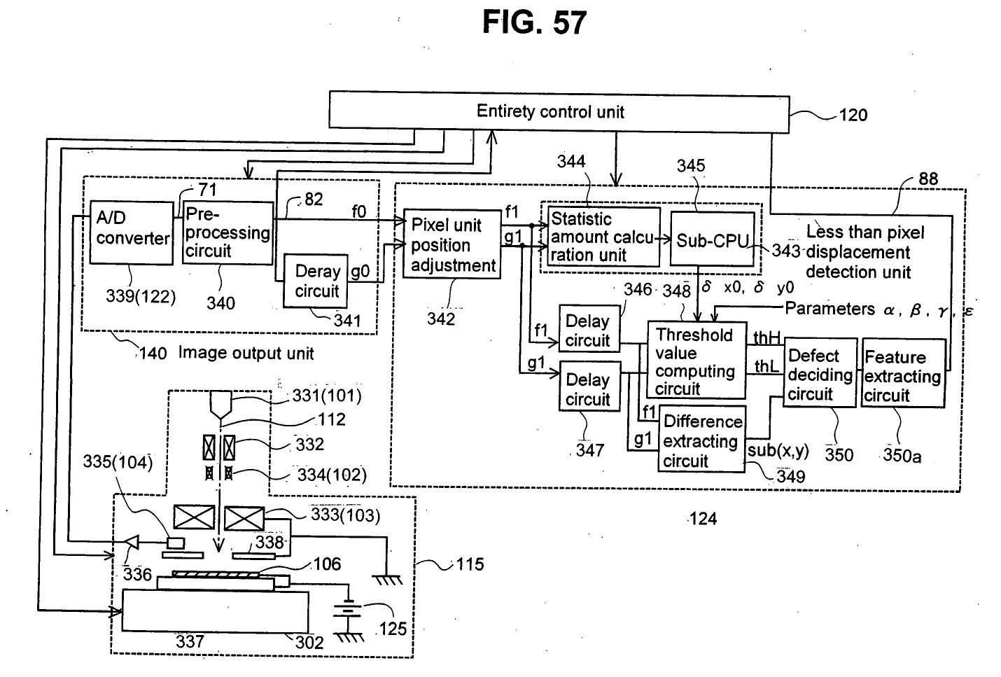

Further, the appearance inspection apparatus using an SEM image will be described with reference to FIGS. 57 to 62. FIG. 57 shows the appearance inspection apparatus using an SEM image according to an embodiment of the present invention. In this embodiment, an electron beam 112 scans the inspected object 106 such as a wafer and electrons generated from the inspected object 106 are detected by the irradiation of electron beams. Then, an electronic beam image at the scanning portion is obtained on the basis of the change of intensity, and the pattern is inspected by using the electron beam image.

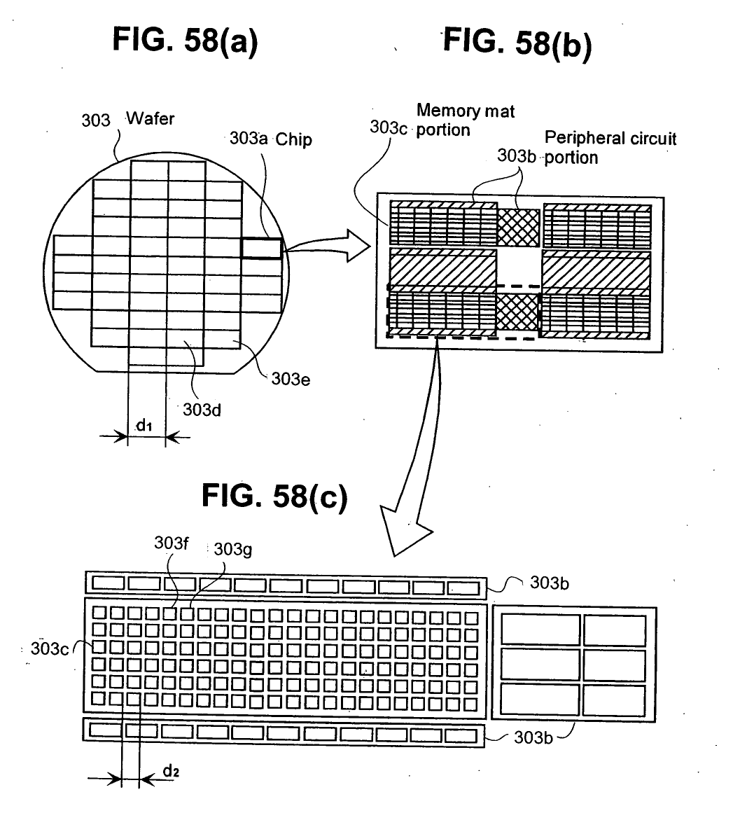

As the inspected object 106, there is the semiconductor wafer 303 as shown in FIGS. 58(a)-58(c), for example. On this semiconductor wafer 3, there are arrayed a number of chips 3a which form the same product finally as shown in FIG. 58(a). An inside pattern layout of the chip 303a comprises a memory mat portion 303c in which memory cells are regularly arranged at the same pitch in a two-dimensional fashion and a peripheral circuit portion 303b as shown by an enlarged view in FIG. 58(b). When the present invention is applied to the inspection of the pattern of this semiconductor wafer 303, a detected image at a certain chip (e.g. chip 303d) is memorized in advance, and then compared with a detected image of another chip (e.g., 303e) (hereinafter referred to as “chip comparison”). Alternatively, a detected image at a certain memory cell (e.g. memory cell 303f) is memorized in advance, and then compared with a detected image of other cell (e.g. cell 303g) (hereinafter referred to as “cell comparison”) as shown in FIG. 58(c), thereby resulting in a defect being recognized.

If the repetitive patterns (chips or cells of the semiconductor wafer, by way of example) of the inspected object 106 are equal to each other strictly and if equal detected images are obtained, then only defects cannot agree with each other when images are compared with each other. Thus, it is possible to recognize a defect.

However, in actual practice, a disagreement between images exists in the normal portion. As a disagreement at the normal portion, there are a disagreement caused by the inspected object, and a disagreement caused by the image detection system. The disagreement caused by the inspected object is based on a subtle difference caused between the repetitive patterns by a wafer manufacturing process such as exposure, development or etching. This disagreement appears as a subtle difference of pattern shape and a difference of gradation value. The disagreement caused by the image detection system is based on a fluctuation of a quantity of illumination light, a vibration of stage, various electrical noises, and a disagreement between detection positions of two images or the like. These disagreements appear as a difference of gradation value of a partial image, a distortion of pattern, and a positional displacement of an image on the detected image.

In the embodiment according to the present invention, a detection image (first two-dimensional image) in which gradation values of coordinates (x, y) aligned at the pixel unit are f1(x, y) and a compared image (second two-dimensional image) in which gradation values of coordinates (x, y) are g1(x, y) are compared with each other, a threshold value (allowance value) used when a defect is determined is set at every pixel considering the positional displacement of pattern and a difference between the gradation values, and a defect is determined on the basis of a threshold value (allowance value set at every pixel.

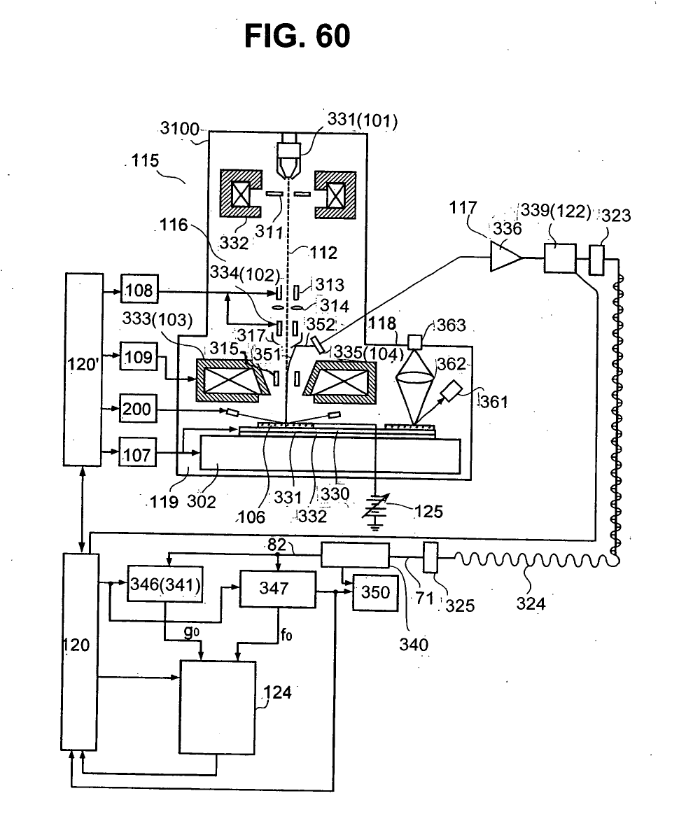

A pattern inspection system according to the present invention comprises, as shown in FIGS. 57 and 60, a detection unit 115, an image output unit 140, an image processing unit 124 and an entirety control unit 120 for controlling the entire system. Incidentally, the present pattern inspection system includes an inspection chamber 2100 whose inside is vacated and exhausted by vacuum and a reserve chamber (not shown) for inserting and ejecting the inspected object 106 into and from the inspection chamber 2100. This reserve chamber can be vacated and exhausted by vacuum independently of the inspection chamber 2100.

Initially, the inspection unit 115 will be described with reference to FIGS. 57 and 60. Specifically, the inside of the inspection chamber 2100 in the detection unit 115 generally comprises, as shown in FIG. 60, an electron optical system 116, an electron detection unit 117, a sample chamber 119, and an optical microscope unit 118. The electron optical system 116 comprises an electron gun 331 (101), an electron beam deriving electrode 11, a condenser lens 332, a blanking deflector 313, a scanning deflector 334 (102), an iris 314, an objective lens 333 (103), a reflecting plate 317, an ExB deflector 315, and a Faraday cup (not shown) for detecting a beam current. The reflecting plate 317 is shaped as a circular cone in order to achieve a secondary electron amplification effect.

Of the electron detection unit 117, the electron detector 335 (104) for detecting electrons such as secondary electrons or reflection electrons is installed above the objective lens 333 (103), for example, within the inspection chamber 2100. An output signal from the electron detector 335 is amplified by an amplifier 336 installed outside the inspection chamber 2100.

The sample chamber 119 comprises a sample holder 330, an X stage 331 and a Y stage 332 previously referred to as stage 105, a position monitoring length measuring device 107 and a height measuring apparatus 200 such as an inspected based plate height measuring device. Incidentally, there may be provided a rotary stage on the stage.

The position monitoring length measuring device 107 monitors a position such as the stages 331, 332 (stage 105), and transfers a monitored result to the entirety control unit 120. The driving systems of the stages 331, 332 also are controlled by the entirety control unit 120. As a result, the entirety control unit 120 is able to precisely understand the area and the position irradiated with electron beams 112 on the basis of such data.

The inspected base plate height measuring device is adapted to measure the height of the inspected object 106 resting on the stages 331, 332. Then, a focal length of the objective lens 333 (103) for converging the electron beam 112 is dynamically corrected on the basis of measured data measured by the inspected base plate height measuring device 200 so that electron beams can be irradiated under the condition that electron beams are constantly properly-focused on the inspected area. Incidentally, in FIG. 60, although the height measuring apparatus 200 is installed within the inspection chamber 2100, the present invention is not limited thereto, and there may used a system in which the height measuring device is installed outside the inspection chamber 2100 and light is projected into the inside of the inspection chamber 2100 through a glass window or the like.

The optical microscope unit 118 is located at the position near the electron optical system 116 within the room of the inspection chamber 2100 and which position is distant to the extent that the optical microscope unit and the electron optical system cannot affect each other. A distance between the electron optical system 116 and the optical microscope unit 118 should naturally be a known value. Then, the X stage 331 or the Y stage 332 is reciprocally moved between the electron optical system 116 and the optical microscope unit 118. The optical microscope unit 118 comprises a light source 361, an optical lens 362, and a CCD-camera 363. The optical microscope unit 118 detects the inspected object 106, e.g. an optical image of a circuit pattern formed on the semiconductor wafer 303, calculates a rotation displacement amount of circuit patterns based on the optical image thus detected, and transmits the rotation displacement amount thus calculated to the entirety control unit 120. Then, the entirety control unit 120 becomes able to correct this rotation displacement amount by rotating a rotating stage forming a part of stage 302 (105) which includes stages 331 and 332, for example. Also, the entirety control unit 120 sends this rotation displacement amount to a correction control circuit 120′, and the correction control circuit 120′ becomes able to correct the rotation displacement by correcting the scanning deflection position of electron beams caused by the scanning deflector 334, for example, on the basis of this rotation displacement amount. Moreover, the optical microscope unit 118 detects the inspected object 106, e.g. the optical image of the circuit pattern formed on the semiconductor wafer 303, observes this optical image, for example, displayed on the monitor 350, and sets the inspection area on the entirety control unit 120 by entering the coordinates of the inspection area into the entirety control unit 120 by using an input based on the optical image thus observed. Furthermore, the pitch between the chips on the circuit pattern formed on the semiconductor wafer 303, for example, or the repetitive pitch of the repetitive pattern such as the memory cell can be measured in advance and can be inputted to the entirety control unit 120. Incidentally, while the optical microscope unit 118 is located within the inspection chamber 2100 in FIG. 60, the present invention is not limited thereto, and the optical microscope unit may be located outside the inspection chamber 2100 to thereby detect the optical image of the semiconductor wafer 303 through a glass window or the like.

As shown in FIGS. 57 and 60, the electron beam emitted from the electron gun 331 (101) travels through the condenser lens 332 and the objective lens 333 (103) and is converged to a beam diameter of about pixel size on the sample surface. In that case, a negative potential is applied to the sample by the ground electrode 338 (118) and the retarding electrode 337 and the electron beam between the objective lens 333 (103) and the inspected object (sample) 106 is decelerated, whereby a resolution can be improved in a low acceleration voltage area. When irradiated with electron beams, the inspected object (wafer 303) 106 generates electrons. The scanning deflector 334 (102) scans repeatedly electron beams in the X direction and electrons generated from the inspected object 106 in synchronism with the continuous movement of the inspected object (sample) 106 in the X direction by the stage 302 (105) are detected, thereby obtaining a two-dimensional electron beam image of the inspected object. The electrons generated from the inspected object are detected by the detector 335 (104), and amplified by the amplifier 336. In order to make the high-speed scanning possible, an electrostatic deflector of which deflection speed is high should preferably be used as the deflector 334 (102) for repeatedly scanning electron beams in the X direction. Moreover, a thermal electric field radiation type electron gun should preferably be used as the electron gun 331 (101) because it can reduce the irradiation time by increasing the electron beam current. Further, a semiconductor detector which can be driven at a high speed should preferably be used as the detector 335 (104).

Next, the image output unit 140 will be described with reference to FIGS. 57, 60, and 61. Specifically, an electron detection signal detected by the electron detector 335 (104) in the electron detection unit 117 is amplified by the amplifier 336, and then converted by the A/D converter 339 (122) into digital image data (gradation image data). Then, the output from the A/D converter 339 (122) is transmitted by an optical converter (light-emitting element) 323, a transmission device (optical fiber cable) 324, and an electric converter (light-receiving device) 325. According to this arrangement, the transmission device 324 may have the same transmission speed as the clock frequency of the A/D converter 339 (122). The output from the A/D converter 339 is converted by the optical converter (light-emitting element) 323 into an optical digital signal, optically transmitted by the transmission device (optical fiber cable) 324 and then converted by the electric converter (light-receiver) 325 into digital image data (gradation image data. The reason that the output signal is converted into the optical signal and then transmitted is that, in order to supply electrons 352 from the reflection plate 317 into the semiconductor detector 335 (104), constituents (semiconductor detector 335, amplifier 336, A/D converter 339, and optical converter (light-emitting element) 323 from the semiconductor detector 335 to the optical converter 323 should be floated at a positive high potential by a high-voltage power supply source (not shown). More precisely, only the semiconductor detector 335 need be floated to the positive high potential. However, the amplifier 336 and the A/D converter 339 should preferably be located near the semiconductor detector in order to prevent noise from being mixed and a signal from being deteriorated. It is difficult to maintain only the semiconductor detector 335 at the positive high voltage, and hence all of the above-mentioned constituents should be held at the high voltage. Specifically, since the transmission device (optical fiber cable) 324 is made of a high insulating material, after the image signal which is held at the positive high potential level in the optical converter (light-emitting element) 323 is passed through the transmission device (optical fiber cable) 324, the electric converter (light-receiver) 325 outputs an image signal of earth level.

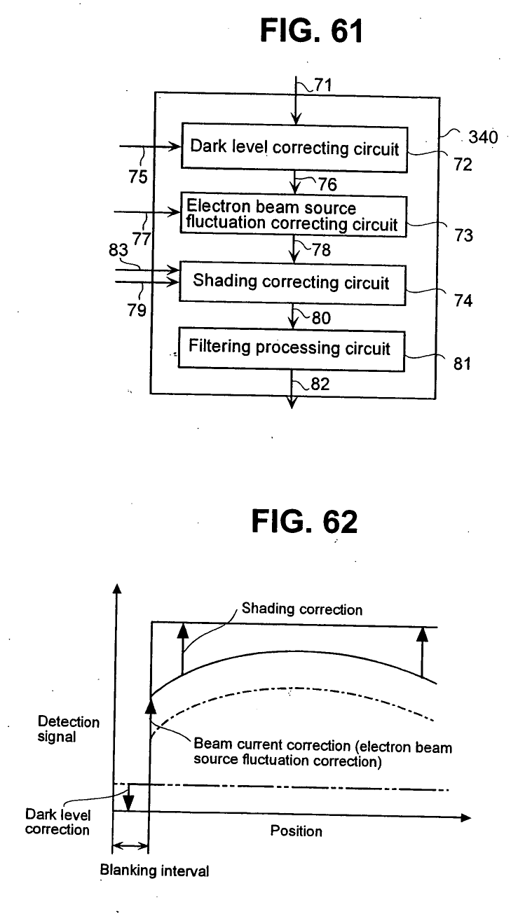

The pre-processing circuit (image correcting circuit) 340 comprises, as shown in FIG. 61, a dark level correcting circuit 72, an electron beam source fluctuation correcting circuit 73, a shading correcting circuit 74 and the like. Digital image data (gradation image data) 71 obtained from the electric converter (light-receiving element) 325 is supplied to the pre-processing circuit (image correcting circuit) 340, in which it is image-corrected such as a dark level correction, an electron beam source fluctuation correction or a shading correction. In the dark level correction in the dark level correcting circuit 72, as shown in FIG. 62, a dark level is corrected on the basis of a detection signal 71 in a beam blanking period extracted based on a scanning line synchronizing signal 75 obtained from the entirety control unit 120. Specifically, the reference signal for correcting the dark level sets an average of a gradation value of a specific number of pixels in a particular position during the beam blanking period to the dark level, and updates the dark level at every scanning line. As described above, in the dark level correcting circuit 72, the detection signal detected during the beam blanking period is dark-level-corrected to the reference signal which is updated at every line. When the electron beam source fluctuation is corrected by the electron beam source fluctuation correcting circuit 73, as shown in FIG. 62, a detection signal 76 of which the dark level is corrected is normalized by a beam current 77 monitored by the Faraday cup (not shown) which detects the above-mentioned beam current at a correction cycle (e.g. line unit of 100 kHz). Since the fluctuation of the electron beam source is not rapid, it is possible to use a beam current that was detected one to several lines before. When a shading is corrected by the shading correcting circuit 74, as shown in FIG. 62, the fluctuation of the quantity of light caused in a detection signal 78 in which the electron beam source fluctuation was corrected at the beam scanning position 79 obtained from the entirety control unit 120 is corrected. Specifically, the shading correction executes the correction (normalization) at every pixel on the basis of reference brightness data 83 which is previously detected. The shading correction reference data 83 is previously detected, the detected image data is temporarily stored in an image memory, the image data thus stored is transmitted to a computer disposed within the entirety control unit 120 or a high-order computer connected to the entirety control unit 120 through a network, and processed by software in the computer disposed within the entirety control unit 120 or the high-order computer connected through the network to the entirety control unit 120, thereby resulting in the shading correction reference data being created. Moreover, the shading correction reference data 83 is calculated in advance and held by the high-order computer connected to the entirety control unit 120 through the network. When the inspection is started, the data is downloaded, and this downloaded data may be latched in a CPU in the shading correcting circuit 74. To cope with a full visual field width, the shading correcting circuit 74 includes two correction memories having pixel number (e.g. 1024 pixels) of an amplitude of an ordinary electron beam, and the memories are switched during a time (time from the end of one visual field inspection to the start of the next one visual field inspection) outside the inspection area. The correction data may have pixel number (e.g. 5000 pixels) of a maximum amplitude of an electron beam, and the CPU may rewritten such data in each correction memory till the end of the next one visual field inspection.

As described above, after the dark level correction (dark level is corrected on the basis of the detection signal 71 during the beam blanking period), the electron beam current fluctuation correction (beam current intensity is monitored and a signal is normalized by a beam current) and the shading correction (fluctuation of quantity of light at the beam scanning position is corrected) are effected on the digital image data (gradation image data) 71 obtained from the electric converter (light-receiving element) 325, the filtering processing is effected on the corrected digital image data (gradation image data) 80 by a Gaussian filter, a mean value filter or an edge-emphasizing filter in the filtering processing circuit 81, thereby resulting a digital image signal 82 with an image quality being improved. If necessary, a distortion of an image is corrected. These pre-processings are executed in order to convert a detected image so as to become advantageous in the later defect judgment processing.

Although the delay circuit 341 formed of a shift register or the like delays the digital image signal 82 (gradation image signal) with an improved image quality from the pre-processing circuit 340 by a constant time, if a delay time is obtained from the entirety control unit 120 and set to a time during which the stage 302 is moved by a chip pitch amount (d1 in FIG. 58(a)), then a delayed signal g0 and a signal f0 which is not delayed become image signals obtained at the same position of the adjacent chips, thereby resulting in the aforementioned chip comparison inspection being realized. Alternatively, if the delay time is obtained from the entirety control unit 120 and set to a time during which the stage 302 is moved by a pitch amount (d2 in FIG. 58(c)) of the memory cell, then the delayed signal g0 and the signal f0 which is not delayed become image signals obtained at the same position of the adjacent memory cells, thereby resulting in the aforementioned cell comparison inspection being realized. As described above, the delay circuit 341 is able to select an arbitrary delay time by controlling a read-out pixel position based on information obtained from the entirety control unit 120. As described above, compared digital image signals (gradation image signals) f0 and g0 are outputted from the image output unit 140. Hereinafter, f0 will be referred to as a detection image and g0 will be referred to as a comparison image. Incidentally, as shown in FIG. 60, the comparison image signal f0 may be stored in a first image memory unit 346 composed of a shift register and an image memory and the detection image signal f0 may be stored in a second image memory unit 347 composed of a shift register and an image memory. As described above, the first image memory unit 346 may comprise the delay circuit 341, and the second image memory unit 347 is not necessarily required.

Moreover, an electron beam image latched within the pre-processing circuit 340 and the second image memory unit 347 or the like or the optical image detected by the optical microscope unit 118 may be displayed on the monitor and can be observed.

The image processing unit 124 will be described with reference to FIG. 57. The pre-processing circuit 340 outputs a detection image f0(x, y) expressed by a gradation value (light and shade value) with respect to a certain inspection area on the inspected object 106, and the delay circuit 341 outputs a comparison image (standard image:reference image) g0(x, y) expressed by a gradation value (light and shade value) with respect to a certain area on the inspected object 106 which becomes a standard to be compared.

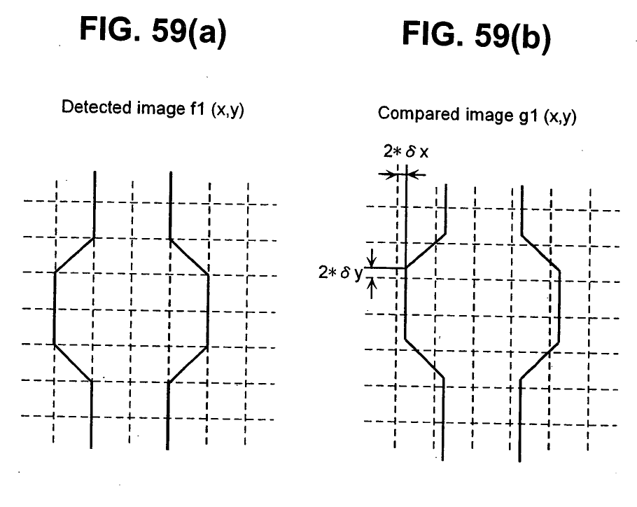

The pixel unit position alignment unit 342 of image processing unit 124 displaces the position of comparison image, for example, in such a manner that the position displacement amount of the comparison image g0(x, y) relative to the above-mentioned detection image f0(x, y) falls in a range of from 0 to 1 pixel, in other words, the position at which a “matching degree” between f0(x, y) and g0(x, y) becomes maximum falls within a range of from 0 to 1 pixel. As a consequence, as shown in FIGS. 59(a) and 59(b), for example, the detection image f0(x, y) and the comparison image g0(x, y) are aligned with an alignment accuracy of less than one pixel. A square portion shown by dotted lines in FIG. 59 denotes a pixel. This pixel is a unit detected by the electron detector 335, sampled by the A/D converter 339 (122) and converted into a digital value (gradation value:light and shade value). That is, the pixel unit denotes a minimum unit detected by the electron detector 335. Incidentally, as the above-mentioned “matching degree,” there may be considered the following equation (expression 1):
max|f0−g0|, ΣΣ|f0−g0|, ΣΣ(f0−g0)2 (expression 1)

max |f0−g0| shows a maximum value of an absolute value of a difference between the detection image f0(x, y) and the comparison image g0(x, y). ΣΣ|f0−g0| shows a total of absolute value of a difference between the detection image f0(x, y) and the comparison image g0(x, y) within the image. ΣΣ|(f0−g0)| shows a value which results from squaring a difference between the detection image f0(x, y) and the comparison image g0(x, y) and integrating the squared result in the x direction and the y direction.

Although the processed content is changed depending upon the adoption of any one of the above-mentioned (expression 1), the case that ΣΣ|f0−g0| is adopted will be described below.

Mx assumes the displacement amount of the comparison image g0(x, y) in the x direction, and my assumes the displacement in the y direction (mx, my are integers). Then, e1(mx, my) and s1(mx, my) are defined by equations of (expression 2) and (expression 3), respectively:
e1(mx,my)=ΣΣ|f0(x,y)−g0(x+mx,y+my) (expression 2)
s1(mx,my)=e1(mx,my)+e1(mx+1,my)+e1(mx,my+1)+e1(mx+1,my+1) (expression 3)

In the expression 2, ΣΣ shows a total within the image. Since what is required to calculate is a value obtained when mx assumes the displacement amount of the x direction in which s1(mx, my) becomes minimum and a value obtained when my assumes the displacement amount of the y direction, by changing mx and my as ±0, 1, 2, 3, 4, . . . n, in other words, by changing the comparison image g0(x, y) with a pixel pitch, there is calculated s1(mx, my) of each time. Then, a value mx0 of mx in which the calculated value becomes minimum and a value my0 of my in which the calculated value becomes minimum are calculated. Incidentally, the maximum displacement amount n of the comparison image should be increased as the positional accuracy is lowered in response to the positional accuracy of the detection unit 115. The pixel unit position alignment unit 342 outputs the detection image f0(x, y) at it is, and outputs the comparison image g0(x, y) with a displacement of (mx0, my0). That is, f1(x, y)=f0(x, y), g1(x, y)=g0(x+mx0, y+my0).

A positional displacement detection unit (not shown) for detecting a positional displacement of less than a pixel divides the images f1(x, y), g(x, y) aligned at the pixel unit into small areas (e.g. partial images composed of 128*256 pixels), and calculates positional displacement amounts (positional displacement amounts become real number of 0 to 1) of less than the pixel at every divided area (partial image). The reason that the images are divided into small areas is in order to cope with a distortion of an image, and hence should be set to a small area to the extent that a distortion can be neglected. As a measure for measuring a matching degree, there are the selection branches shown in the expression 1. An example is shown in which the third “sum of squares of difference” (ΣΣ(f0−g0)2) is adopted.

Let it be assumed that an intermediate position between f1(x, y) and g1(x, y) is held at the positional displacement amount 0 and that, as shown in FIG. 59, f1 is displaced y−δx in the x direction, f1 is displaced by −δy in the by direction, g1 is displaced by +δx in the x direction, and that g1 is displaced by +δy in the y direction. That is, the displacement amounts of f1 and g1 are 2*δx in the x direction and 2*δy in the y direction. Since δx, δy are not integers, in order to displace f1 and g1 by δx, δy, it is necessary to define a value between the pixels. An image f2 in which f1 is displaced by +δx in the x direction and by +δy in the y direction and an image g2 in which g1 is displaced by −δx in the x direction and by −δy in the y direction are defined as the following equations of (expression 4) and (expression 5):
f2(x,y)=f1(x+δx,y+δy)=f1(x,y)+δx(f1(x+1,y)−f1(x,y))+δy(f1(x,y+1)−f1(x,y)) (expression 4)
g2(x,y)=g1(x−δx,y−δy)=g1(x,y)+δx(g1(x−1,y)−g1(x,y))+δy(g1(x,y−1)−g1(x,y)) (expression 5)

The expression 4 and the expression 5 are what might be called linear interpolations. A matching degree e2(δx, δy) of f2 and g2 is represented by the following equation of (expression 6) if “sum of squares of difference” is adopted.
e2(δx, δy)=ΣΣ(f2(x,y)−g2(x,y))2 (expression 6)

ΣΣ denotes a total within small areas (partial images). The object of the positional displacement detection unit (not shown) for detecting a positional displacement of less than the pixel unit is to obtain a value δx0 of δx and a value δy0 of δy in which e2(δx, δy) takes the minimum value. To this end, an equation which results from partially differentiating the above-mentioned expression 6 by δx, δy is set to 0 and may be solved. The results are obtained as shown by the following equations of (expression 7) and (expression 8):
δx={(ΣΣC0*Cy)*(ΣΣCx*Cy)ΣΣC0*Cx)*(ΣΣCy*Cy)}/{(ΣΣCx*Cx)*(ΣΣCy*Cy)−(ΣΣCx*Cy)*(ΣΣCx*Cy)} (expression 7)
δx={(ΣΣC0*Cx)*(ΣΣCx*Cy)ΣΣC0*Cy)*(ΣΣCx*Cx)}/{(ΣΣCx*Cx)*(ΣΣCy*Cy)−(ΣΣCx*Cy)*(ΣΣCx*Cy)} (expression 8)

However, respective ones of C0, Cx, Cy establish relationships shown by the following equations of (expression 9), (expression 10) and (expression 11):
C0=f1(x,y)−g1(x,y) (expression 9)
Cx={f1(x+1,y)−f1(x,y)}−{g1(x−1,y)−g1(x,y)} (expression 10)
Cy={f1(x,y+1)−f1(x,y)}−{g1(x,y−1)−g1(x,y)} (expression 11)

In order to obtain δx0, δy0, respectively, as shown by the (expression 7) and the (expression 8), it is necessary to obtain a variety of statistic amounts ΣΣCk*Ck (Ck=C0, Cx, Cy). The statistic amount calculating unit 344 calculates a variety of statistic amount ΣΣCk*Ck on the basis of the detection image f1(x, y) composed of the gradation value (light and shade value) aligned at the pixel unit obtained from the pixel unit position alignment unit 342 and the comparison image g1(x, y).

The sub-CPU 345 obtains δx0, δy0 by calculating the (expression 7) and the (expression 8) by using the ΣΣCk*Ck which was calculated in the statistic amount calculating unit 344.

The delay circuits 346, 347 formed of the shift register or the like are adapted to delay the image signals f1 and g1 by the time which is required by the less than pixel positional displacement unit (not shown) to calculate δx0, δy0.

The difference image extracting circuit (difference extracting circuit:distance extracting unit) 349 is adapted to obtain a difference image (distance image) sub(x, y) between f1 and g1 having positional displacements 2*δx0, 2*δy0 from a calculation standpoint. This difference image (distance image) sub(x, y) is expressed by the equation of (expression 12) as follows:
sub(x,y)=g1(x,y)−f1(x,y) (expression 12)

The threshold value computing circuit (allowance range computing unit) 348 is adapted to calculate by using the image signals f1, g1 from the delay circuits 346, 347 and the positional displacement amounts δx0, δy0 of less than the pixel obtained from the less than pixel positional displacement detection unit (not shown) two threshold values (allowance values indicative of allowance ranges) thH(x, y) and thL(x, y) which are used by the defect deciding circuit (defect judgment unit) 350 to determine in response to the value of the difference image (distance image) sub(x, y) obtained from the difference image extracting circuit (difference extracting circuit:distance extracting unit) 349 whether or not the inspected object is the nominated defect. ThH(x, y) is the threshold value (allowance value indicative of allowance range) which determines the upper limit of the difference image (distance image) sub(x, y), and thL(x, y) is the threshold value (allowance value indicative of allowance range) which determines the lower limit of the difference image (distance image) sub(x, y). Contents of the computation in the threshold value computing circuit 348 are expressed by the equations of (expression 13) and (expression 14) as follows:
thH(x,y)=A(x,y)+B(x,y)+C(x,y) (expression 13)
thL(x,y)=A(x,y)−B(x,y)−C(x,y) (expression 14)

However, A(x, y) is a term expressed by a relationship of the following equation of (expression 16) and which is used to correct the threshold values by using the less than pixel positional displacement amounts δx0, δy0 in response to the value of the difference image (distance image) sub(x, y) substantially.

Also, B(x, y) is a term expressed by a relationship of the equation of the (expression 16) and which is used to allow a very small positional displacement of a pattern edge (very small difference of pattern shape, pattern distortion also returns to a very small positional displacement of pattern edge from a local standpoint) between the detection image f1 and the comparison image g1.

Also, C(x, y) is a term expressed by a relationship of the equation of (expression 17) and which is used to allow a very small difference of gradation value (light and shade value) between the detection image f1 and the comparison image g1).

$$\begin{matrix}A ( x , y ) = \{ dx 1 ( x , y ) * δ x 0 - dx 2 ( x , y ) * ( - δ x 0 ) \} + \{ dy 1 ( x , y ) * δ y 0 - dy 2 ( x , y ) * ( - δ x 0 ) \} \\ = \{ dx 1 ( x , y ) + dx 2 ( x , y ) \} * δ x 0 + \{ dy 1 ( x , y ) + dy 2 ( x , y ) \} * δ y 0 & ( expression 15 ) \\ B ( x , y ) = \vert \{ dx 1 ( x , y ) * α - dx 2 ( x , y ) * ( - α ) \} \vert + \vert \{ dy 1 ( x , y ) * β - dy 2 ( x , y ) * ( - β ) \} \vert \\ = \vert \{ dx 1 ( x , y ) + dx 2 ( x , y ) * α \vert + \vert \{ dy 1 ( x , y ) + dy 2 ( x , y ) \} * β \vert & ( expression 16 ) \\ C ( x , y ) = ( ( max 1 + max 2 ) / 2 ) * γ + ɛ & ( expression 17 )\end{matrix}$$

where α, β are the real numbers ranging from 0 to 0.5, γ is the real number greater than 0, and ε is the integer greater than 0.

dx1(x, y) is expressed by a relationship of the equation of (expression 18), and indicates a changed amount of a gradation value (light and shade value) with respect to the x direction+1 adjacent image in the detection image f1(x, y).

dy2(x, y) is expressed by a relationship of the equation of (expression 19), and indicates a changed amount of a gradation value (light and shade value) with respect to the x direction−1 adjacent image in the comparison image g1(x, y).

dy1(x, y) is expressed by a relationship of the equation of (expression 20), and indicates a changed amount of a gradation value (light and shade value) with respect to the y direction+1 adjacent image in the detection image f1(x, y).

dy2(x, y) is expressed by a relationship of the equation of (expression 21), and indicates a changed amount of a gradation value (light and shade value) with respect to the y direction−1 adjacent image in the comparison image g1(x, y).
dx1(x,y)=f1(x+1,y)−f1(x,y) (expression 18)
dx2(x,y)=g1(x,y)−g1(x−1,y) (expression 19
dy1(x,y)=f1(x,y+1)−f1(x,y) (expression 20)
dy2(x,y)=g1(x,y)−g1(x,y−1) (expression 21)

max1 is expressed by a relationship of the equation of (expression 22), and indicates maximum gradation values (light and shade values) of x direction+1 adjacent image and y direction+1 adjacent image including itself in the detection image f1(x, y).

max2 is expressed by a relationship of the equation of (expression 23), and indicates maximum gradation values (light and shade values) of x direction−1 adjacent image and y direction−adjacent image including itself in the comparison image g1(x, y).
max1=max{f1(x,y),f1(x+1,y),f1(x,y+1),f(x+1,y+1)} (expression 22)
max2=max{g1(x,y),g1(x−1,y),g1(x,y−1),g(x−1,y−1)} (expression 23)

First, the first term A(x, y) in the equations of (expression 13) and (expression 14) for calculating the threshold values thH(x, y), thL(x, y) will be described. Specifically, the first term A(x, y) in the equations of (expression 13) and (expression 14) for calculating the threshold values thH(x, y) and thL(x, y) is the term used to correct the threshold values in response to the less than pixel positional displacement amounts δx0, δy0 which were calculated by the positional displacement detection unit 343. Since dx1 expressed by (expression 18), for example, is a local changing rate of a gradation value of f1 in the x direction, dx1(x, y)*δx0 expressed by (expression 15) can be regarded as a predicted value of the change of the gradation value (light and shade value) of f1 obtained when the position is shifted by δx0. Therefore, the first term {dx1(x, y)*δx0−dx2(x, y)*(−δx0)} can be regarded as a value which predict at every pixel a changing rate of a gradation value (light and shade value) of the difference image (distance image) of f1 and g1 obtained when the position of f1 is displaced by δx0 in the x direction and the position of g1 is displaced by −δx0 in the x direction. Similarly, the second term can be regarded as the value which predicts a changing rate with respect to the y direction. Specifically, {dx1(x, y)+dx2(x, y)}*δx0 is a value which can predict a changing rate of a gradation value (light and shade value of difference image (distance image) of f1 and g1 in the x direction by multiplying a local changing rate {dx1(x, y)+dx2(x, y)} of the difference image (distance image) between the detection image f1 and the comparison image g1 in the x direction with the positional displacement δx0. Also, {dy1(x, y)+dy2(x, y)}*δy0 is a value which predicts at every pixel a changing rate of a gradation value (light and shade value) of the difference image (distance image) of f1 and g1 by multiplying a local changing rate {dy1(x, y)+dy2(x, y) of the difference image (distance image) between the detection image f1 and the comparison image g1 in the y direction with the positional displacement δy0.

As described above, the first term A)x, y) in the threshold values thH(x, y) and thL(x, y) is the term used to cancel the known positional displacements δx0, δy0.

The second term B(x, y) in the equations of (expression 13) and (expression 14) for calculating the threshold values thH(x, y) and thL(x, y) will be described. Specifically, the second term B(x, y) in the equations of (expression 13) and (expression 14) for calculating the threshold values thH(x, y) and thL(x, y) is the term used to allow a very small positional displacement of pattern edge (very small difference of pattern shape and pattern distortion also are returned to very small positional displacements of pattern edge from a local standpoint). As will be clear from the comparison of the (expression 15) for calculating A(x, y) and the (expression 16) for calculating B(x, y), B(x, y) is an absolute value of a change prediction of a gradation value (light and shade value) of the difference image (distance image) brought about by the positional displacements α, β. If the positional displacement is canceled by A(x, y), then the addition of B(x, y) to A(x, y) means that the position aligned state is further displaced by α in the x direction and by β in the y direction considering a very small positional displacement of pattern edge caused by a very small difference based on the pattern shape and the pattern distortion. That is, +B(x, y) expressed by the equation of (expression 13) is to allow the positional displacement of +α in the x direction and the positional displacement of +β in the y direction as the very small positional displacements of the pattern edge caused by the very small differences based on the pattern shape and the pattern distortion. Further, the subtraction of B(x, y) from A(x, y) in the equation of (expression 14) means that the positional aligned state is positionally displaced by −α in the x direction and by −β in the y direction. −B(x, y) expressed by the equation of (expression 14) is adapted to allow the positional displacement of −α in the x direction and −β in the y direction. As shown by the equations of (expression 13) and (expression 14), if the threshold value includes the upper limit thH(x, y) and the lower limit thL(x, y), then it is possible to allow the positional displacements of ±α, ±β. Then, if the threshold value computing circuit 348 sets the values of the inputted parameters α, β to proper values, then it becomes possible to freely control the allowable positional displacement amounts (very small positional displacement amounts of pattern edge) caused by the very small difference based on the pattern shape and the pattern distortion.

Next, the third term C(x, y) in the equations of (expression 13) and (expression 14) for calculating the threshold values thH(x, y) and thL(x, y) will be described. The third term C(x, y) in the equations of (expression 13) and (expression 14) for calculating the threshold values thH(x, y) and thL(x, y) is a term used to allow a very small difference of a gradation value (light and shade value) between the detection image f1 and the comparison image g1. As shown by the equation of (expression 13), the addition of C(x, y) means that the gradation value (light and shade value) of the comparison image g1 is larger than the gradation value (light and shade value) of the detection image f1 by C(x, y). As shown by the equation of (expression 14), the subtraction of C(x, y) means that the gradation value (light and shade value) of the comparison value g1 is smaller than the gradation value (light and shade value) of the detection image by C(x, y). While C(x, y) is a sum of a value which results from multiplying a representing value (max value) of a gradation value at the local area with the proportional constant γ and the constant ε as shown by the equation of (expression 17), the present invention is not limited to the above-mentioned function. If the manner in which the gradation value is fluctuated is already known, then it is possible to use a function which can cope with such manner. For example, if it is clear that a fluctuation width is proportional to a square root of a gradation value, then the equation of (expression 17) should be replaced with C(x, y)=(square root of (max1+max2))*γ+ε. Thus, the threshold value computing circuit 348 becomes able to freely control a difference of allowable gradation value (light and shade value) by the inputted parameters γ, ε similarly to B(x, y).

Specifically, the threshold value computing circuit (allowable range computing unit) 348 includes a computing circuit for computing {dx1(x, y)+dx2(x, y)} by the equations of (expression 18) and (expression 19) based on the detection image f1(x, y) composed of a gradation value (light and shade value) inputted from the delay circuit 346 and the comparison image g1(x, y) composed of a gradation value (light and shade value) inputted from the delay circuit 347, a computing circuit for computing {dy1(x, y)+dy2(x, y)} by the equations of (expression 20) and (expression 21) and a computing circuit for computing (max1+max2) by the equations of (expression 22) and (expression 23). Further, the threshold value computing circuit 348 includes a computing circuit for computing ({dx1(x, y)+dx2(x, y)}*δx0±|{dx1(x, y)+dx2(x, y)}|*α) which is a part of (expression 15) and a part of (expression 16) on the basis of {dx1(x, y)+dx2(x, y)} obtained from the computing circuit, δx0 obtained from the less than pixel displacement detection unit 343 and the inputted a parameter, a computing circuit for computing (dy1(x, y)+dy2(x, y))*δy0±|{dy1(x, y)+dy2(x, y)}|*β) which is a part of (expression 15) and a part of (expression 16) on the basis of {dy1(x, y)+dy2(x, y)} obtained from the computing circuit, δy0 obtained from the less than pixel displacement detection unit 343 and the inputted β parameter and a computing circuit for computing ((max1+max2)/2)*γ+ε) in accordance with the equation of (expression 17), for example, on the basis of (max1+max2) obtained from the computing circuit and the inputted γ, ε parameters. Further, the threshold value computing circuit 348 includes an adding circuit for positively adding ({dx1(x, y)+dx2(x, y)}*δx0+|{dx1(x, y)+dx2(x, y)}|*α), ({dy1(x, y)+dy2(x, y)}*δy0+|{dy1(x, y)+dy2(x, y)}|*β) obtained from the computing circuit and ((max1+max2)/2)*γ+ε) obtained from the computing circuit to output the threshold value thH(x, y) of the upper limit, a subtracting circuit for negatively computing (((max1+max2)/2)*γ+ε) obtained from the computing circuit and an adding circuit for positively computing ({dx1(x, y)+dx2(x, y)}*δx0−|{dx1(x, y)+dx2(x, y)|*α} obtained from the computing circuit, ({dy1(x, y)+dy2(x, y)}*δy0−|{dy1(x, y)+dy2(x, y)}|*β) obtained from the computing circuit and −((max1+max2)/2*γ+ε) obtained from the subtracting circuit to output the threshold value thL(x, y) of the lower limit.

Incidentally, the threshold value computing circuit 348 may be realized by a CPU by software processing. Further, the parameters α, β, γ, ε inputted to the threshold value computing circuit 348 may be entered by an input means (e.g. keyboard, recording medium, network or the like) disposed in the entirety control unit 120.

The defect deciding circuit (defect judgment unit) 350 decides by using the difference image (distance image) sub(x, y) obtained from the difference image extracting circuit (difference extracting circuit) 349, the threshold value of the lower limit (allowable value indicating the allowable range of lower limit) thL(x, y) obtained from the threshold value computing circuit 348 and the threshold value of the upper limit (allowable value indicating the allowable range of upper limit) thH(x, y) that the pixel at the position (x, y) is a non-defect nominated pixel of the following equation of (expression 24) is satisfied and that the pixel at the position (x, y) is a defect nominated pixel if it is not satisfied. The defect deciding circuit 350 outputs def(x, y) which takes a value of 0, for example, with respect to the non-defect nominated pixel and which takes a value greater than 1, for example, the defect-nominated pixel indicating a disagreement amount.
thL(x,y)≦sub(x,y)≦thH(x,y) (expression 24)

The feature extracting circuit 350a executes a noise elimination processing (e.g. contracts/expands def(x, y). When all of 3×3 pixels are not simultaneously the defect-nominated pixels, the center pixel is set to 0 (non-defect nominated pixel), for example, and eliminated by a contraction processing, and is returned to the original one by an expansion processing. After a noise-like output (e.g. all 3×3 pixels are not simultaneously the defect-nominated pixels) is deleted, there is executed a defect-nominated pixel merge processing in which nearby defect-nominated pixels are collected into one. Thereafter, barycentric coordinates and XY projection lengths (maximum lengths in the x direction and the y direction) are demonstrated at the above-mentioned unit. Incidentally, the feature extracting circuit 350a calculates a feature amount 88 such as a square root of (square of X projection length+square of Y projection length) or an area, and outputs the calculated result.

As described above, the image processing unit 124 controlled by the entirety control unit 120 outputs the feature amount (e.g. barycentric coordinates, XY projection lengths, area, etc.) of the defect-nominated portion in response to coordinates on the inspected object (sample) 106 which is detected with the irradiation of electron beams by the electron detector 335 (104).

The entirety control unit 120 converts position coordinates of the defect-nominated portion on the detected image into the coordinate system on the inspected object (sample) 106, deletes a pseudo-defect, and finally forms defect data composed of the position on the inspected object (sample) 106 and the feature amount calculated from the feature extracting circuit 350a of the image processing unit 124.

According to the embodiment of the present invention, since the whole positional displacement of the small areas (partial images), the very small positional displacements of individual pattern edges and the very small differences of gradation values (light and shade values) are allowed, the normal portion can be prevented from being inadvertently recognized as the defect. Moreover, by setting the parameters α, β, γ, ε to proper values, it becomes possible to easily control the positional displacement and the allowance amount of the fluctuation of the gradation values.

Further, according to the embodiment of the present invention, since an image which is position-aligned by the interpolation in a pseudo-fashion, an image can be prevented from being affected by a smoothing effect which is unavoidable in the interpolation. There is then the advantage that the present invention is advantageous in detecting a very small defect portion. In actual practice, according to the experiments done by the inventors of the present invention, having compared the result in which the defect is decided by calculating the threshold value allowing the positional displacement and the fluctuation of the gradation value similarly to this embodiment after an image which is position-aligned by the interpolation in a pseudo-fashion by using the result of the positional displacement detection of less than pixel and the result obtained by the defect judgment according to this embodiment, the defect detection efficiency can be improved by greater than 5% according to the embodiment of the present invention.

The arrangement for preventing the electron beam image in the aforementioned electron beam apparatus (observation SEM apparatus, length-measuring SEM apparatus) from being deteriorated will be described further. Specifically, the quality of the electron beam image is deteriorated by the image distortion caused by the deflection and the aberration of the electron optical system and by the resolution lowered by the de-focusing. The arrangement for preventing the image quality from being deteriorated is comprised of the height detection apparatus 200 composed of the height detection optical apparatus 200a and the height calculating unit 200b, the focus control apparatus 109, the deflection signal generating apparatus 108, and the entirety control apparatus 120.

FIGS. 63 and 64(a)-64(b) show the height detection optical apparatus 200a according to a first embodiment of the present invention. Specifically, the height detection optical apparatus 200a according to the present invention comprises an illumination optical system formed of a light source 201, a mask 203 in which the same pattern irradiated with light from the light source 201, e.g. the pattern composed of repetitive (repeated) rectangular patterns, a projection stop 211, a polarizing filter 240 for emitting S-polarized light and a projection lens 210 and which illuminates the multi-slit shaped pattern with the S-polarized light at an angle (θ=greater than 60 degrees) vertically inclined from the sample surface 106 by an angle θ and a detection optical system composed of a detection lens 215 for focusing regularly-reflected light from the sample surface 106 on the light-receiving surface of a line image sensor 214, a cylindrical lens 213 and a detection lens 216 for converging the longitudinal direction of the multi-slit shaped pattern on the light-receiving pixels of the line image sensor 214 and the line image sensor and which is used to detect a height of the sample surface 106 from the shift amount of the multi-slit image detected by the line image sensor 214.

Light emitted from the light source 201 irradiates the mask 203 on which there is drawn the multi-slit shaped pattern which results from repeating the rectangular-shaped pattern, for example. As a result, the multi-slit-shaped pattern is projected by the projection lens 210 onto the height measuring position 217 on the sample surface 106. The multi-slit-shaped pattern drawn on the mask 203 is not limited to the slit-shaped pattern, and may be shaped as any shape such as an ellipse or a square so long as it is formed by the repetition of the same pattern. Generally, it can be a pattern that comprises a row of patterns with different shapes. Moreover, the spacing between the neighboring patterns can be different from each other. What is essential, as will be described later in detail using FIG. 64, is that by averaging the multiple height estimations computed from the movements of the multiple patterns, a more precise height estimation can be obtained. Therefore, hereinafter, the word “multi-slit-shaped pattern” or “luminous flux of repetitive light pattern” defines a pattern which comprises multiple arranged patterns with either different shapes or the same shape, whose spacing between the neighboring patterns are either different or the same. The multi-slit-shaped pattern projected onto the sample surface 106 is focused by the detection lens 215 on the line image sensor 214 such as a CCD. Assuming that m is the magnification of this detection optical system, then when the height of the sample surface 106 is changed by z, the multi-slit image is shifted by 2z·sin θ·m on the whole. By using this fact, it is possible to detect the height of the sample surface 106 from the shift amount of the multi-slit image obtained based on the signal received by the line image sensor 214.

Reference numeral 110 denotes the optical axis of the upper observation system, i.e. the height detection position. Specifically, when the above-mentioned height detection apparatus is used as an auto focus height sensor, reference numeral 110 becomes the optical axis of the upper observation system. Incidentally, assuming that p is the pitch of the multi-slit-shaped pattern of the projected image of the projection lens 210, then the pitch of the pattern projected onto the sample surface 106 becomes p/cos θ, and the pitch of the pattern on the image sensor 214 becomes pm. Also, assuming that m′ is the magnification of the illumination projection system, then the pitch of the pattern on the mask 203 becomes p/m′. That is, the pitch of the multi-slit-shaped pattern formed on the mask 203 becomes p/m′.

As shown in FIGS. 64(a), 64(b), when a height is detected on the sample 106 at its boundaries having different reflectances, an intensity distribution of a signal detected on the line image sensor 214 is affected by a reflectance distribution of a sample. However, if the multi-slit-shaped pattern is as thin as possible so long as a clear image can be maintained within a height detection range, then it is possible to suppress a detection error caused by a reflectance distribution on the surface of the object. Because, the detection error is caused as a center of gravity of a slit image is deviated due to a reflectance distribution of a sample, and an absolute value of this deviation increases in proportion to the width of the slit. In the embodiment as shown in FIG. 64(b), the third slit from left is affected by an influence of a fluctuation of a reflectance on the boundary of the sample, but the slit width is narrow so that the detection error is small. Furthermore, it is possible to reduce a detection error caused by the object and the detection fluctuation by averaging the height detected values of a plurality of slits.

Although the detection error decreases as the slit width is reduced, this has a limitation. Thus, even when the slit width is reduced over a certain limit, no slit is clearly focused on the image sensor 214, and a contrast is lowered. This has the following relationship.

Specifically, assuming that ±zmax is a target height detection range, then at that time, the multi-slit image on the image sensor 214 is de-focused by ±2zmax·cos θ. On the other hand, assuming that p is the cycle of the multi-slit-shaped pattern on the projection side and that NA is an NA (Numerical Aperture) of the detection lens 215, then this focal depth becomes ±a·0.61p/NA. That is, the condition that the slit cycle p satisfies (2zmax·cos θ)<(a·0.61p/NA) is the condition under which the multi-slit image can be constantly detected clearly. In the above, a is the constant determined by defining the focus depth such that its amplitude is lowered. When the focus depth is defined under the condition that the amplitude is lowered to ½, a is about 0.6.

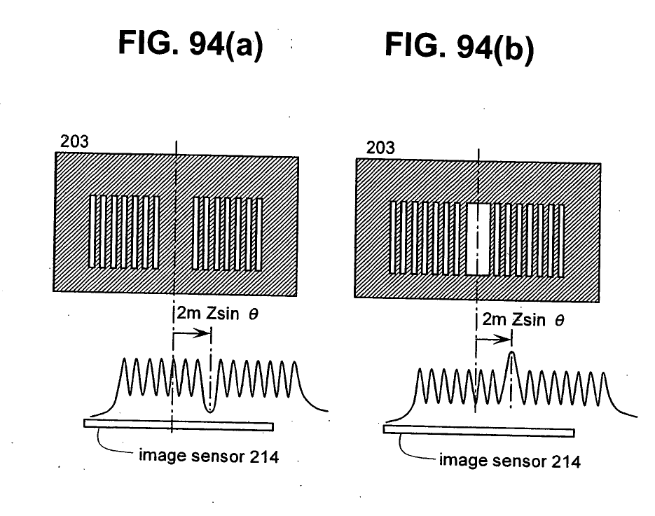

In the embodiment shown in FIG. 63, the projection stop 211 is placed at the front focus position of the projection lens 210, and the detection stop 216 is located at the rear focus position of the detection lens 215. It is for the purpose of eliminating fluctuations of magnifications caused when the sample 106 is elevated or lowered by placing the projection lens 210 and the detection lens 215 to the sample side tele-centric state. This embodiment shows the effect of making the shape and/or the spacing of the multi-slit-shaped pattern non-uniform. In order to enlarge the height detection range of the height detector 200 in this invention, using as many slits as possible is effective. By using many slits, a slit that is projected onto the sample 106 close to the optical axis of the upper observation system 110 is always found even if the height of the sample 106 changes greatly. However, in this case, when too many slits are used in the multi-slit-shaped pattern, the slits around the both ends can go outside the view area of the lens 210 or 215 or the image sensor 214, making it impossible to identify each slit, hence, making it impossible to estimate the movement (2mZ sin θ) of each slit. As illustrated in FIGS. 94(a) and 94(b), by making the center spacing of the multi-slit larger or by making the center slit wider, it becomes possible to identify each slit as long as the center spacing or the center slit is within the viewing area of the height detector 200. With this embodiment, the height detectable range becomes larger. Many variations of the multi-slit-shaped pattern can be easily analogized in which the shape of each slit and/or the spacing between the neighboring slits are made different in order to identify each slit.

Also, in the embodiment shown in FIG. 63, the polarizing filter 240 is placed in front of the projection lens 210 to selectively project S-polarized light. This can achieve an effect for suppressing a positional shift caused by a multi-path reflection in a transparent film and an effect for suppressing a difference of reflectances between the areas.

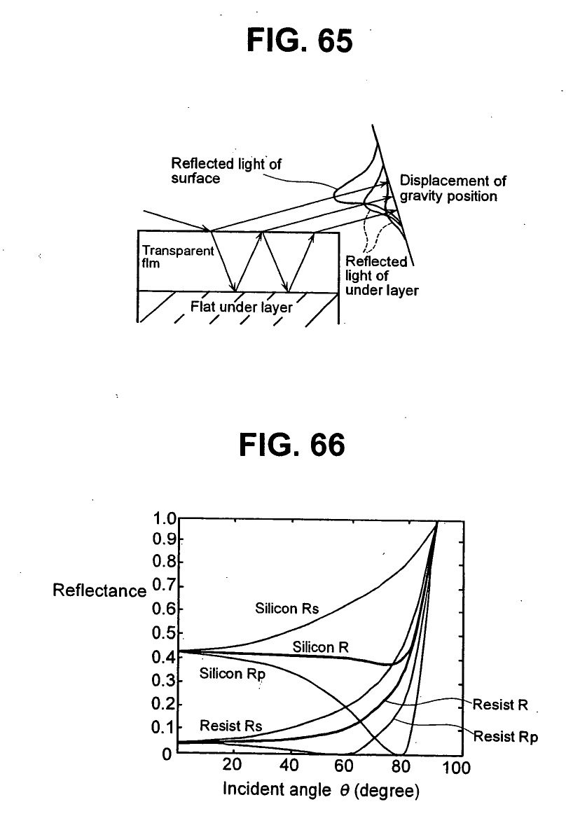

As shown in FIG. 65, when the surface of the sample is covered with a transparent film such as an insulating film for light, there occurs a phenomenon that projected light causes a multi-path reflection in the transparent film to thereby shift the position of projected light. Since S-polarized light is more easily shifted on the surface of the transparent film than P-polarized light, if the polarizing filter 240 is inserted, then S-polarized light becomes difficult to cause a multi-path reflection. On the other hand, FIG. 66 shows a graph graphing reflectances of resist and silicon which are examples of transparent films. Rs represents a reflectance of S-polarized light, Rp represents a reflectance of P-polarized light, and R represents a reflectance of randomly-polarized light. As described above, the S-polarized light has a smaller difference of reflectances between the materials. Further, a study of this graph reveals that the reflectance increases as the incident angle increases and that a difference between the materials decreases. Specifically, an error becomes difficult to occur at the pattern boundary. Therefore, the incident angle θ should preferably as large as possible. The incident angle should preferably become greater than 80° ideally, and it is preferable to use an incident angle of at least greater than 60°. Incidentally, the position of the polarizing filter 240 is not limited to the front of the projection lens 210, and may be interposed at any position between the light source 201 and the detector 214 with substantially similar effects being achieved. Although the light source 201 may be a laser light source or a light-emitting diode, it should preferably be a lamp of a wide zone such as a halogen lamp, a metal halide lamp or a mercury lamp. Alternatively, a laser or a light-emitting diode having a plurality of wavelengths may be used, and such a plurality of wavelengths may be mixed by a dichroic mirror. The reason for this is that single light tends to cause a multi-path interference within the transparent film to thereby shift projected light or a difference of reflectances due to a material or a pattern on the sample tends to increase so that a large error tends to occur.

In the embodiment shown in FIG. 63, the cylindrical lens 213 is located in front of the line image sensor 214. The reason for this is that light is focused on the line image sensor 214 to increase a quantity of detected light and that an error is decreased by averaging reflected light from a wide area on the sample. However, the use of the cylindrical lens 213 is not an indispensable condition, and should be determined in response to the necessity.

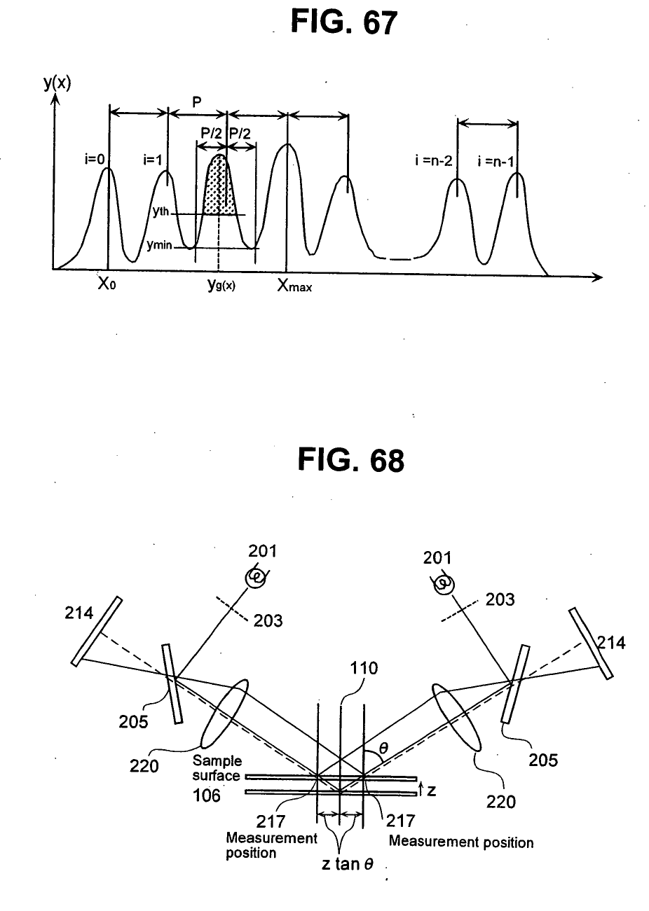

A height detection algorithm of the sample surface 106 according to an embodiment will be described next with reference to FIG. 67. Let it be assumed that n is the total number of slits, p is the pitch and y(x) is the detection waveform. Also, let it be assumed that ygo(i) (i=0, . . . , n−1) represents the position of the peak corresponding to each slit obtained when the height z=0 (relationship of ygo(i)=ygo(0)+p*i is satisfied).

1. Scan y(x) and calculate a position xmax of maximum value.

2. Calculate the substantial position of the peak i by searching left and right directions from xmax by each pitch p.

3. Assuming that xo represents the peak position of the left end, then the substantial position of the peak i becomes xo+p*i. The positions of the left and right troughs xo+p*i−p/2, xo+p*i+p/2.

4. Set ymin=max(y(xo+p*i−p/2), y(xo+p*i+p/2). That is, a larger one of left and right troughs is set to ymin.

5. Set k to a constant of about 0.3, and set yth=ymin+k*(y(xo+p*i)−ymin). That is, set amplitude (y(xo+p*i)−ymin)*k to a range value (threshold value) yth.

6. Calculate a center of gravity of y(x)−yth relative to a point at which y(x)>yth is satisfied between xo+p*i−p/2 and xo+p*i+p/2, and set the value thus calculated to yg(i).

7. Calculate weighted mean of yg(i)−ygo(i), and set the calculated weighted mean to image shift.

8. Calculate the height z by adding an offset to a value which results from multiplying the image shift with a detection gain (1/(2m·sin θ)).

In this manner, there is realized the height detection which is difficult to be affected by the surface state of the sample 106. Incidentally, in this embodiment, the peak of the slit image is used but instead a trough between the slit images may be used. Specifically, a center of gravity of yth−y(x) is calculated with respect to a point of y(x)<yth and set to a center of gravity of each trough. Then, the shifted amount of the whole image is obtained by averaging the movement amount of these trough images. Thus, there can be achieved the following effects. Since the detection waveform is determined based on the product of the projection waveform and the reflectance of the sample surface, the bright portion of the slit image is largely affected by the fluctuation of the reflectance, and the shape of the detection waveform tends to change. On the other hand, the trough portion of the waveform is difficult to be affected by the reflectance of the sample surface. Therefore, by the height detection algorithm based on the measurement of the movement amount of the trough between the slit images, it is possible to reduce the detection error caused by the surface state of the object much more.

The height detection optical apparatus 200a according to a second embodiment according to the present invention will be described next with reference to FIG. 68. In the first embodiment shown in FIG. 63, since the multi-slit-shaped pattern 203 is projected from the oblique upper direction, when the sample surface 106 is elevated and lowered, the position at which the pattern is projected on the sample, i.e. the sample measurement position 217 is shifted and displaced from the detection center 110. Assuming that Z is the height of the sample and θ is the projection angle, then this shift amount is represented by Z tan θ. At that time, if the sample surface 106 is inclined by ε, then there occurs a detection error. The magnitude of this detection error is Z·tan θ·tan ε. For example, when Z is 200 μm, θ is 70 degrees and tan ε is 0.005, the above-mentioned detection error becomes 2.7 μm. When this problem arises, the arrangement of the second embodiment shown in FIG. 68 can achieve the effects. Specifically, the pattern projection/detection are carried out from the left and right symmetrical directions, and the two detected values are averaged, whereby the height of the constant point 110 can be obtained.

The second embodiment shown in FIG. 68 will hereinafter be described in detail. Since the arrangement is symmetrical, the same constituents are constantly located at the corresponding positions, and hence the other side of the constituents need not be described. It is to be appreciated that the projection and detection from the symmetrical direction are also the same. Light emitted from the light source 201 illuminates the mask 203 on which the multi-slit-shaped pattern is drawn. Of the light, light reflected by the half mirror 205 is projected by the projection/detection lens 220 onto the sample 106 at its position 217. The multi-slit-shaped pattern projected on the sample 106 is regularly reflected and focused on the line image sensor 214 by the projection/detection lens 220 disposed on the opposite side. At that time, a luminous flux that has passed through the half mirror 205 is focused on the line image sensor 214. Assuming that m is the magnification of the detection optical system, when the height of the sample is changed by z, the multi-slit image is shifted by 2mz·sin θ on the whole. By using this fact, the height of the sample 106 is calculated from the shifted amounts of the left and right multi-slit images. Then, an average value is calculated by using the height detection values of the left and right detection systems, and the average value thus calculated is obtained as a height detected value at the final point 110. When the above-mentioned height detection apparatus is used as the auto focus height sensor, the height detection position becomes the optical axis of the upper observation system. Incidentally, it is needless to say that the half mirror 205 may be replaced with a beam splitter of cube configuration as long as the beam splitter passes a part of light and reflects a part of light. Moreover, similarly to the first embodiment shown in FIG. 63, by using the cylindrical lens 213, the longitudinal direction of the slit may be contracted and focused on the line sensor 214.

The height detection optical apparatus 200a according to a third embodiment of the present invention will be described next with reference to FIG. 69. Although this arrangement is able to constantly obtain the height of the constant point 110 similarly to FIG. 68, in FIG. 68, a quantity of light is reduced to ½ by the half mirror 205 so that, when light is passed through or reflected by the half mirror 205 twice, a quantity of light is reduced to ¼. Therefore, if a polarizing beam splitter 241 is inserted instead of the half mirror 205 and a quarter-wave plate is interposed between the polarizing beam splitter 241 and the sample 106 as shown in FIG. 69, then it becomes possible to suppress the reduction of the quantity of light to ½. Specifically, light emitted from the light source 201 illuminates the mask 203 having the multi-slit-shaped pattern formed thereon. Of the light, S-polarized component reflected by the polarizing beam splitter 241 is passed through the quarter-wave plate 242 and thereby converted into circularly-polarized light. This light is projected by the projection/detection lens 220 onto the sample 106 at its position 217. The multi-slit pattern projected onto the sample is regularly reflected, and then focused on the line image sensor 214 by the projection/detection lens 220 disposed on the opposite side. At that time, the circularly-polarized light is converted by the quarter-wave plate 242 into P-polarized light. This light is passed through the polarizing beam splitter 242 without being substantially lost, and then focused on the line image sensor 214, thereby making it possible to reduce the loss of the quantity of light. Moreover, if a laser for generating polarized light is used as the light source 201 to enable S-polarized light to pass the first polarizing beam splitter 241, then it becomes possible to substantially suppress the loss of the quantity of light. Assuming that m is the magnification of the detection optical system, then when the height of the sample is changed by z, the multi-slit image is shifted by 2mz·sin θ on the whole. By using this fact, the height of the sample 106 is calculated from the shift amounts of the left and right multi-slit images. An average value is calculated by using the two height detected values of the left and right detection systems, and the average value thus calculated is determined as a height detected value at the final point 110. When the height detection optical apparatus is used as the auto focus height sensor, the height detection position 110 becomes the optical axis of the upper observation system. It is needless to say that the longitudinal direction of the slit may be contracted by using the cylindrical lens 213 and focused on the line image sensor 214 similarly to the first embodiment shown in FIG. 63.

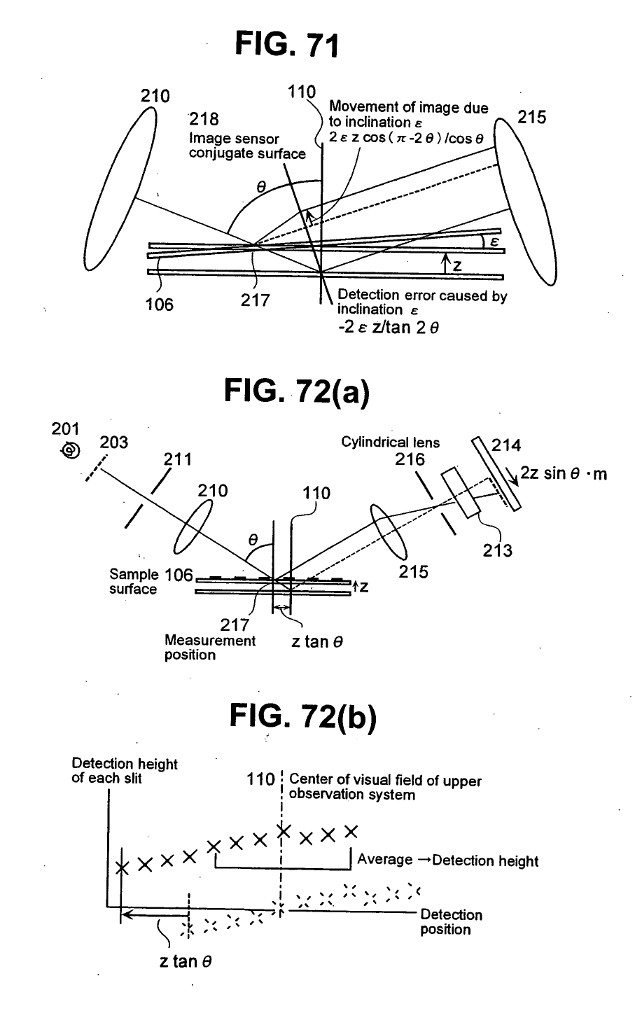

Further, the manner in which an error caused by another cause can be canceled out by using the arrangement of the second or third embodiment shown in FIG. 68 or 69 will be described with reference to FIG. 71. FIG. 71 is a partly enlarged view of FIG. 63, in which reference numeral 210 denotes a projection lens and reference numeral 215 denotes a detection lens. If reference numeral 218 denotes a conjugation surface or focusing surface formed on the image sensor 214 by the detection lens 215, then the shift amount of projected light on this conjugation surface 218 is detected on the image sensor 214. When the height of the sample 106 is increased by z, the detection light reflection position 217 is shifted from the height detection position 110 by z·tan θ. Further, when the sample surface 106 is inclined by an angle εrad, the detection light reflected on the reflection position 217 is inclined by an extra angle of 2εrad due to a so-called optical lever effect. Then, the detection light position on the conjugation surface 218 is shifted by 2εz·cos(π−2θ)/cos θ. Since a height detection error results from multiplying this shifted amount with ½ sin θ, the detection error caused by the inclination of εrad of the sample 106 is represented by −2εz/tan 2θ. For example, assuming that z is 200 μm, θ is 70 degrees and tan ε is 0.005, then the above-mentioned detection error becomes 2.4 μm. When this problem arises, the arrangement of the second or third embodiment shown in FIG. 68 or 69 can achieve the effects. Specifically, the error caused by the above-mentioned optical lever effect becomes the same magnitude and becomes opposite in sign when the projection or detection is carried out from the opposite direction as shown in FIG. 68 or 69. Therefore, when height detection values from the left and right image sensors are averaged, an error can be canceled out. Thus, it becomes possible to carry out the height detection which is free from the error caused by the inclination of the sample surface 106.

Next, the manner in which the height of the sample surface 106 can be obtained accurately by the height calculating unit 200b even when the height z of the sample surface 106 is changed will be described with reference to FIGS. 72(a)-72(b). Although the optical system shown in FIG. 72(a) is identical to that shown in FIG. 63, if the height of the sample surface 106 is changed by z, then the detection position of the slit image is changed by z·tan θ. Since the pattern of the multi-slit shape is projected and the respective slits are reflected at different positions on the sample, the shift amount of each slit image reflects a height corresponding to each reflected position on the sample. Specifically, as shown in FIG. 72(b), there is obtained surface-shaped data of the sample 106. FIG. 72(b) shows a detection height of each slit with respect to the detection position corresponding to the height of the sample surface 106. A measurement point shown by a dotted line indicates measured data obtained when the sample 106 is located at the reference height. When the sample 106 is elevated by z, as shown by a solid line, the sample detection position corresponding to each slit is shifted to the left by z·tan θ. As is defined in the description of the embodiment shown in FIG. 63, assuming that p/cos θ is the pitch of the multi-slit-shaped pattern on the sample surface 106, then the slit corresponding to the visual field center 110 of the upper observation system is shifted to the right by z·tan θ/(p/cos θ)=z·sin θ/p.

Therefore, the height calculating unit 200b can select a plurality of slits containing this slit at the center, average height detection values from these slits, determine the value thus averaged as a final height detection value, and can accurately obtain the height at the visual field center 110 of the upper observation system. In order for the height calculating unit 200b to calculate z·sin θ/p, it is necessary to know the height z. Since the z required may be an approximate value for selecting the slit, the height that was calculated previously or the detection height obtained before the detection position displacement is corrected may be used as the height z. Incidentally, the position equivalent to the visual field center 110 is shifted on the image sensor by zm·sin θ as the height of the sample 106 is changed by z.

Further, when the appearance is inspected on the basis of the SEM image shown in FIGS. 56 and 57, the two-dimensional SEM images of a certain wide area should be latched. To this end, while the stage 105 is moved continuously, the beam deflector 102 should be driven to scan electron beams in the direction substantially perpendicular to the direction in which the stage 105 is moved, and the secondary electron detector 104 need detect the two-dimensional secondary electron image signal. Specifically, while the stage 105 is moved continuously in the X direction, for example, the beam deflector 102 should be driven to scan electron beams in the Y direction substantially perpendicular to the direction in which the stage 105 is moved, and then the stage 105 is moved stepwise in the Y direction. Thereafter, while the stage 105 is continuously moved in the X direction, the beam deflector 102 should be driven to scan electron beams in the Y direction substantially perpendicular to the direction in which the stage 105 is moved, and the secondary electron detector 104 should detect the two-dimensional secondary electron image signal.

Also in this embodiment, the height detection apparatus 200 should constantly detect the height of the surface of the inspected object 106 from which the secondary electron image signal is detected and obtain the correct inspected result by executing the automatic focus control.

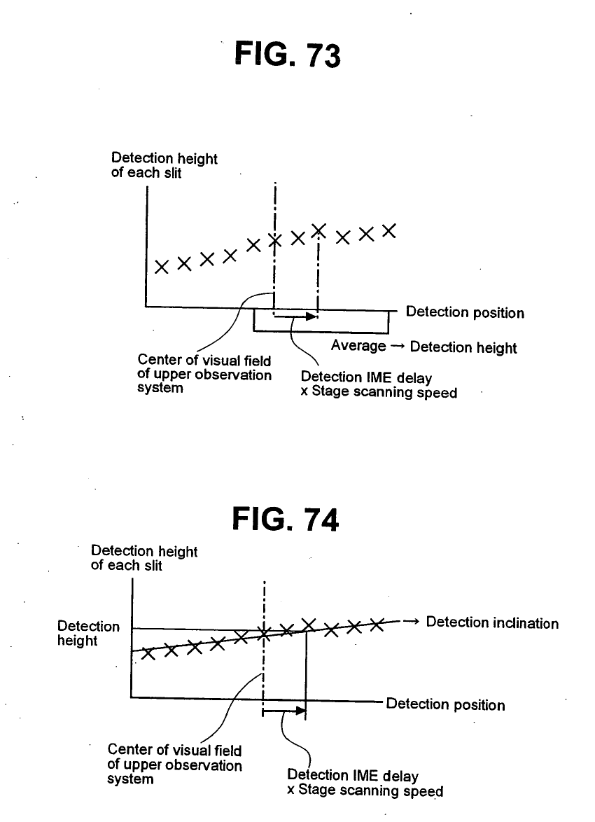

However, due to an image accumulation time of the image sensor 214 in the height detection optical apparatus 200a, a calculation time in the height calculating unit 200b, the responsiveness of the focus position control apparatus 109 or the like, it is frequently observed that a focus control is delayed. Therefore, even when the focus control is delayed, light should be accurately focused on the surface of the inspected object 106 from which the secondary electron image signal is detected. In FIG. 73, let it be assumed that the stage 105 is continuously moved from right to left. In this case, taking the above-mentioned delay time into consideration, the height calculating unit 200b may calculate the height slightly shifted right from the visual field center 110 of the upper observation system, and the focus control apparatus 109 may control the focusing by controlling the focus control current or the focus control voltage to the objective lens 103. The shift amount of the necessary detection position becomes a product VT of the above-mentioned delay time T and the scanning speed (moving speed) V of the stage 105. Specifically, as shown in FIG. 73, the height calculating unit 200b can obtain the values corresponding to the heights by using signals from images of slit groups shifted to the right by VT/(p/cos θ) from the upper observation system visual field center 110 detected from the image sensor 214, average the values thus obtained, and can detect the height in which the delay time is corrected by determining the averaged value as the final height detection value. Incidentally, the measurement position shift amount VT on the sample corresponds to VTm·cos θ on the image sensor 214. As described above, even when the focus control is delayed, since the height calculating unit 200b can calculate the height of the surface of the inspected object 106 from which the secondary electron image signal is detected, the focus control apparatus 109 can accurately focus light on the surface of the inspected object 106 from which the secondary electron image signal is detected by controlling the focus control current or the focus control voltage to the objective lens 103.

In this embodiment, the detection position displacement caused by the change of the height of the sample surface 106 shown in FIG. 72(b) and the time delay shown in FIG. 73 are both corrected. When the two-side projection shown in FIGS. 68 and 69 is used, the detection position displacement caused by the change of the height of the sample surface 106 is canceled out automatically so that only the time delay may be corrected.

FIG. 74 shows an embodiment in which the time delay is corrected not by using the averaged value of the height detection values as shown in FIG. 73, but the final height detection value is calculated by applying a straight line to the surface shape of the detected sample surface 106. In this fashion, the height calculating unit 200b may apply a straight line to detected height data obtained from the position of each slit according to the method of least squares, for example, calculate the height of the position shifted by −zm·sin θ+VTm·cos θ on the image sensor (CCD) 214 by using the resultant straight line, and may determine the height thus obtained as the final detected height. As shown in FIGS. 58(a)-58(c), when the surface shape of the sample surface is partly uneven like the semiconductor memory comprising the memory cell portion 303c and the peripheral circuit portion 303b, it is possible to selectively detect only the height of the high portion of the surface shape of the sample surface by using a suitable method such as a Hough transform instead of the method of least squares. As described above, even when the focus control is delayed, since the height calculating unit 200b calculates the height in accordance with the surface shape of the inspected object 106 from which the secondary electron image signal is detected, the focus control apparatus 109 can precisely focus light on the surface shape of the inspected object 106 from which the secondary electron image signal is detected by controlling the focus control current or the focus control voltage to the objective lens 103. Also, as shown in FIGS. 58(a)-58(c), in the case of the semiconductor memory comprising the memory cell portion 303c and the peripheral circuit portion 303b which are different in height on the surfaces, it becomes possible to accurately focus light on the surface shape.

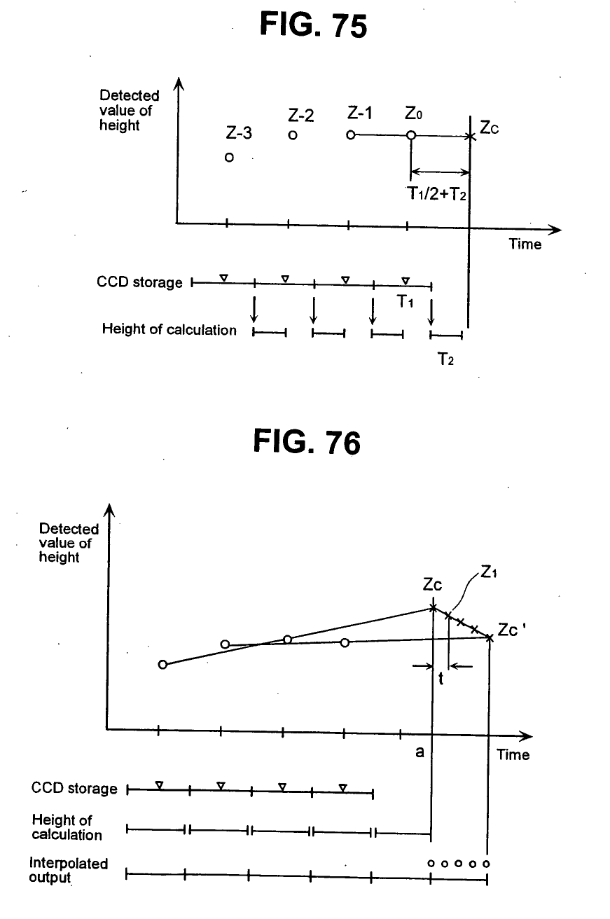

In the embodiment shown in FIGS. 72, 73, 74, there is illustrated the detection time delay correction method obtained on the assumption that the scanning direction of the stage 302 and the projection-detection direction of multi-slit are substantially parallel to each other. A detection time delay correction method that can be used regardless of the scanning direction of stage and the projection-detection direction of multi-slit will be described next. Since the line image sensor 214 outputs image signals accumulated during a certain time T1, it can be considered that the line image sensor may obtain an average image of the period T1. Specifically, data obtained from the line image sensor 214 has a time delay of T1/2. Further, in order for the height calculating unit 200b formed of the computer, a constant time T2 is required. Thus, the height detection value indicates past information by a time of (T1/2)+2 in total. As shown in FIG. 75, assuming that detection values obtained at a constant interval are Z−m, Z−(m−1), . . . , Z−2, Z−1, Z0, then the height calculating unit 200b can estimate a present time Zc from these data. As shown in FIG. 75, for example, it is possible to obtain the present height Zc by extrapolating the latest detection value Z0 and a preceding detection value with straight lines as in the following equation of (expression 25):
Zc=Z0+((Z0)−(Z−1))×((T1/2)+T2)/T1 (expression 25)

Extrapolation straight lines may of course be applied to more than three points Z−m, Z−(m−1), . . . Z−2, Z−1, Z0 so as to reduce an error or a quadratic function, a cubic function or the like may be applied to these points. These extrapolation methods are mathematically well known, and when in use, the most suitable one may be selected in accordance with the magnitude of the change of the height detection value and the magnitude of the fluctuations.

As another embodiment, the manner in which the height detection value is corrected and outputted will be described. When the height detection value changes stepwise at the interval T1, if the feedback is applied to electron beams by using such stepwise height detection values, then it is not preferable that the quality of electron beam image is changed rapidly at the interval T1. In this case, in addition to the extrapolation height detection value Zc, an extrapolation height detection value Zc′ which is delayed by a time T1 from a time a is calculated similarly. In the embodiment shown in FIG. 76, the extrapolation height detection values Zc and Zc′ are calculated by the following equation of (expression 26):
Zc=(Z−1)+(((Z−1)−(Z−3))/(2T1))×2.5T1
Zc′=(Z0)+(((Z0)−(Z−2))/(2T1))×2.5T1 (expression 26)

On the basis of these Zc and Zc′, the height Z1 which is delayed by t from the time a can be calculated by interpolation as in the following equation of (expression 27):
Z1=Zc+(Zc′−Zc)t/T1 (expression 27)

As described above, the detection time delay caused by the CCD storage time and the height calculation time can be corrected. Thus, even when height of the inspected object 106 is change every moment, a height detection value with a small error can be obtained, and a feedback can be stably applied to the electron optical system which controls electron beams.

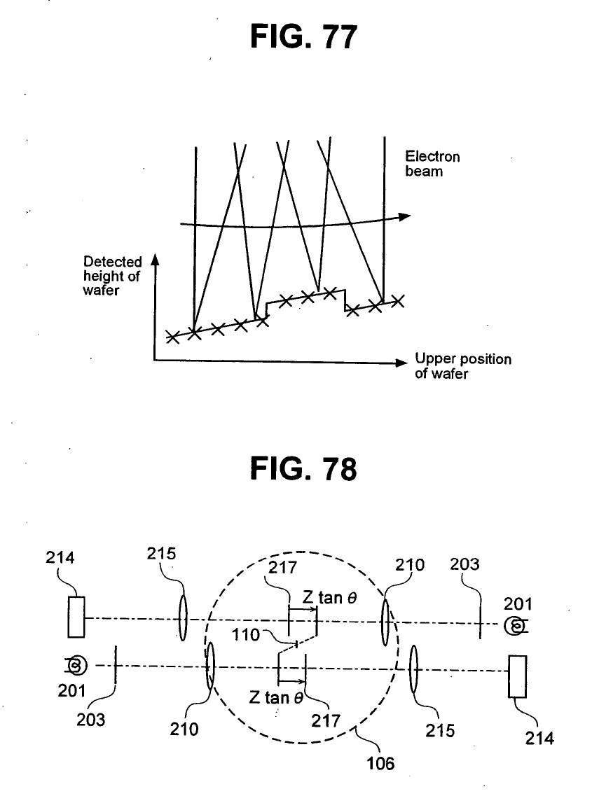

Further, in the electron optical system shown in FIGS. 55, 56, 57 and 60, since the focus position thereof can be controlled at a high speed by a focus control current or a focus control voltage, the focusing can be made by an embodiment shown in FIG. 77. Specifically, while electron beams are scanned once, the focus control apparatus 109 dynamically changes the focus position by controlling the focus control current or the focus control voltage to the objective lens 103 such that the position thus changed may agree with the surface shape of the sample surface 106 detected by the height detection optical apparatus 200a and which is calculated by the height calculating unit 200b. Since the height calculating unit 200b is able to calculate the surface shape of the sample surface 106 from the image signal of the multi-slit-shaped pattern obtained from the image sensor 214 of the height detection optical apparatus 200a, while electron beams are scanned once, the focus control apparatus 109 can realize the properly-focused state by controlling the focus control current or the focus control voltage to the objective lens 103 in accordance with the surface shape of the sample surface 106 thus calculated. Thus, when an inspected object has a large stepped structure like a semiconductor memory, it becomes possible to accurately focus light on the inspected object constantly.

FIG. 78 shows another embodiment of the two-side projection system shown in FIGS. 68 and 69. Specifically, in the embodiment shown in FIG. 78, two optical systems according to the embodiment shown in FIG. 63 are prepared and disposed side by side in which the detection directions are made opposite to each other. As shown in FIGS. 68 and 69, it is possible to realize a function equivalent to that of the arrangement which makes the left and right optical system common by using the half mirror 205. Specifically, also in the embodiment shown in FIG. 78, as the sample surface 106 is elevated and lowered, the detection apparatus 217 is moved right and left with the result that the position of the center of the detection apparatus 217 composed of the two optical systems can always be made constant. Therefore, it is possible to detect the height at the constant position 110 by averaging the height detection values obtained from these optical systems. Thus, it is possible to construct a height detector which can prevent a detection error from being caused when the detection position is displaced by the fluctuation of the height. However, since the patterns of multi-slit shape are projected at different positions, when the surface of the inspected object 106 has steps and undulations, detection light is not irradiated on the point 110 and a detection error occurs. Accordingly, the present invention is applicable when the surface of the inspected object has small steps and undulations.

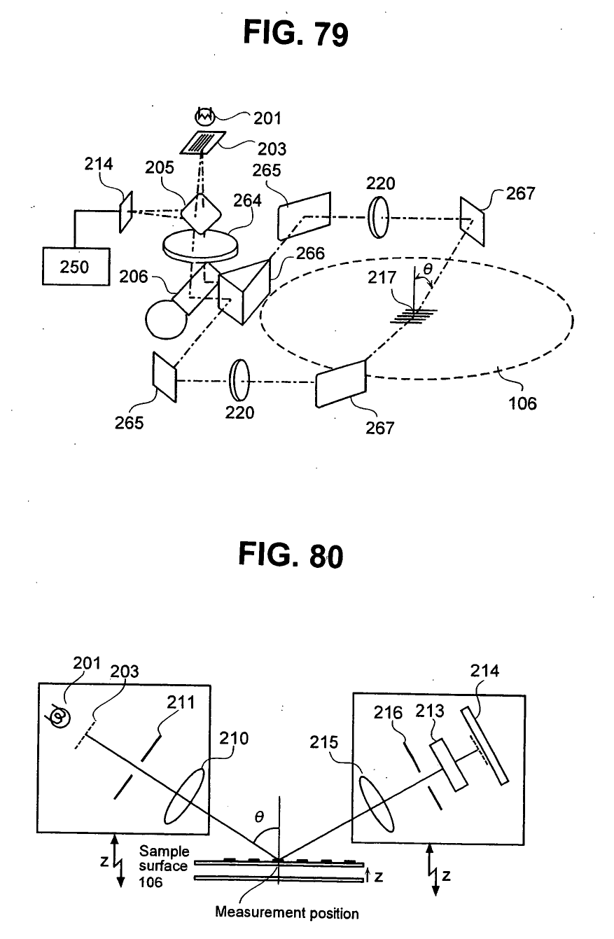

Furthermore, FIG. 79 shows another embodiment of the two-side projection system shown in FIGS. 68 and 69. Specifically, in the embodiment shown in FIG. 79, two optical system use an illumination and an image sensor. Light emitted from a light source 201 illuminates a mask pattern 203 of multi-slit shape. Light passed through a multi-slit 203 is traveled through a half mirror 205, converted by a lens 264 into parallel light, reflected by a mirror 206, and branched by a branching optical system (roof mirror) 266 into two multi-slit light beams. The multi-slit light beams thus branched are projected by a projection/detection lens 220 through a mirror 267 to thereby focus an image of a mask pattern 203 at the measurement position 217 on the sample 106. An incident angle obtained at that time is assumed as θ. A pair of multi-slit light beams reflected on the surface of the sample 106 are returned through the same light paths as those of projected light and reached to the half mirror 205. Specifically, a pair of multi-slit light beams reflected on the surface of the sample 106 are reflected on the respective mirrors 267, traveled through the respective projection/detection lenses 220, reflected on the respective mirrors 265, reflected on the branching optical system 266, reflected on the mirror 206, synthesized by the lens 264 and reached to the half mirror 205. Light reflected on the half mirror 205 is focused on the image sensor 214. On the sensor 214, light beams that were branched into two directions by the branching optical system 266 are synthesized one more time so that only one illumination system and one image sensor 214 are sufficient. Moreover, since the height calculating unit 200b may process only one waveform, a load may be decreased. Therefore, it is possible to inexpensively realize a height detection apparatus which can prevent a detection position from being displaced by the two-side projection system.

As another embodiment, instead of an arrangement for controlling an angle of the mirror 206 electrically, if the mirror 206 is controlled in such a manner that the position at which the slit-shaped pattern image is focused on the image sensor 214 always becomes constant, then the irradiated position 217 of detection light on the sample can be maintained constant regardless of the height z of the sample 106. When the mirror is controlled as described above, the rotation angle of the mirror 206 and the height z are in proportion to each other so that the height z of the sample can be detected by detecting the rotation angle of the mirror 206.

FIG. 80 shows an embodiment of another arrangement in which the detection position can be prevented from being displaced. Although the layout of the optical system is the same as that of the embodiment shown in FIG. 63, the whole of the detector can be elevated and lowered. If the height of the whole of the detector is controlled such that the position of the slit on the image sensor 214 always becomes constant, then the detection light irradiated position 217 can be maintained constant regardless of the height z of the sample 106. The height z of the whole of the detector presented at that time agrees with the height z of the sample 106. Another advantage of this arrangement will be described. In the embodiment shown in FIG. 63, if a magnification color aberration exists in the lens 215, the position of the multi-slit image on the image sensor 214 is displaced by the color of the sample surface 217. That is, an error occurs in the detection height. As a result, it is necessary to suppress the color aberration of the lens 215. On the other hand, in the arrangement shown in FIG. 80, the center of the multi-slit pattern is constantly located on the optical axis under control. Since the color aberration does not occur on the optical axis, the color aberration of the lens and the distortion of image do not cause the detection error. Therefore, it becomes possible to construct a height detector of a small detection error by an inexpensive lens. Further, since the detection multi-slit pattern is not de-focused as the height of the sample is changed, the size of each slit can be reduced to approximately the limit of resolution of lens. Furthermore, there is the advantage that a height detection error caused by the reflectance distribution of the sample can be reduced.

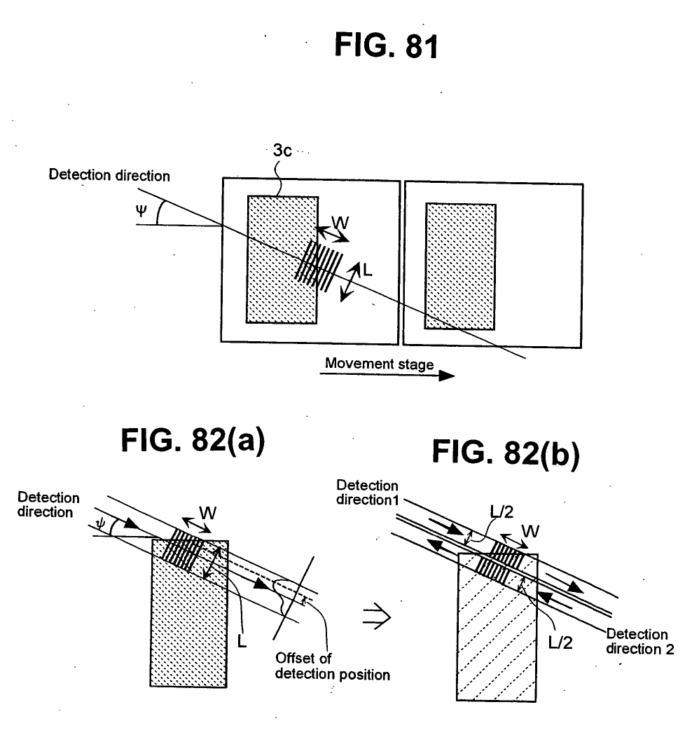

A method of further decreasing a detection error by properly selecting the slit direction will be described next with reference to FIG. 81. When a semiconductor apparatus is inspected or observed as a sample, the semiconductor apparatus usually has a pattern such that an area such as a memory mat portion 303c is formed in each rectangular chip as shown in FIG. 81. Since it is customary that the memory mat portion has small patterns formed thereon, light tends to scatter/diffracted, thereby resulting in a low reflectance portion being formed. When the slit is irradiated on this boundary portion, a symmetry of a detection pattern obtained as a reflected light image is broken, and hence there occurs a detection error. On the other hand, when the longitudinal direction of the slit is irradiated on the pattern with an inclination angle φ relative to the pattern as shown in FIG. 81, a ratio of the portion in which the border line of the pattern crosses the slit relative to the length L of the slit is reduced so that an amount in which a symmetry of a detection pattern is fluctuated by a difference of reflectances at the boundary portion of the pattern can be decreased. That is, a detection error can be reduced. Thus, in addition to the error reduction achieved by the multi-slit, it is possible to achieve a further error reduction effect. In the embodiment shown in FIG. 81, the projection & detection direction and the longitudinal direction of the slit are perpendicular to each other, which is not always necessary. Specifically, the angle of the longitudinal direction of the slit projected on the sample 106 can be controlled by rotating the mask 203 on which there is formed the multi-slit like pattern. At that time, the cylindrical lens 213 and the line image sensor 214 also should be rotated in the direction opposing the sample 106 by the same angle as that of the mask 203. Assuming that η is this angle, then the direction of the slit projected on the sample 106 is rotated by arctan(sin η/(cos η cos θ)) in the projection direction.

While the method of correcting the detection position of the projection direction by the multi-slit and the method of canceling out the positional displacement by the two-side projection have been described so far with respect to the phenomenon in which the detection position is displaced by the height z of the sample surface 106, a method of reducing a displacement of a detection position in the longitudinal direction of the slit, i.e. in the direction perpendicular to the projection direction will be described. When the longitudinal direction of the slit is projected across areas having different reflectances on the sample as shown in FIG. 82(a), detection light is given an intensity distribution in the longitudinal direction of the slit. In this case, the height distribution of the sample is reflected on the height detection value with a weighting corresponding to the light quantity distribution of this detected light. Specifically, the height detection value considerably reflects information of the area having the high reflectance with the result that a height of a point displaced from the height measurement point 110 is unavoidably measured. The resultant detection error is reduced as the size L of the longitudinal direction of the slit is reduced. However, the detection light quantity is decreased and is easily affected by a local fluctuation of the reflectance on the surface of the sample. Therefore, the size of the slit cannot be reduced freely. Accordingly, as is seen in the embodiments shown in FIGS. 68, 69, 79, 80, in the arrangement in which detection light is projected from both sides, the projection positions are displaced in the longitudinal direction of the slit in such a manner that the projection positions of the right and left slits may not overlap as shown in FIG. 82(b). Then, in the case of this embodiment, only the multi-slit pattern of a direction 1 is projected across the two areas so that a height detection value based on a detection direction 2 does not cause an error. Thus, it is possible to reduce an error to ½ by averaging height detection values of the detection direction 1 and the detection direction 2. In the embodiment shown in FIG. 82(b), the length of the slit is reduced to L/2 such that the total width of the projection areas of the projection direction 1 and the projection direction 2 may become L. Consequently, as compared with FIG. 82(a), the detection position displacement of the longitudinal direction of the slit can be reduced to ¼ on the whole.

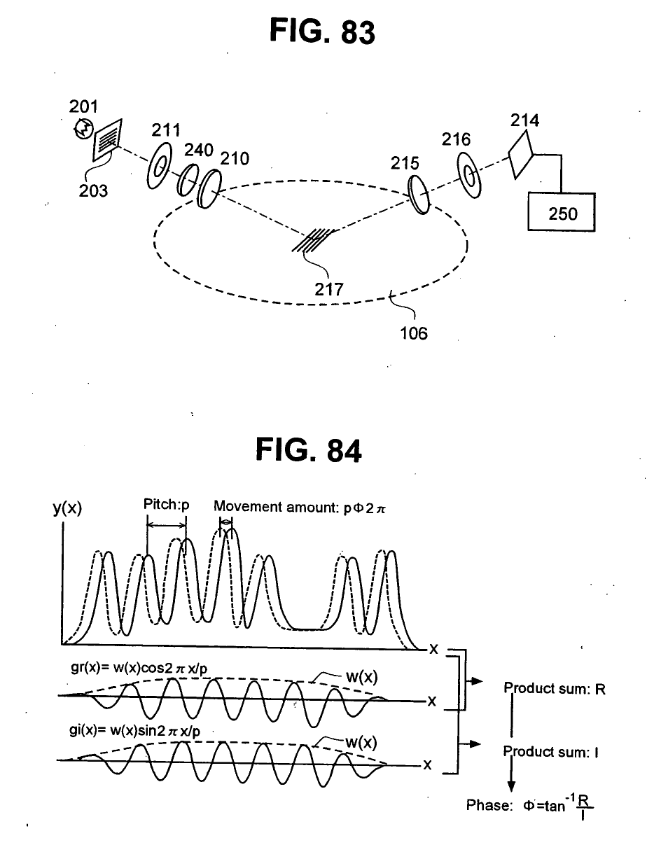

An embodiment in which a two-dimensional distribution of the height of the sample 106 is obtained will be described next with reference to FIG. 83. Light emitted from the light source 201 illuminates the mask 203 with the pattern composed of rectangular repeated patterns, for example. This light is projected by the projection lens 210 at the position 217 on the sample 106. The multi-slit pattern projected onto the sample is focused by the detection lens 215 on the two-dimensional image sensor 214 such as a CCD. Assuming that m is the magnification of the detection system, then when the height of the sample is changed by z, the slit image is shifted by 2mz·sin θ. Since this shift amount reflects a height of a point at which the slit irradiates the sample, by using this shift amount, it becomes possible to detect the height distribution of the sample 106 in the irradiated range of the slit.

In the embodiment shown in FIG. 83, the stop 211 is disposed at the front focus position of the projection lens 210, and the stop 216 is disposed at the rear focus position of the detection lens 215. The reason for this is that a magnification fluctuation caused when the sample 106 is elevated and lowered can be eliminated by disposing the lenses 210 and 215 in a sample-side tele-centric fashion. Consequently, the magnification fluctuation caused by the change of the height of the sample surface 106 can be suppressed, and a detection linearity can be improved.

Moreover, as in the embodiment shown in FIG. 83, the polarizing filter 240 is disposed at the front of the projection lens 210 to selectively project S-polarized light. The reason for this is that, when a pattern formed on an insulating film or the like is inspected on the basis of the SEM image, the insulating film is a transparent film and therefore a multi-path reflection can be prevented in the transparent film, thereby making it possible to inspect the above-mentioned pattern while a difference of reflectances between the materials is suppressed. The polarizing filter 240 is not always disposed in front of the projection lens, and may be interposed between the light source 201 and the detector 214 with substantially similar effects being achieved.

With respect to a multi-slit shift amount detection algorithm executed by the height calculating unit 200b, an embodiment different from FIG. 67 will be described next. FIG. 84 shows a method of detecting a phase change φ of a cyclic waveform. Assuming that p is a pitch of a multi-slit shaped pattern, then the phase change φ(rad) corresponds to a shift amount pφ/2π. This shift amount corresponds to a height change pφ/(2πm·sin θ) so that the height detection is concluded as the detection of the phase change of the cyclic waveform. The height detection in the height calculating unit 200b can be realized by a product sum calculation. Specifically, the detection waveform is assumed to be y(x). Then, a product sum of the detection waveform and a function g(x)=w(x)exp(i2πx/p), and a resultant phase may be obtained where i is the imaginary number unit, and w(x) is the correlation function of a proper real number. When this correlation function is a Gaussian function, w(x) is, in particular, called a Gavore filter, and w(x) may be any function as long as the function may be smoothly lost at the respective ends. While the complex function is employed in the above description, it will be expressed by a real number as follows. Having calculated the product sum of gr(x)=w(x)·cos(i2πx/p) and gi(x)=w(x)·sin(i2πx/p) with y(x), results are set to R and I, respectively. Then, the phase of y(x) is represented as 9=arctan(I/R). However, since this phase is folded in a range of −π to π, phases may be coupled by searching the previous detection phases without a dropout or an approximate value of 2π-order of the phase is calculated by calculating the approximate position of the peak. Incidentally, while the weighting function w(x) and the width of the waveform y(x) are made substantially equal in this example, the portion which overlaps the weighting function w(x) is selected from the multi-slit image by reducing the width of the weighting function w(x) relative to the waveform y(x), and the shift amount of this portion can be calculated. Furthermore, by using a weighting function for selecting a right half portion from the multi-slit pattern existing range and a weighting function for selecting a left half portion from the multi-slit pattern existing range, the heights of the left half portion and the right half portion can be calculated with respect to the measurement position on the sample. Then, it is possible to obtain the height and the inclination of the sample by using such calculated results.

Furthermore, while the above-mentioned algorithm constructs the filter matched with the pitch p of the well-known multi-slit shaped pattern and uses this filter to detect the phase, the present invention is not limited thereto, and an FFT (Fast Fourier Transform) is effected on y(x) and a phase corresponding to a peak of a spectrum is obtained, thereby making it possible to detect the phase of the waveform y(x).

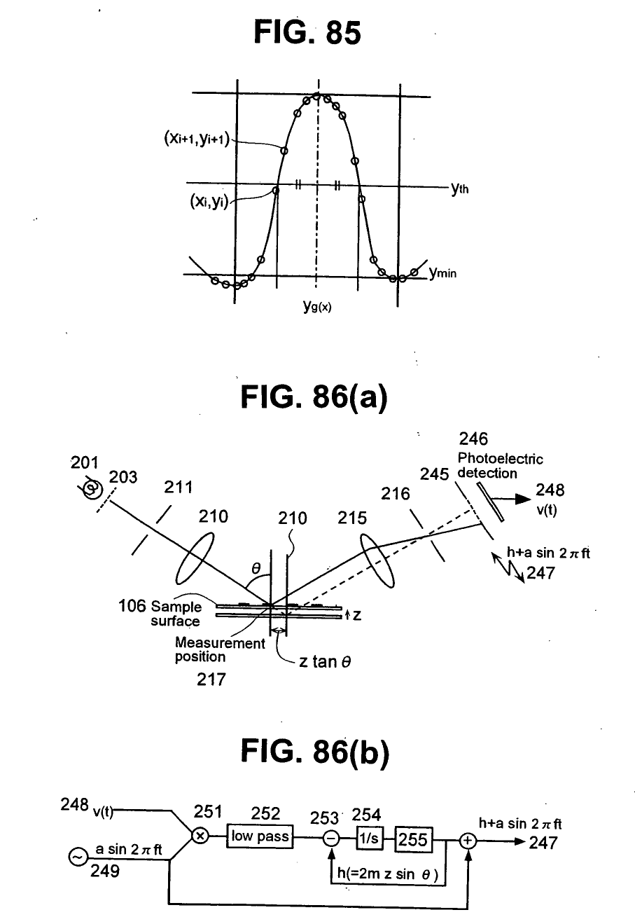

An embodiment of another slit shift amount measuring algorithm will be described next with reference to FIG. 85. In the embodiment shown in FIG. 67, the displacement of the slit image is measured by using the center of gravity. According to this method, such displacement is converted into a height on the basis of the position of the edge of the slit image. Initially, similarly to the embodiment shown in FIG. 67, the peak of each slit and the positions of troughs on the respective sides are calculated and a proper threshold value yth is calculated from the amplitude. Then, searching two points across this threshold value yth, resultant two points are set to (xi, yi) and (xi+1, yi+1). Then, x coordinates of a point at which the line connecting the above two points and threshold value cross each other are expressed by xi+(xi+1−xi) (yth−yi)/(yi+1−yi). This operation is effected on each of left and right inclined portions of the slit, the positions of the crossing points between the threshold values and this line are calculated, and then a middle point is determined as the position of the slit.

Moreover, the peak position of the slit can be determined as the position of the slit. The interpolation is executed in order to calculate the peak position with an accuracy below pixel. There are various interpolation methods. When a quadratic function interpolation, for example, is carried out, if three points before and after the maximal value are set to (x1−Δx, y0), (x1, y1) and (x1+Δx, y2), then the peak position is expressed by x1+Δx (y2−y0)/{2(2·y2−y2−y0)}.

While the above-mentioned methods have been described so far on the assumption that the position of the slit is calculated, the present invention is not limited thereto, and the position of the trough of the detection waveform is calculated and the shift of this position is detected, thereby making it possible to obtain the height of the sample. If so, the following effects can be achieved. The amount in which the waveform of the detection multi-slit pattern is fluctuated by the reflectance distribution on the surface of the sample increases much more when the reflectance boundary coincides with the peak portion of the multi-slit image as compared with the case in which the reflectance boundary coincides with the trough portion. The reason for this is that the detected light quantity distribution is determined based on a product of the light quantity distribution obtained when the reflectance of the sample is constant and the reflectance of the sample. Consequently, the bright portion tends to cause the change of the detected light quantity relative to the change of the same reflectance. Accordingly, if the position of the trough portion having the small fluctuation of the waveform is calculated, the position of the slit image can be detected and the height of the sample can be detected with a small error independently of the state of the reflectance of the sample. As the method of detecting the position of the trough portion, there may be used the algorithm for calculating a center of gravity relative to a code-inverted waveform −y(x) shown in FIG. 67 and the algorithm for calculating the point crossing the threshold value by the interpolation shown in FIG. 85.

A method of detecting the position of the multi-slit image without the linear image sensor will be described next with reference to FIGS. 86(a)-86(b). As shown in FIG. 86(a), light emitted from a light source 201 illuminates a mask 203 on which the multi-slit shaped pattern is drawn. This multi-slit pattern is projected by a projection lens 210 at a position 217 on a sample 106. The multi-slit pattern projected onto the sample is focused by a detection lens 215 on a mask pattern 245. A quantity of light passed through this mask pattern 245 is detected by a photoelectric detector 246. The mask pattern 245 is the pattern having the same pitch as that of the mask 203, and is vibrated about h at a sin 2πft. In synchronism therewith, an output 248 of the photoelectric detector 246 is vibrated. If this is synchronizing-detected, then the direction of the positional displacement between the multi-slit image and the vibrating mask pattern 245 can be detected. If this detected positional displacement is fed back to the vibration center h of the pattern 245, then the position of the multi-slit image and the position of the vibrating mask pattern 245 can agree with each other constantly. Since the vibration center h of the pattern 245 obtained at that time is equal to 2mz·sin θ, the height of the sample can be obtained from this fact. FIG. 86(b) is a block diagram showing this fact. An oscillator 249 supplies a signal of sine wave of a sin 2πft. This sine wave signal is supplied to a multiplier 251, in which it is multiplied with a signal v(t) (248) from the photoelectric detector 246 and supplied through a low-pass filter 252. Since this signal indicates the positional displacement from the multi-slit image of the mask 246, this signal is inputted to a temporary delay loop composed of a subtracter 253 (subtracts h (=2mz·sin θ) obtained from a gain 255), an integrator 254, and the gain 255. This output becomes the vibration center h of the mask 245. The mask 245 is driven by a drive signal 247 which results from adding the signal a sin 2πft from the oscillator 249 to this signal. Thus, it is possible to maintain the multi-slit image and the vibration center position h of the mask pattern 245 coincident with each other.

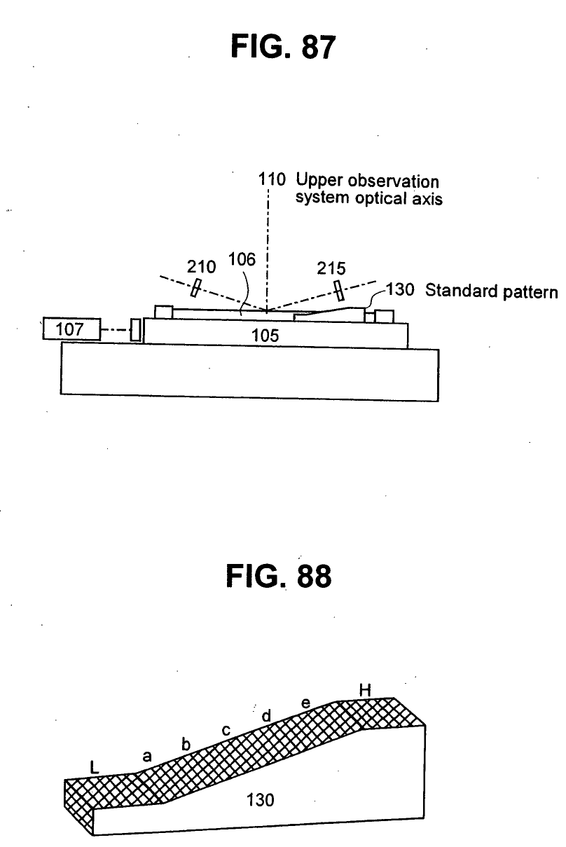

An embodiment concerning a method of correcting a focus control current or a focus control voltage and a focus position of charged particle optical system (objective lens 103) in the observation SEM apparatus and the length measuring SEM apparatus including the appearance inspection SEM apparatus shown in FIG. 55 or 56 or 57 or 60 will be described. When a relationship between the control current and the focus position is nonlinear, a nonlinear correction is required. A method of evaluating a linearity and determining a correction value will be described. A correction standard pattern 130 shown in FIG. 88 is fixed to a sample holder on the stage 302 which holds the inspected object 106 and located as shown in FIG. 87. The correction standard pattern 130 is made of a conductive material so as to prevent the correction standard pattern from being charged when electron beams 112, which are charged particle beams, are scanned.

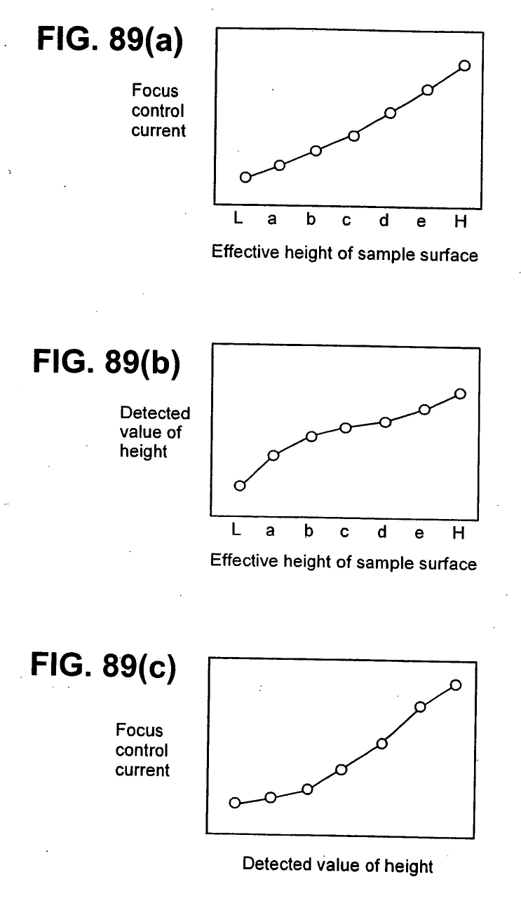

Upon correction, on the basis of the command from the entirety control unit 120, the stage control apparatus 126 is controlled in such a manner that this correction standard pattern 130 is moved about the upper observation system optical axis 110 in the observation area. The entirety control unit 120 uses this standard pattern 130 to obtain from the focus control apparatus 109 the focus control current or the focus control voltage under which the secondary electron image signal (SEM image signal) which is the charged particle beam image detected by the secondary electron detector 104 which is the charged particle detector becomes clearest at each point, and measures the same. At that time, the visibility of the secondary electron image (SEM image) which is the charged particle beam image is detected by the secondary electron detector 104. A digital SEM image signal converted by the A/D converter 339 (122) or the digital SEM image signal pre-processed by the pre-processing circuit 340 is inputted to the entirety control unit 120 and thereby displayed on the display 143 or stored in the image memory 347 and displayed on the display 350, thereby being visually confirmed or determined by the image processing for calculating a changing rate of an image at the edge portion of the SEM image inputted to the entirety control unit 120. Since the real height of the correction sample surface (correction standard pattern 130) is already known, if this height information is inputted by using an input (not shown), then the entirety control unit 120 is able to obtain a relationship between the real height of the sample surface and the optimum focus control current or focus control voltage by the above-mentioned measurement as shown in FIG. 89(a). Simultaneously, the height detection optical apparatus 200a and the height calculating unit 200b measure the height of the correction standard pattern 130, whereby the entirety control unit 120 obtains a correction curve indicative of a relationship between the real height of the sample surface and a measured height detection value measured by the height detection optical apparatus 200a and the height calculating unit 200b as shown in FIG. 89(b). A study of these two correction curves reveals that the entirety control unit 120 can detect, from the detection values obtained by the height detection optical apparatus 200a and the height calculating unit 200b, the optimum focus control current or focus control voltage under which a properly-focused charged particle beam image is picked up. Moreover, instead of obtaining separately two sets of correction curves of the height of the sample surface and the detection value obtained by the height detection optical apparatus 200a or the like and the real height of the sample surface and the focus control current or focus control voltage, the entirety control unit 120 may directly obtain a correction curve presented between the detection value obtained by the height detection optical apparatus 200a and the focus control current or focus control voltage as shown in FIG. 89(c). In this case, the real height of the correction standard pattern 130 need not be detected.

Specifically, as shown in FIG. 91, the correction is made by using the correction standard pattern 130. In a step S30, a correction is started. In a step S31, the entirety control unit 120 issues a command to the stage control apparatus 126 in such a manner that the position n of the correction sample piece 130 is moved to the optical axis 110 of the electron optical system. Then, a step S32 and steps S33 to S38 are executed in parallel to each other. In the step S32, the entirety control unit 120 issues a height detection command to the height calculating unit 200b to thereby obtain non-corrected height detection data Zdn. At the same time, in the steps 33, the entirety control unit 120 issues a command to the focus control apparatus 109 so that the focus control signal of the electron optical system (objective lens 103) matches Ii. Next, in the step S34, the entirety control unit 120 issues a command to the deflection control apparatus 108 so that electron beams are scanned in a one-dimensional or two-dimensional fashion. In the next step S35, the entirety control unit 120 issues a command to the image processing unit 124 so that the SEM image thus obtained is processed to calculate a visibility Si of an image. In the next step S36, i=i+1 is set in the focus control signal Ii of the electron optical system (objective lens 103). Until i≦Nn is satisfied in the step S37, the steps S33 to S35 are repeated to thereby obtain the visibility Si of the image in each focus control signal Ii. If a NO is outputted in the inequality of i≦Nn in the step S37, then in the step S38, the entirety control unit 120 calculates the focus control signal In, in which the visibility Si of the image becomes maximum.

In the next step S39, the entirety control unit 120 issues a command to the image processing unit 124 in such a manner that the image processing unit obtains an image distortion parameter composed of an image magnification correction, an image rotation correction or the like in each height Zn in the correction sample piece 130 and stores the image distortion correction parameter thus obtained in the memory 142. In the next step S40, the position n on the sample piece 130 is set to n=n+1. Then, until n≦Nn is satisfied in a step S41, the steps S31 to S39 are repeated to thereby obtain the focus control signal In under which the visibility of the image in the height Zdn of each sample piece becomes maximum and the image distortion correction parameter composed of the image magnification correction, the image rotation correction or the like. If a NO is outputted in the inequality of n≦Nn at the step S41, then in a step S42, the entirety control unit 120 obtains a correction curve shown in FIG. 89(c) from the focus control signal In under which a visibility of an image in the non-corrected height detection value Zdn and the height Zdn of each sample piece becomes maximum or if the real height Zn of each position n of the sample piece 130 is already known, the entirety control unit obtains correction curves shown in FIGS. 89(a), (b) from Zdn, Zn, In. Then, in a step S43, the entirety control unit 120 obtains a parameter (e.g. coefficient approximate to polynomial) of the above-mentioned correction curve, and stores the parameter thus obtained in the memory 142. Then, the processing is ended (S44).

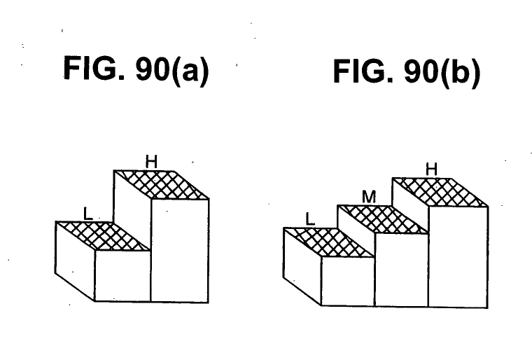

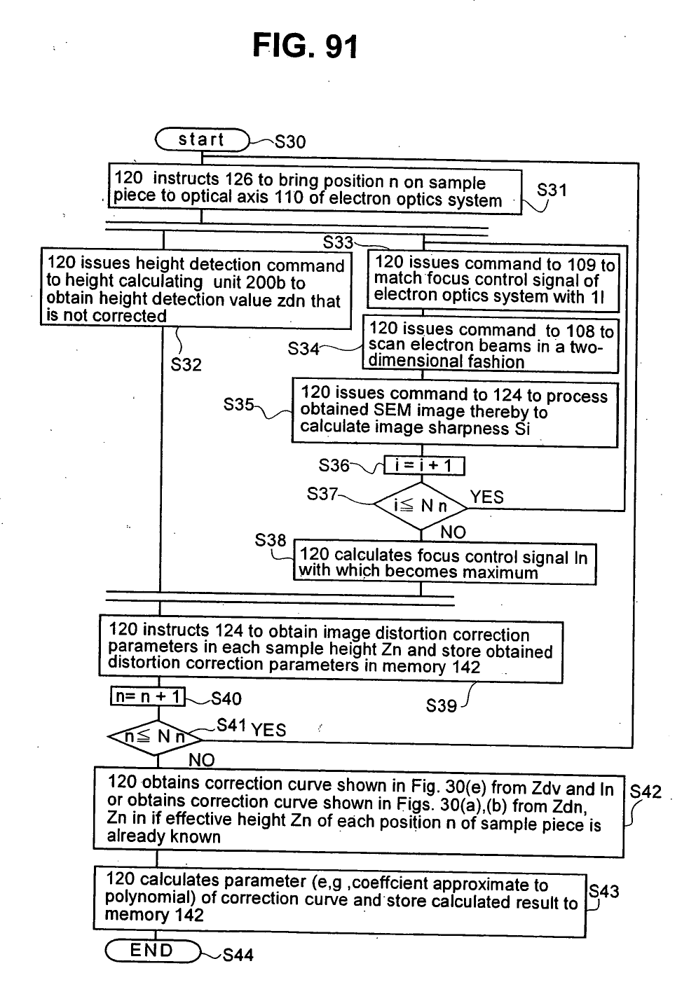

Incidentally, the correction standard pattern 130 shown in FIG. 88 has flat respective ends, and hence can correct a gain and an offset by effecting the correction in the above-mentioned two portions. While the correction standard pattern 130 has the correction curve of which the shape is stable, it is effective for executing a prompt correction when only a gain and an offset drift. When the shape of the correction curve is very stable and can be corrected by other methods, the gain and offset between the control currents to the optical system height detection optical apparatus 200a and the objective lens 103 may be corrected by the standard pattern having a one step difference as shown in FIG. 90(a). Moreover, when the shape of the correction curve is a simple shape that can be approximated by the quadratic function, there may be used the standard pattern having two step differences as shown in FIG. 90(b).

Furthermore, when the charged particle beam apparatus such as the SEM apparatus has the Z stage, the Z stage is moved and detected in height not by the standard pattern shown in FIG. 90, but by an ordinary pattern having no step difference, and the image is evaluated, thereby making it possible to correct the control currents to the height detection optical apparatus 200a and the objective lens 103. In this case, although the focus can be adjusted by the Z stage, if a responsive speed of the stage is not sufficient relative to a speed at which the observation portion is changed, then the stage is placed in the fixed state, and the focus can be adjusted by the control current to the objective lens 103.

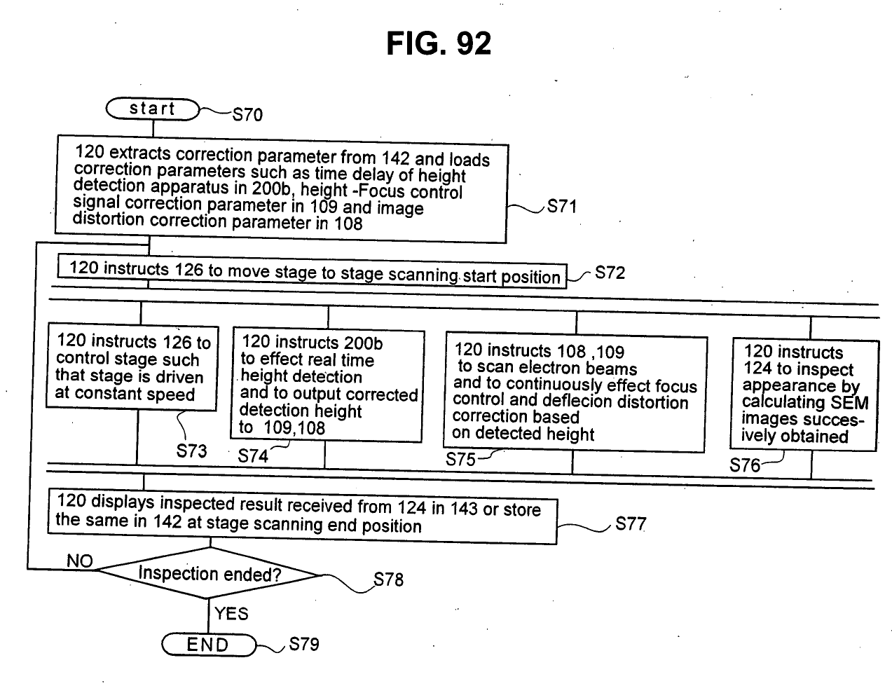

The manner in which the correction is executed by using the correction parameter thus obtained and an appearance is inspected on the basis of the SEM image in the SEM apparatus shown in FIG. 55 or 56 will be described with reference to a flowchart shown in FIG. 92. Specifically, in a step S70, the processing is started. In the next step S71, the entirety control unit 120 reads out the correction parameter from the memory 142, loads a height detection apparatus correction parameter to the height calculating unit 200b, loads a height-focus control signal correction parameter to the focus control apparatus 109, and loads an image distortion correction parameter such as an image magnification correction to the deflection control apparatus 108.

In the next step S72, the entirety control unit 120 issues a command to the stage control apparatus 126 so that the stage control apparatus moves the stage to a stage scanning start position. Then, steps S73, S74, S75, S76 are executed in parallel to each other. In the step S73, the entirety control unit 120 issues a command to the stage control apparatus 126 so that the stage control apparatus 126 drives the stage 302 with the inspected object 106 resting thereon at a constant speed. Simultaneously, in the step S74, the entirety control unit 120 issues a command to the height calculating unit 200b such that the height calculating unit 200b outputs correction detection height information 190 based on real time height detection and height detection apparatus correction parameters obtained from the height detection optical apparatus 200a to the focus control apparatus 109 and the deflection control apparatus 108. Further, at the same time, in the step S75, the entirety control apparatus 120 issues commands to the focus control apparatus 108 and the deflection control apparatus 109 such that the focus control apparatus 108 and the deflection control apparatus 109 continuously execute the focus control by using height-focus control signal correction parameters based on the scanning of electron beams and the corrected detection height and the deflection distortion correction by using the image distortion correction parameters such as image magnification correction based on the corrected detection height. Furthermore, at the same time, in the step S76, the entirety control unit 120 issues a command to the image processing unit 124 such that the appearance inspection is executed by obtaining SEM images continuously obtained from the image processing unit 124.

In the next step S77, at the stage scanning end position, the entirety control unit 120 displays the inspected result received from the image processing unit 124 on the display 143 or stores the above inspected result in the memory 142. If it is determined at the next step S78 that the inspection is not ended, then a control goes back to the step S72. If it is determined at the step S78 that the inspection is ended, the processing is ended (step S79).

While the SEM apparatus (electron beam apparatus) has been described so far in the above-mentioned embodiments, the present invention may be applied to other converging charged beam apparatus such a converging ion beam apparatus. In that case, the electron gun 101 may be replaced with an ion source. Then, in this case, while the secondary electron detector 104 is not always required, in order to monitor the state manufactured by the ion beams, a secondary electron detector or secondary ion detector may be disposed at the position of the secondary electron detector 104. Further, the present invention may also be applied to manufacturing apparatus of a wide sense which includes a pattern writing apparatus using electron beams. In this case, while the secondary electron detector 104 is not always required, because the main purpose is to utilize the electron beam for writing patterns on the sample 106, the secondary electron detector should preferably be used similarly in order to monitor the processing state or to align the position of the sample.

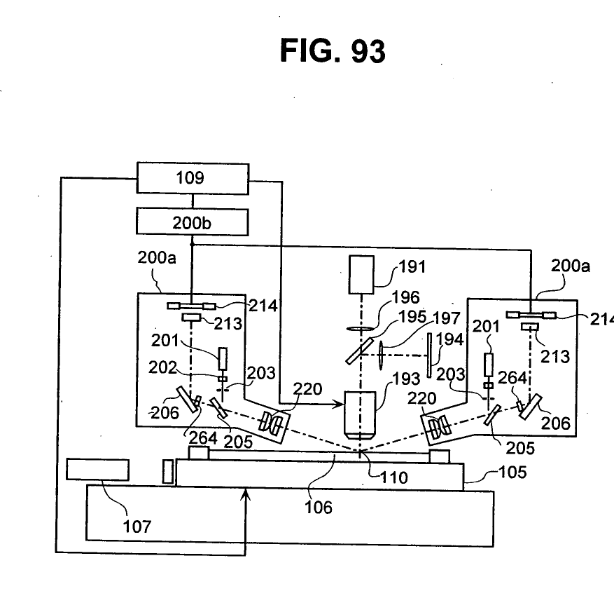

It is apparent that optical apparatus such as ordinary optical microscope, optical appearance inspection apparatus and optical exposure apparatus may similarly construct an automatic focus mechanism by using the present height detection apparatus if they have a mechanism for controlling a focus position. In the case of apparatus in which a sample is not elevated and lowered in order to achieve the properly-focused state but a focus position of an optical system is changed, such apparatus can receive particularly remarkable effects of characteristics of highly-accurate height detection of wide range achieved by the present height detection apparatus. FIG. 93 is a diagram showing the embodiment of this case. Only points different from those of FIG. 55 will be described. Reference numeral 191 denotes a light source from which illumination light is irradiated on the sample 106 through a lens 196, a half mirror 195, and an objective lens 193. This image is traveled through the objective lens 193, reflected by the half mirror 195, and focused on an image detector 194 through a lens 197. At that time, the focus of the objective lens 193 should be properly focused on the surface of the sample 106. At that time, light can be properly-focused at a high speed if the apparatus includes the height detector 200. In this embodiment shown in this sheet of drawing, light is properly-focused by elevating and lowering the objective lens 193 but instead light may be properly-focused by elevating and lowering the stage 105. However, if the objective lens 193 is elevated and lowered, then effects of characteristics in which the present height detector 200 can execute the highly-accurate height detection in a wide range can be demonstrated more remarkably. Alternatively, the properly-focused state may of course be established by elevating and lowering the whole of optical system comprising 191, 193, 195, 196, 197, 194. Further, an optical system appearance inspection apparatus may be arranged by adding the image processing unit 124 or the like shown in FIGS. 55 and 56 to the arrangement shown in FIG. 93. Furthermore, a laser material processing machine may be arranged by using the arrangement of the embodiment shown in FIG. 93.

According to the present invention, the image distortion caused by the deflection and the aberration of the electron optical system can be reduced, and the decrease of the resolution due to the de-focusing can be reduced so that the quality of the electron beam image (SEM image) can be improved. As a result, the inspection and the measurement of length based on the electron beam image (SEM image) can be executed with high accuracy and with high reliability.

Additionally, according to the present invention, if the height information of the surface of the inspected object detected by the optical height detection apparatus and the correction parameters between the focus control current or the focus control voltage of the electron optical system and the image distortion such as the image magnification error are obtained in advance, then the most clear electron beam image (SEM image) can be obtained from the inspected object without image distortion, and the inspection and the measurement of length based on the electron beam image (SEM image) can be executed with high accuracy and with high reliability.

Further, according to the present invention, in the electron beam system inspection apparatus, since the height of the surface of the inspected object can be detected real time and the electron optical system can be controlled real time, an electron beam image (SEM image) of high resolution without image distortion can be obtained by the continuous movement of the stage, and the inspection can be executed. Hence, an inspection efficiency and its stability can be improved. In addition, an inspection time can be reduced. In particular, the reduction of the inspection time is effective in increasing a diameter when the inspected object is the semiconductor wafer.

Furthermore, according to the present invention, similar effects can be achieved also in observation manufacturing apparatus using converging charged particle beams.

At least a portion (if not all) of the present invention may be practiced as a software invention, implemented in the form of one or more machine-readable medium having stored thereon at least one sequence of instructions that, when executed, causes a machine to effect operations with respect to the invention. With respect to the term “machine”, such term should be construed broadly as encompassing all types of machines, e.g., a non-exhaustive listing including: computing machines, non-computing machines, communication machines, etc. With regard to the term “one or more machine-readable medium”, the sequence of instructions may be embodied on and provided from a single medium, or alternatively, differing ones or portions of the instructions may be embodied on and provided from differing and/or distributed mediums. A “machine-readable medium” includes any mechanism that provides (i.e., stores and/or transmits) information in a form readable by a machine (e.g., a processor, computer, electronic device). Such “machine-readable medium” term should be broadly interpreted as encompassing a broad spectrum of mediums, e.g., a non-exhaustive listing including: electronic medium (read-only memories (ROM), random access memories (RAM), flash cards); magnetic medium (floppy disks, hard disks, magnetic tape, etc.); optical medium (CD-ROMs, DVD-ROMs, etc); electrical, optical, acoustical or other form of propagated signals (e.g., carrier waves, infrared signals, digital signals); etc.

Method embodiments may be emulated as apparatus embodiments (e.g., as a physical apparatus constructed in a manner effecting the method); apparatus embodiments may be emulated as method embodiments. Still further, embodiments within a scope of the present invention include simplistic level embodiments through system levels embodiments.

In concluding, reference in the specification to “one embodiment”, “an embodiment”, “example embodiment”, etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment or component, it is submitted that it is within the purview of one skilled in the art to effect such feature, structure, or characteristic in connection with other ones of the embodiments and/or components. Furthermore, for ease of understanding, certain method procedures may have been delineated as separate procedures; however, these separately delineated procedures should not be construed as necessarily order dependent in their performance, i.e., some procedures may be able to be performed in an alternative ordering, simultaneously, etc.

This concludes the description of the example embodiments. Although the present invention has been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

1. A charged-particle beam apparatus comprising:
a stage on which a sample is set;
a charged-particle optical system for converging a charged-particle beam generated by a charged-particle source;
a scanning means for scanning an area on said sample in which a pattern is formed with said charged-particle beam converged by said charged-particle optical system;
a focus control means for controlling a focal position of said charged-particle beam converged by said charged-particle optical system;
an astigmatism adjustment means for adjusting astigmatism of said charged-particle beam converged by said charged-particle optical system;
an image detection means for obtaining an image of said sample by detecting secondary particles generated from said sample by the scanning of said converged charged-particle beam by said scanning means;
an image-processing means for processing said image obtained by said image detection means; and
a control system for adjusting and controlling said astigmatism of said converged charged-particle beam by using information from said image-processing means,
wherein, said control system so controls that said scanning means scans said charged particle bean in one direction, said image detection means obtains plural images of said sample having mutually different focal positions by changing focal position of said charged particle beam with said focus control means, said image processing means computes sharpness values of said charged-particle optical system in two directions which are substantially perpendicular with each other, said scanning means changes scanning direction in another direction inclined to said one direction and scanning said area on said sample in a direction inclined to that of the previous scanning of said area, said image detection means obtains plural images of said sample having mutually different focal positions by changing focal position of said charged particle beam with said focus control means, said image processing means computes sharpness values of said charged-particle optical system in two directions which are substantially perpendicular with each other, calculating astigmatism of said charged-particle optical system based on said computed sharpness value in four directions of said converged charged-particle beam and feeding back an astigmatism correction amount to said astigmatism adjustment means based on said calculated astigmatism.

2. A charged-particle beam apparatus according to claim 1 wherein said particle-picture detection means carries out a focus scanning operation to obtain said image having a plurality of focal positions two times.

3. A charged-particle beam apparatus according to claim 1 wherein said image-processing means computes a focal offset based on said image having a plurality of focal positions.

4. A charged-particle beam apparatus according to claim 3 wherein said control system feed backs a focus correction quantity based on said converged charged-particle beam's focal offset computed by said image-processing means to said focus control means in order to adjust and control said converged charged-particle beam.

5. A charged-particle beam apparatus according to claim 1 wherein said control system carries out non-linear processing to find said astigmatism correction amount based on said converged charged-particle beam's sharpness values computed by said image processing means.

6. A charged-particle beam apparatus according to claim 1 wherein said image detection means carries out a focus scanning operation to obtain said image having a plurality of focal positions two times by changing a picture direction by about 45 degrees, about 135 degrees, about −45 degrees or about −135 degrees.

7. A charged-particle beam apparatus according to claim 6 wherein said image-processing means:
finds sharpness in substantially a 45-degree direction and sharpness in substantially a 135-degree direction of two types of images from each of said images with different scanning angles and each with a plurality of focal positions, which pictures are obtained from said particle-picture detection means;
finds pieces of directional-sharpness data for said focal positions in four directions, namely, substantially a 0-degree direction, a 45-degree direction, a 90-degree direction and a 135-degree direction, from collected results of a focus scan operation carried out two times;
finds in-focus positions in at least said four found pieces of directional-sharpness data; and
computes an astigmatic difference of said converged charged-particle beam from a relation among said in-focus positions for said four directions.

8. A charged-particle beam apparatus according to claim 1 wherein said image detection means carries out a focus scan operation to obtain an image having a plurality of focus positions two times whereas said image-processing means:
finds pieces of directional-sharpness data in four directions, namely, substantially a 0-degree direction, a 45-degree direction, a 90-degree direction and a 135-degree direction, from focal positions corresponding to said first and second focus scan operations and covariance values of differential pictures in differentiation directions or square roots of said covariance values for said differential pictures in said four directions, namely, said 0-degree direction, said 45-degree direction, said 90-degree direction and said 135-degree direction, of images from said images, which each have a plurality of focal positions and are obtained from said particle-picture detection means;
finds in-focus positions in at least said found pieces of directional sharpness data in said four directions; and
computes an astigmatic difference and a focal offset of said converged charged-particle beam from a relation among said in-focus positions for said four directions.

9. A charged-particle beam apparatus according to claim 1 wherein said sample has a pattern created thereon to include edge elements in at least three directions.

10. A charged-particle beam apparatus according to claim 1 wherein said sample has at least three areas each including a sub-pattern having an edge element so that said sample has a pattern created thereon to include edge elements in at least three directions.

11. A charged-particle beam apparatus according to claim 1 wherein said image detection means controls said focus control means to detect a particle picture having a plurality of focal positions from said sample.

12. A charged-particle beam apparatus according to claim 1 wherein said image detection means detects a particle picture having a plurality of focal positions from a plurality of areas different from each other on said sample.

13. A charged-particle beam apparatus according to claim 1 wherein said sample is an inclined sample or a sample having a staircase-shaped surface.

14. A charged-particle beam apparatus according to claim 1 wherein, while said focus control mean is changing a focal position for said sample at a high speed, said scanning means radiates said converged charged-particle beam to said sample in a scanning operation.

15. A charged-particle beam apparatus according to claim 1, comprising a defect-inspection image-processing means,
wherein said defect-inspection image-processing means inspects said sample for a defect existing on said sample by using an image of said sample;
said image of said sample is obtained by said image detection means as a result of detection of particles, which are generated from said sample when said scanning means radiates said converged charged-particle beam to said sample in a scanning operation; and
said converged charged-particle beam has been subjected to adjustment and control of at least astigmatism thereof in said control system.

16. A charged-particle beam apparatus according to claim 1, comprising:
a defect-inspection image-processing means,
wherein said defect-inspection image-processing means measures dimensions of a pattern existing on an object substrate serving as said sample by using an image of said sample;
said image of said sample is obtained by said image detection means as a result of detection of particles, which are generated from said object substrate when said scanning means radiates said converged charged-particle beam to said sample in a scanning operation; and
said converged charged-particle beam has been subjected to adjustment and control of at least astigmatism thereof in said control system.

17. A charged-particle beam apparatus comprising:
a stage on which a sample is set;
a charged-particle optical system for converging a charged-particle beam generated by a charged-particle source;
a scanning means for scanning an area on said sample in which a pattern is formed with said charged-particle beam converged by said charged-particle optical system;
a focus control means for controlling a focal position of said charged-particle beam converged by said charged-particle optical system;
an astigmatism adjustment means for adjusting astigmatism of said charged-particle beam converged by said charged-particle optical system;
an image detection means for obtaining an image of said sample by detecting secondary particles generated from said sample by the scanning of said converged charged-particle beam by said scanning means;
an image-processing means for processing said image obtained by said image detection means;
a control system for adjusting and controlling said astigmatism of said converged charged-particle beam by using information from said image-processing means; and
a height detection means for optically detecting a height on an object substrate serving as said sample,
wherein said control system so controls that said scanning means scans said charged particle bean in one direction, said image detection means obtains plural images of said sample having mutually different focal positions by changing focal position of said charged particle beam with said focus control means, said image processing means computes sharpness values of said charged-particle optical system in two directions which are substantially perpendicular with each other, said scanning means changes scanning direction in another direction inclined to said one direction and scanning said area on said sample in a direction inclined to that of the previous scanning of said area, said image detection means obtains plural images of said sample having mutually different focal positions by changing focal position of said charged particle beam with said focus control means, said image processing means computes sharpness values of said charged-particle optical system in two directions which are substantially perpendicular with each other, calculating astigmatism of said charged-particle optical system based on said computed sharpness value in four directions of said converged charged-particle beam and feeding back an astigmatism correction amount to said astigmatism adjustment means based on said calculated astigmatism, and
wherein said focus control means is controlled on the basis of said optically detected height on said object substrate.

18. A method for adjusting astigmatism of a charged-particle beam apparatus, comprising:
converging a charged-particle beam, which is generated by a charged-particle source, by using a charged-particle optical system;
irradiating and scanning in one direction said converged charged-particle beam in an area on a sample, on which a pattern is formed, to obtain an image of said sample by detecting secondary particles generated from said sample by said irradiating and scanning said converged charged-particle beam;
changing a focal position of said converged charged-particle beam;
obtaining a plurality of images of said sample having mutually different focal positions by repeating the operations from converging to changing for plural times;
repeating the operations from converging to obtaining once more by changing said scanning direction of said converged charged-particle beam to be inclined to said one direction at the irradiating and scanning operations, thereby scanning said area on said sample in a direction inclined to that of the previous scanning of said area;
computing an astigmatism of said charged-particle optical system by calculating sharpness values in two directions substantially perpendicular with each other from the plurality of images obtained at said obtaining operation by scanning said converged charged-particle beam in said one direction and sharpness values in another two directions substantially perpendicular with each other from the plurality of images obtained at said obtaining operation by scanning said converged charged-particle beam in another direction inclined to said one direction and estimating an astigmatism correction amount from said calculated sharpness value in four directions; and
controlling and adjusting said astigmatism of said charged-particle optical system by feeding back said astigmatism correction amount based on said computed astigmatism.

19. A method for automatically adjusting astigmatism of a charged-particle beam apparatus according to claim 18, wherein an operation to obtain said images having focal positions different from each other by changing a focal position of said converged charged-particle beam is carried out two times.

20. A method for automatically adjusting astigmatism of a charged-particle beam apparatus according to claim 18, wherein, at said computing said sharpness values, a focal offset of said converged charged-particle beam is calculated.

21. A method for automatically adjusting astigmatism of a charged-particle beam apparatus according to claim 20, comprising adjusting and controlling a focus of said converged charged-particle beam by feeding back a focus correction quantity based on said calculated focal offset of said converged charged-particle beam to a focus control means.

22. A method for automatically adjusting astigmatism of a charged-particle beam apparatus according to claim 18, wherein said computing of said sharpness values includes:
finding degrees of directional sharpness in at least three directions from said images having a plurality of focal positions for said focal positions;
finding in-focus positions at said found degrees of directional sharpness in at least said three directions; and
computing an astigmatic difference of said converged charged-particle beam from a relation among said found in-focus positions for at least said three directions.

23. A method for automatically adjusting astigmatism of a charged-particle beam apparatus according to claim 22, wherein at said computing an astigmatic difference, said in-focus positions at said degrees of directional sharpness in at least said three directions are each found by:
finding a maximum value or a peak value for each of said degrees of directional sharpness; and
finding a true position by interpolation based on values in close proximity to said maximum value or said peak value.

24. A method for automatically adjusting astigmatism of a charged-particle beam apparatus according to claim 18, wherein, at said obtaining said images, a focus scanning operation to obtain said images are carried out 2 times by changing a picture direction by about 45 degrees, about 135 degrees, about −45 degrees or about −135 degrees.

25. A method for automatically adjusting astigmatism of a charged-particle beam apparatus according to claim 24, wherein said computing of said sharpness values of said converged charged-particle beam includes:
finding sharpness in a substantially 45-degree direction and sharpness in a substantially 135-degree direction of two types of images from each of said 2-dimensional particle pictures with different scanning angles and each with a plurality of focal positions, which pictures are obtained at said obtaining said image;
finding pieces of directional-sharpness data for said focal positions in four directions, namely, substantially a 0-degree direction, a 45-degree direction, a 90-degree direction and a 135-degree direction, from collected results of a focus scan operation carried out two times;
finding in-focus positions in at least said found pieces of directional sharpness data in said four directions; and
computing an astigmatic difference and a focal offset of said converged charged-particle beam from a relation among said in-focus positions for said four directions.

26. A method for automatically adjusting astigmatism of a charged-particle beam apparatus according to claim 1, comprising inspecting an object substrate serving as said sample for a defect existing on said sample by using said image obtained as a result of detection of particles generated from said sample by radiation of said converged charged-particle beam to said sample in a scanning operation whereby said converged charged-particle beam has been subjected to adjustment and control of said astigmatism.

27. A method for automatically adjusting astigmatism of a charged-particle beam apparatus according to claim 18, comprising measuring dimensions of a pattern existing on an object substrate serving as said sample by using said image obtained as a result of detection of particles generated from said sample by radiation of said converged charged-particle beam to said sample in a scanning operation whereby said converged charged-particle beam has been subjected to adjustment and control of said astigmatism.

28. A method for adjusting astigmatism of a charged-particle beam apparatus, said method comprising:
converging a charged-particle beam, which is generated by a charged-particle source, by using a charged-particle optical system;
irradiating and scanning in one direction said converged charged-particle beam in an area of a sample, on which a pattern is formed, to obtain an image of said sample by detecting secondary particles generated from said sample by said irradiating and scanning said converged charged-particle beam;
changing a focal position of said converged charged-particle beam;
obtaining a plurality of images of said sample having mutually different focal positions by repeating the operations from converging to changing for plural times;
repeating the operations from converging to obtaining once more by changing said scanning direction of said converged charged-particle bean to be inclined to said one direction at the irradiating and scanning operations, thereby scanning said area on said sample in a direction inclined to that of the previous scanning of said area;
computing an astigmatism of said charged-particle optical system by calculating sharpness values in two directions substantially perpendicular with each other from the plurality of images obtained at said obtaining operation by scanning said converged charged-particle beam in said one direction and sharpness values in another two directions substantially perpendicular with each other from the plurality of images obtained at said obtaining operation by scanning said converged charged-particle beam in another direction inclined to said one direction, and estimating an astigmatism correction amount from said calculated sharpness value in four directions;
controlling and adjusting said astigmatism of said charged-particle optical system by feeding back said estimated astigmatism correction amount to an astigmatism adjustment means; and
repeating the above operations from converging to controlling until said astigmatism correction amount becomes smaller than a predetermined value.

29. A method for automatically adjusting astigmatism of a charged-particle beam apparatus according to claim 28, wherein, at said obtaining a plurality of images, an operation to obtain said image having focal positions different from each other by sequentially changing a focal position of said converged charged-particle beam is carried out two times.

30. A method for automatically adjusting astigmatism of a charged-particle beam apparatus according to claim 28, comprising computing a focal offset by using information contained in said images having focal positions different from each other.

31. A method for automatically adjusting astigmatism of a charged-particle beam apparatus according to claim 30, comprising adjusting and controlling a focus of said converged charged-particle beam on the basis of a defect calculated at said computing a focal offset.

32. A method for automatically adjusting astigmatism of a charged-particle beam apparatus, said method comprising:
converging a charged-particle beam, which is generated by a charged-particle source, by using a charged-particle optical system;
irradiating and scanning in one direction said converged charged-particle beam in an area of a sample, on which a pattern is formed, to obtain an image of said sample by detecting secondary particles generated from said sample by said irradiating and scanning said converged charged-particle beam;
changing a focal position of said converged charged-particle beam;
obtaining a plurality of images of said sample having mutually different focal positions by repeating the operations from converging to changing for plural times;
repeating the operations from converging to obtaining once more by changing said scanning direction of said converged charged-particle bean to be inclined to said one direction at the irradiating and scanning operations, thereby scanning said area on said sample in a direction inclined to that of the previous scanning of said area;
computing an astigmatism of said charged-particle optical system by calculating sharpness values in two directions substantially perpendicular with each other from the plurality of images obtained at said obtaining operation by scanning said converged charged-particle beam in said one direction and sharpness values in another two directions substantially perpendicular with each other from the plurality of images obtained at said obtaining operation by scanning said converged charged-particle beam in another direction inclined to said one direction, and estimating an astigmatism correction amount from said calculated sharpness value in four directions; and
controlling and adjusting said astigmatism of said charged-particle optical system by feeding back said estimated astigmatism correction amount to an astigmatism adjustment means;
optically detecting a height of an object substrate serving as said sample;
controlling a focus of said converged charged-particle beam on the basis of information on said detected height of said object substrate; and
repeating the above operations from converging to controlling until said astigmatism correction amount becomes smaller than a predetermined value.

33. A method for automatically adjusting astigmatism of a charged-particle beam apparatus according to claim 28, comprising inspecting an object substrate serving as said sample for a defect existing on said sample by using said image obtained as a result of detection of particles generated from said sample by radiation of said converged charged-particle beam to said sample in a scanning operation whereby said converged charged-particle beam has been subjected to adjustment and control of said astigmatism.

34. A method for automatically adjusting astigmatism of a charged-particle beam apparatus according to claim 28, comprising measuring dimensions of a pattern existing on an object substrate serving as said sample by using said image obtained, as a result of detection of particles generated from said sample by radiation of said converged charged-particle beam to said sample in a scanning operation whereby said converged charged-particle beam has been subjected to adjustment and control of said astigmatism.
